(19) United States
(12) Patent Application Publication
(10) Pub. No.: US 2014/0006109 A1
(43) Pub. Date: Jan. 2, 2014

(54) System and Methods for Generating Price Sensitivity

(71) Applicant: Vendavo, Inc., Mountain View, CA (US)

(72) Inventors: Gianpaolo Callioni, Redwood City, CA (US); Allen David Ross Gray, Menlo Park, CA (US); Sean P. Geraghty, Scottsdale, AZ (US); Vlad Gorlov, Park Ridge, NJ (US)

(21) Appl. No.: 13/909,068

(22) Filed: Jun. 3, 2013

Related U.S. Application Data
(63) Continuation-in-part of application No. 11/938,714, filed on Nov. 12, 2007.
(60) Provisional application No. 60/865,643, filed on Nov. 13, 2006.

(51) Int. Cl. G06Q 30/02

(52) U.S. Cl. CPC G06Q 30/0206
USPC 705/7.35

(57) ABSTRACT

The present invention relates to systems and methods for calculating a segment's sensitivity to price changes. A histogram distribution is generated for transaction frequency by price as the initial part of the sensitivity analysis. The shape of this histogram may be used to extrapolate a sensitivity measure. This can be done in two distinct ways: statistical regression or slope approximation. For statistical regression, the inverse of the cumulative distribution function is first calculated. The slope of this function is determined to be the sensitivity; the steeper the curve the more sensitive the segment is to price changes. The second technique approximates the slope of the right hand side of the histogram in order to determine sensitivity.

### CROSS REFERENCE TO RELATED APPLICATIONS

This application is a continuation-in-part of U.S. patent application Ser. No. 11/938,714, filed on Nov. 12, 2007, by Jens E. Tellefsen and Jeffrey D. Johnson, entitled “Systems and Methods for Price Optimization using Business Segmentation”, which in turn is a continuation-in-part of U.S. patent application Ser. No. 11/415,877 filed May 2, 2006, and also claims priority of U.S. Provisional patent application Ser. No. 60/865,643 filed on Nov. 13, 2006, which applications are incorporated herein in their entirety by this reference.

This application is related to pending application Ser. No. 12/408,868, filed Mar. 23, 2009, now U.S. Pat. No. 8,301,487, by Jamie Rapperport, Jeffrey D. Johnson, Gianpaolo Callioni, Allan David Ross Gray, Sean Geraghty, Vlad Gorlov and Amit Mehra, entitled “System and Methods for Calibrating Pricing Power and Risk Scores” which application is incorporated herein in its entirety by this reference.

This application is related to pending application Ser. No. 12/408,862, filed Mar. 23, 2009, by Jamie Rapperport, Jeffrey D. Johnson, Gianpaolo Callioni, Allan David Ross Gray, Sean Geraghty, Vlad Gorlov and Amit Mehra, entitled “System and Methods for Generating Quantitative Pricing Pricing Power and Risk Scores” which application is incorporated herein in its entirety by this reference.

### BACKGROUND OF THE INVENTION

The present invention relates to business to business market price control and management systems. More particularly, the present invention relates to systems and methods for generating price sensitivity of a particular segment.

There are major challenges in business to business (hereinafter “B2B”) markets which hinder the effectiveness of classical approaches to analyzing pricing impacts and thus optimization or guidance of pricing strategies. Classical approaches to price optimization typically rely upon databases of extensive transaction data which may then be modeled for demand. The effectiveness of classical price optimization approaches depends upon a rich transaction history where prices have changed, and consumer reactions to these price changes are recorded. Thus, classical price optimization approaches work best where there is a wide customer base and many products, such as in Business to Consumer (hereinafter “B2C”) settings.

Unlike B2C environments, in B2B markets a small number of customers represent the lion's share of the business. Managing the prices of these key customers is where most of the pricing opportunity lies. Also, B2B markets are renowned for being data-poor environments. Availability of large sets of accurate and complete historical sales data is scarce.

Furthermore, B2B markets are characterized by deal negotiations instead of non-negotiated sale prices (prevalent in business to consumer markets). There is little existing literature on optimization of negotiation terms and processes, neither at the product/segment level nor at the customer level.

Finally, B2B environments suffer from poor customer segmentation. Top-down price segmentation approaches are rarely the answer. Historical sales usually exhibit minor price changes for each customer. Furthermore, price bands within customer segments are often too large and customer behavior within each segment is non-homogeneous.

Product or segment price optimization relies heavily on the quality of the customer segmentation and the availability of accurate and complete sales data. In this context, price optimization makes sense only (i) when price behavior within each customer segment is homogeneous and (ii) in the presence of data-rich environments where companies sales data and their competitors' prices are readily available. These conditions are met almost exclusively in B2C markets, such as retail, and are rarely encountered in B2B markets.

On the other hand, customer price optimization relies heavily on the abundance of data regarding customers' past behavior and experience, including win/loss data and customer price sensitivity. Financial institutions have successfully applied customer price optimization in attributing and setting interest rates for credit lines, mortgages and credit cards. Here again, the aforementioned condition is met almost exclusively in B2C markets.

There are three major types of price optimization solutions in the B2B marketplace: revenue/yield management, price testing and highly customized optimization solutions.

Revenue/yield management approaches were initially developed in the airline context, and were later expanded to other applications such as hotel revenue management, car rentals, cruises and some telecom applications (e.g., bandwidth pricing). These approaches are exclusively concerned with perishable products (e.g., airline seats) and are not pricing optimization approaches per se.

Price testing approaches attempt to learn and model customer behavior dynamically by measuring customer reaction to price changes. While this approach has been applied rather successfully in B2C markets, where the benefits of price optimization outweigh the loss of a few customers, its application to B2B markets is questionable. No meaningful customer behavior can be modeled without sizable changes in customer prices (both price increases and decreases). In B2B markets, where a small fraction of customers represent a substantial fraction of the overall business, these sizable price-changing tests can have adverse impact on business. High prices can drive large customers away with potentially a significant loss of volume. Low prices on the other hand, even for short periods of time, can dramatically impact customer behavior, increase customers' price sensitivities and trigger a more strategic approach to purchasing from the customers' side.

Finally, in B2B markets, highly customized price optimization solutions have been proposed. These solutions have had mixed results. These highly customized price optimization solutions require significant consulting effort in order to address companies' unique situations including cost structure, customer and competitor behavior, and to develop optimization methods that are tailored to the type of pricing data that is available. Most of the suggested price changes from these solutions are not implemented. Even when they are implemented, these price changes tend not to stick. Furthermore, the maintenance of such pricing solutions usually requires a lot of effort. This effort includes substantial and expensive on-going consulting engagements with the pricing companies.

Due to the difficulties inherent in a B2B environment, there is a strong need for a system able to provide guidance for price changes which reduces the need for ongoing consultation and is more readily implemented. The usage of pricing power and risk tools is one such system that addresses the unique hurdles of the B2B environment.

Pricing Power & Risk analysis would be greatly enhanced by the availability of a quantifiable measure of segment price sensitivity. Until now, no such measure has existed in the B2B environment. Elasticity is a metric used in data rich B2C environments, but it does not translate well to negotiated B2B settings.

As such, an urgent need exists for a system and method for calculating segment price sensitivity. Such a sensitivity metric enables clients in a B2B environment to generate efficient pricing guidance without the need for a particularly rich transaction database.

### SUMMARY OF THE INVENTION

The present invention discloses business to business market price control and management systems. More particularly, the present invention teaches systems and methods for generating price sensitivity for a segment. Such a sensitivity measurement may be particularly useful for power/risk analysis of transactions, and to provide pricing and negotiation guidance.

Price sensitivity is a unique quantifiable measurement in Business to Business (B2B) environments where transactions are routinely negotiated between the parties. These negotiations provide transaction logs where a single segment is sold at a range of prices, typically in a normalized frequency curve.

The present systems and methods generate a histogram distribution of transaction frequency by price as the initial part of the sensitivity analysis. The shape of this histogram may be used to extrapolate a sensitivity measure. This can be done in two distinct ways: statistical regression or slope approximation.

For statistical regression, the inverse of the cumulative distribution function is first calculated. The slope of this function is determined to be the sensitivity; the steeper the curve the more sensitive the segment is to price changes. The second technique approximates the slope of the right hand side of the histogram in order to determine sensitivity. This approximation may be performed by assigning a low and a high anchor. These anchors are typically at the 50-65 percentile of the distribution (for the high anchor), and 80-95 percentile (for the low anchor). The frequency is typically average around these anchors to “smooth” out noise variations in the frequency data. A line can then be generated between the high and low frequency which approximates the distribution curve's slope.

As previously noted, the calculated sensitivities may be useful for determining optimized prices or deal guidance. In some embodiments, the sensitivity may be output to a pricing system for use in pricing power/risk analysis. Additionally, in some embodiments of the system, a segmentation module may generate the segments for which the sensitivity is calculated.

Note that the various features of the present invention described above can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an example logical block diagram of a system for generating price sensitivity for a product segment, in accordance with some embodiments of the present invention;

FIG. 1B is an example logical block diagram for a price sensitivity analyzer, in accordance with some embodiments;

FIG. 2A is a simple graphical representation of an enterprise level pricing environment, in accordance with some embodiments;

FIG. 2B is a simplified graphical representation of a price modeling environment where an embodiment of the present invention may be utilized;

FIG. 3 is a high level flowchart illustrating the process for generating a sensitivity measure, in accordance with some embodiments;

FIG. 4 is a flow chart illustrating a technique for determining a sensitivity by approximating distribution curvature, in accordance with some embodiments;

FIG. 5 is a flow chart illustrating a technique determining a sensitivity by statistical regression, in accordance with some embodiments;

FIGS. 6A, 6B, 6C and 6D are example diagrams illustrating deal completion probabilities by differing acceptance and offer probability curves, in accordance with some embodiments;

FIG. 7 is an example diagram illustrating deal completion probabilities depending upon a price shift impacting offer probabilities, in accordance with some embodiments;

FIGS. 8A and 8B illustrate example diagrams for a deal probability and the inverse cumulative distribution function for the distribution, in accordance with some embodiments;

FIG. 9 is an example diagram illustrating one method of approximating distribution curvature for the generation of a sensitivity value, in accordance with some embodiments;

FIG. 10 is an exemplary integrated price management system for generating optimized price changes and generating business guidance in accordance with some embodiments;

FIG. 11 is an exemplary price optimizer for use with the integrated price management system in accordance with some embodiments;

FIG. 12 is an exemplary product segment price generator for use with the price optimizer of the integrated price management system in accordance with some embodiments;

FIG. 13 is an exemplary Segment Generator for use with the product segment price generator of the price optimizer in the integrated price management system in accordance with some embodiments;

FIG. 14 is an exemplary segment pricing power analyzer for use with the product segment price generator of the price optimizer in the integrated price management system in accordance with some embodiments;

FIG. 15 is an exemplary segment pricing risk analyzer for use with the product segment price generator of the price optimizer in the integrated price management system in accordance with some embodiments;

FIG. 16 is an exemplary client reconciliation engine for use with the product segment price generator of the price optimizer in the integrated price management system in accordance with some embodiments;

FIG. 17 is an exemplary client segment cartographer for use with the product segment price generator of the price optimizer in the integrated price management system in accordance with some embodiments;

FIG. 18A is an exemplary segment pricing power reconciler for use with the client reconciliation engine of the product segment price generator of the price optimizer in the integrated price management system in accordance with some embodiments;

FIG. 18B is an exemplary segment pricing risk reconciler for use with the client reconciliation engine of the product segment price generator of the price optimizer in the integrated price management system in accordance with some embodiments;

FIG. 19A is an exemplary pricing power value calibrator of the segment pricing power reconciler for use with the client reconciliation engine of the product segment price generator of the price optimizer in the integrated price management system in accordance with some embodiments;

FIG. 19B is an exemplary pricing risk value calibrator of the segment pricing risk reconciler for use with the client reconciliation engine of the product segment price generator of the price optimizer in the integrated price management system in accordance with some embodiments;

FIG. 20 is an exemplary segment price setter for use with the product segment price generator of the price optimizer in the integrated price management system in accordance with some embodiments;

FIG. 21 is an exemplary price, approval and guidance generator for use with the segment price setter of the product segment price generator of the price optimizer in the integrated price management system in accordance with some embodiments;

FIG. 22 is an exemplary deal evaluator for use with the integrated price management system in accordance with some embodiments;

FIG. 23 is a high level flowchart illustrating generating Quantitative Pricing Power and Risk scores in accordance with some embodiments;

FIG. 24 is a flow chart illustrating an exemplary method for providing price and deal guidance for a business to business client in accordance with some embodiments;

FIG. 25 is a flow chart illustrating an exemplary method for analyzing a business to business client of FIG. 24;

FIG. 26 is a flow chart illustrating an exemplary method for price setting and guidance optimization of FIG. 24;

FIG. 27 is a flow chart illustrating an exemplary method for generating target prices of FIG. 18;

FIG. 28 is a flow chart illustrating an exemplary method for allocating price changes across the segments of FIG. 26;

FIG. 29 is a flow chart illustrating an exemplary method for generating segment pricing power values of FIG. 28;

FIG. 30 is a flow chart illustrating an exemplary method for generating segment pricing risk values of FIG. 28;

FIG. 31 is a flow chart illustrating an exemplary method for reconciling pricing power and risk values of FIG. 30;

FIG. 32 is a flow chart illustrating an exemplary method for reconciling gap between discrepant quantitative values and qualitative values of FIG. 31;

FIG. 33 is a flow chart illustrating an exemplary method for identifying a subset of quantitative segments to reflect what the client had in mind when generating qualitative scores of FIG. 32;

FIG. 34 is a flow chart illustrating an exemplary method for adjusting item level scores such that quantitative scores adhere to qualitative scores of FIG. 32;

FIG. 35 is a flow chart illustrating an exemplary method for comparing pricing power and risk values to business goals to develop pricing suggestions of FIG. 28;

FIG. 36 is a flow chart illustrating an exemplary method for applying price changes to segments by pricing goals of FIG. 35;

FIG. 37 is a flow chart illustrating an exemplary method for applying price changes to segments as to minimize pricing risk while maximizing pricing power of FIG. 36;

FIG. 38 is a flow chart illustrating an exemplary method for evaluating a vendor proposal of FIG. 23;

FIG. 39 is an illustrative example of a pricing power and risk segment plot in accordance with some embodiments;

FIG. 40 is an illustrative example of a pricing power and risk table for exemplary segments in accordance with some embodiments;

FIG. 41 is an illustrative example of a pricing power and risk segment plot in an interface in accordance with some embodiments;

FIG. 42 is an illustrative example of the pricing power and risk segment plot in the interface and illustrating a pricing power and risk reconciliation in accordance with some embodiments;

FIG. 43 is an illustrative example of a pricing power and risk segment plot with price change guidance tradeoff contours in accordance with some embodiments;

FIG. 44 is an illustrative example of a pricing power and risk segment plot with an applied price change matrix in accordance with some embodiments;

FIG. 45 is an illustrative example of a pricing power and risk segment plot for three exemplary client segments in accordance with an embodiment of the present invention;

FIG. 46 is an exemplary table of quantitative pricing power and risk factors and scores for exemplary generated segments in accordance with an embodiment of the present invention;

FIG. 47 is an exemplary table of quantitative versus qualitative pricing power and risk scores for the exemplary client segments of FIG. 45;

FIG. 48 is an exemplary plot of quantitative versus qualitative pricing power scores for the exemplary client segments of FIG. 45;

FIG. 49 is an exemplary plot of quantitative versus qualitative pricing risk scores for the exemplary client segments of FIG. 45;

FIG. 50 is an exemplary plot of quantitative pricing power and risk scores for the exemplary generated segments and the and qualitative client scores for the exemplary client segment of FIGS. 45 and 46;

FIG. 51 is the exemplary plot of FIG. 50 wherein a subset of the exemplary generated segments has been selected for the quantitative pricing power and risk scores;

FIG. 52 is the exemplary plot of FIG. 51 wherein a the exemplary generated segments quantitative pricing power and risk scores have been calibrated;

FIG. 53 illustrates a comparison of two exemplary price change scenarios in accordance with some embodiments;

FIG. 54 illustrates an exemplary plot of revenue change to risk for the two exemplary price change scenarios of FIG. 53; and

FIGS. 55A and 55B illustrate example computer systems capable of executing at least portions of the disclosed embodiments of the present invention.

### DETAILED DESCRIPTION OF THE PREFERRED EMBODIMENTS

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Many pricing methodologies have been developed in order to generate additional profit for retailers and manufacturers. Within the Business to Consumer (B2C) markets, large quantities of statistical data are readily available, thereby enabling statistical modeling of purchasing behaviors. Price elasticity, demand interdependencies and promotional modeling can all be accomplished with sufficient computational power. However in the Business to Business (B2B) environment, such statistical modeling is less effective given that most transactions are negotiation based, and as such the data is not sufficiently granular to utilize the same modeling algorithms. As such, novel means for determining pricing have been developed.

One such pricing mechanism is to generate pricing “power” and pricing “risk” values for products or product segments. These power and risk values may guide deal makers to propose and negotiate B2B transactions that are both profitable and successful.

One pricing “power” measurement of particular interest is a segment's “sensitivity” to pricing. Sensitivity (or price sensitivity) is the B2B analogous measure to price elasticity within the B2C environment. Sensitivities are essentially a measure of a purchasers probability of purchasing an item at a given price point. Since the data in B2C environments is not conducive to calculating elasticity, sensitivity values must be derived in other ways.

Sensitivity differs from traditional elasticity measures in that price elasticity is derived from a demand model, which estimates volumes at given pricing points. In B2B environments it is difficult to construct a viable demand model. Sensitivity, in contrast to elasticity, does not utilize volume estimates, and is used to differentiate more price sensitive segments from less price sensitive segments.

Sensitivity, as quantifiably measured in these embodiments, is a new and unique metric. Similar metrics have been identified in the past that traditionally required experienced and sophisticated sales people to intuitively derive a “gut feel” of how much a segment is impacted by price; the present systems and methods allow for improved means for calculating sensitivities that are quantitatively accurate, and reflect actual purchasing behaviors.

Note that while much of the discussion contained herein relates to negotiation based transactions where sensitivity is leveraged by a pricing system as a measurement of pricing “power”, it is understood that pricing sensitivity has value independent from pricing systems. For example, price sensitivity may be useful for market analysis, research purposes, and decision making by manufacturers. Additionally, price sensitivity may be employed for the generating of prices independent of pricing power and risk measures, and outside of a negotiation based transaction.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Price Sensitivity Systems

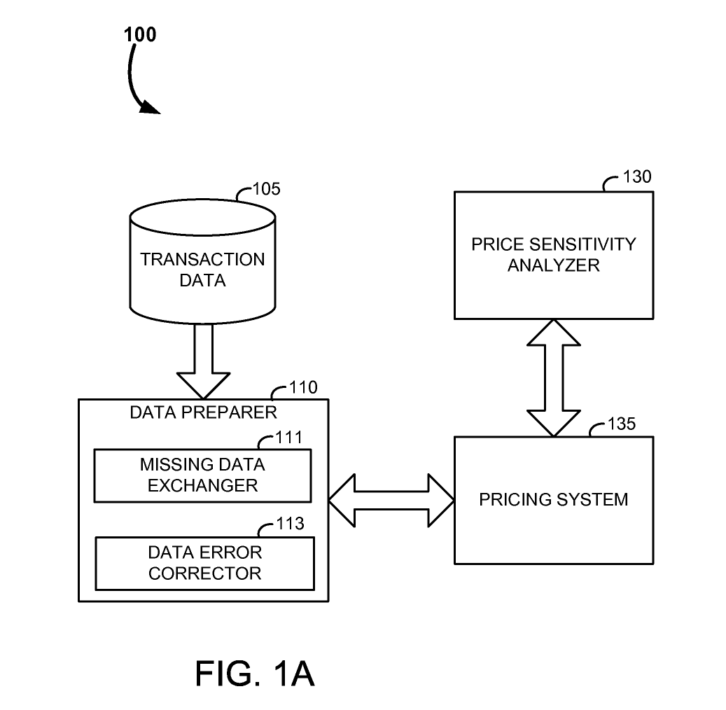

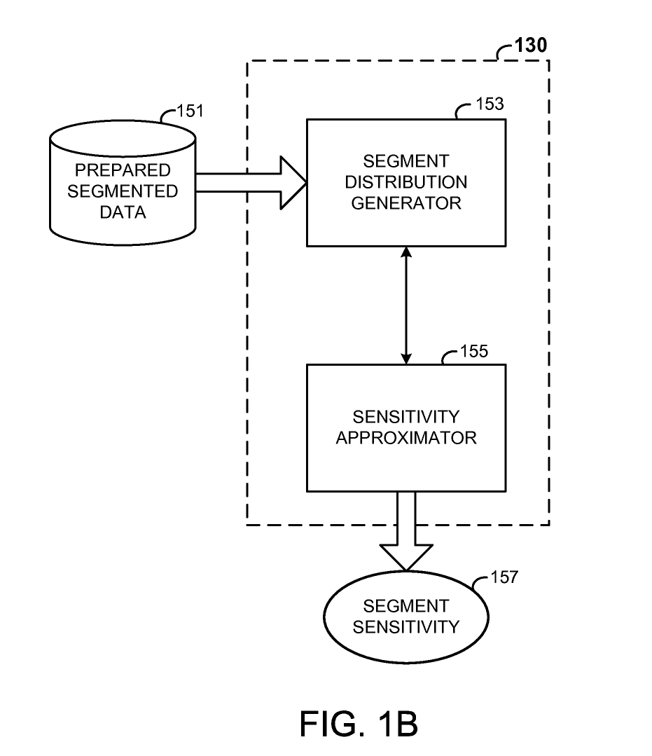

To facilitate discussion, FIG. 1A is an example logical block diagram of a system 100 for generating price sensitivity for a product segment, in accordance with some embodiments. In this system 100, a database 132 (also known as a data warehouse) of transaction data is provided to a data preparation module 110. The database 132 may be populated with data from one or more clients and past transactions. This data may include product data, customer data, transaction data, inventory data, cost data, segment data, transaction and deal data, and other data pertinent to pricing. Segment Data may additionally include product types, attributes, channel, transaction and market data.

The data preparer 110 includes a missing data exchanger 111 and a data error correction 113 module. The missing data exchanger 111 may parse through the data being supplied and identify where entries are incomplete using error correction techniques known in the art. These missing data points may be removed or imputed, as desired, to generate a complete data set. Data imputation may include replacement of data points with industry averages, modeled values, or averages of the non-missing values.

The data error corrector 113 may then parse through the data to identify and correct other errors in the data. Known error correction techniques may likewise be employed here to generate a “clean” data set. Error correction may include the identification and correction of nonsensical data (such as negative volume or price values), or statistically erroneous data points (for example a value beyond two standard deviations from what is expected).

Error correction may be foregone when the data entering the system is pristine or otherwise includes low error rates. Ultimately, however, the quality of starting transaction data impacts the final results derived by the system.

In this example, the cleaned transaction data is provided to a pricing system 135, which can employ the data to generate pricing analytics and/or optimized pricing suggestions. Specific examples of pricing systems 135 are provided below in greater detail for the sake of clarity. The pricing system 135, may also generate customer segments, in some embodiments. However, it is important to note that, for the purposes of segment price sensitivity generation, the pricing system 135 is not necessarily required. In that sort of a system, the clean data stream may be provided directly to the price sensitivity analyzer 130.

Regardless of if data is supplied to the price sensitivity analyzer 130 directly from the database 132, the data preparer 110 or the pricing system 135, the price sensitivity analyzer 130 may utilize this transaction data to develop a sensitivity measure for a given segment.

FIG. 1B is a more detailed example logical block diagram for the price sensitivity analyzer 130. In this diagram, the prepared segment data 151 is seen being provided to a segment distribution generator 153. As noted previously, the pricing system 135 breaks out the data by product segments. If no pricing system 135 is present in any particular embodiment, then the segmentation activity is performed by a segmentation engine either prior to the price sensitivity analyzer 130, or as part of the price sensitivity analyzer 130.

The segment distribution generator 153 produces a histogram distribution of successful transactions as a function of pricing. Since B2B transactions are typically the result of negotiations, where each party must accept the final terms, a range of transaction prices exist in a frequency distribution. Typically this is a normal curve, or a skewed normal curve. The distribution is then provided to a sensitivity approximater 155, which generates an approximate, but representative and quantifiable, value for customer sensitivity for the segment 157 using either statistical regression or a linear approximation of the curve. Examples of the processes for sensitivity approximation shall be provided in greater detail below, in conjunction with accompanying flowcharts and examples.

As noted previously, the pricing system 135 and sensitivity analyzer 130 are of particular use in conjunction with a Business to Business (B2B) environment. In order to provide greater clarity, the framework for a B2B environment shall now be discussed in greater detail.

### II. Business to Business Environment

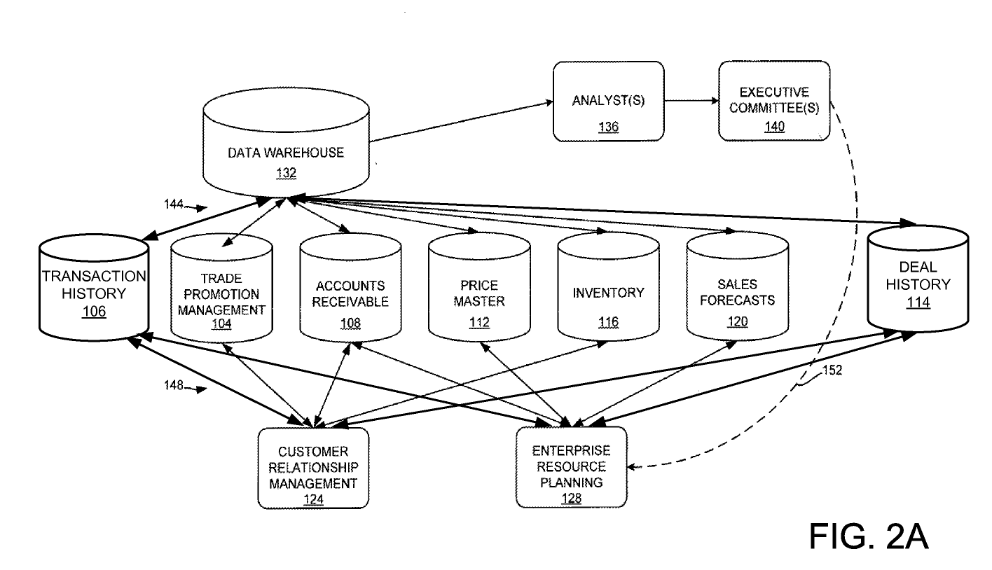

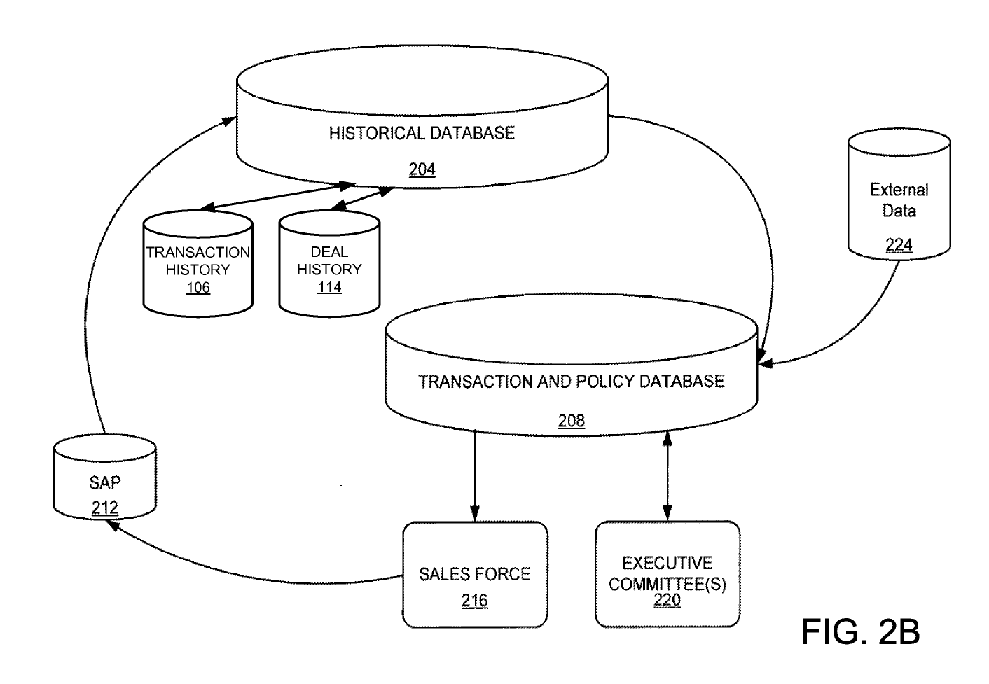

FIG. 2A is a simplified graphical representation of an enterprise pricing environment common to a B2B setting. Several example databases (104-120) are illustrated to represent the various sources of working data, which all may be provided to the database 132. These might include, for example, Trade Promotion Management (TPM) 104, Accounts Receivable (AR) 108, transaction history 106, Price Master (PM) 112, deal history 114, inventory 116, and sales forecasts 120. The data in those repositories may be utilized on an ad hoc basis by Customer Relationship Management (CRM) 124, and Enterprise Resource Planning (ERP) 128 entities to produce and post sales transactions (also may be provided to the database 132). The various connections 148 established between the repositories and the entities may supply information such as price lists as well as gather information such as invoices, rebates, freight, and cost information.

The wealth of information contained in the various databases (104-120) however, is not “readable” by executive management teams due in part to accessibility and, in part, to volume. That is, even though data in the various repositories may be related through a Relational Database Management System (RDMS), the task of gathering data from disparate sources can be complex or impossible depending on the organization and integration of legacy systems upon which these systems may be created. In one instance, all of the various sources may be linked to the data warehouse 132 by various connections 144. Typically, data from the various sources may be aggregated to reduce it to a manageable or human comprehensible size. Thus, price lists may contain average prices over some selected temporal interval. In this manner, data may be reduced. However, with data reduction, individual transactions may be lost. Thus, CRM 124 and ERP 128 connections to an aggregated data source may not be viable.

Analysts 136, on the other hand, may benefit from aggregated data from a data warehouse. Thus, an analyst 136 may compare average pricing across several regions within a desired temporal interval to develop, for example, future trends in pricing across many product lines. An analyst 136 may then generate a report for an executive committee 140 containing the findings. An executive committee 140 may then, in turn, develop policies that drive pricing guidance and product configuration suggestions based on the analysis returned from an analyst 136. Those policies may then be returned to CRM 124 and ERP 128 entities to guide pricing activities via some communication channel 152 as determined by a particular enterprise.

As can be appreciated, a number of complexities may adversely affect this type of management process. First, temporal setbacks exist at every step of the process. For example, a CRM 124 may make a sale. That sale may be entered into a sales database 120, INV database 116, deal history database 114, transaction history database 106, and an AR database 108. The entry of that data may be automatic where sales occur at a network computer terminal, or may be entered in a weekly batch process thus introducing a temporal setback. Another example of a temporal setback is time-lag introduced by batch processing data stored to a data warehouse resulting in weeks-old data that may not be timely for real-time decision support. Still other temporal setbacks may occur at any or all of the transactions illustrated in FIG. 2A that may ultimately render results untimely at best, and irrelevant at worst. Thus, the relevance of an analyst's 136 original forecasts may expire by the time the forecasts reach the intended users. Still further, the usefulness of any pricing guidance and product configuration suggestions developed by an executive committee 140 may also have long since expired leaving a company exposed to lost margins.

As pertains to some embodiments of the present invention, FIG. 2B is a simplified graphical representation of a price modeling environment where sensitivity analysis may be employed. This data structure may be embodied in the data warehouse 132 physically or logically. A historical database 204 may contain any of a number of records. In some embodiments, a historical database may include sales transactions from the deal history database 114 and the transaction history database 106. In other embodiments, a historical database may include waterfall records.

An analysis of a historical data may then be used to generate a transaction and policy database 208. For example, analysis of a selected group of transactions residing in a historical database may generate a policy that requires or suggests a rebate for any sale in a given region. In this example, some kind of logical conclusion or best guess forecast may determine that a rebate in a given region tends to stimulate more and better sales. A generated policy may thus be guided by historical sales transactions over a desired metric—in this case, sales by region. A policy may then be used to generate logic that will then generate a transaction item.

In this manner, a price list of one or many items reflecting a calculated rebate may be automatically conformed to a given policy and stored for use by a sales force, for example. In this example, a rebate may be considered as providing guidance to a sales force. Furthermore, historical data may be used to generate configuration suggestions, and for analytics.

In some embodiments, policies are derived strictly from historical data. In other embodiments, policies may be generated ad hoc in order to test effects on pricing based hypothetical scenarios. In still other examples, executive committee(s) 220, who implements policies, may manually enter any number of policies relevant to a going concern. For example, an executive committee(s) 220 may incorporate forecast data from external sources 224 or from historical data stored in a historical database in one embodiment. Forecast data may comprise, in some examples, forward looking price estimations for a product or product set, which may be stored in a transaction and policy database. Forecast data may be used to generate sales policies such as guidance and suggestion as noted above. Still further, forecast data may be utilized by management teams to analyze a given deal to determine whether a margin corresponding to a deal may be preserved over a given period of time. In this manner, an objective measure for deal approval may be implemented. Thus forecast data, in some examples, may be used either to generate sales policy, to guide deal analysis, or both. Thus, in this manner, policies may be both generated and incorporated into the system.

After transactions are generated based on policies, a transactional portion of the database may be used to generate sales quotes by a sales force 216 in SAP 212, for example. SAP 212 may then generate a sales invoice which may then, in turn, be used to further populate a historical database 204 including the deal history database 114 and transaction history database 106. In some embodiments, sales invoices may be constrained to sales quotes generated by a transaction and policy database. That is, as an example, a sales quote formulated by a sales force 216 may require one or several levels of approval based on variance (or some other criteria) from policies (e.g., guidance and suggestion) stored in a transaction and policy database 208. In other embodiments, sales invoices are not constrained to sales quotes generated by a transaction and policy database.

### III. Methods for Generating Segment Sensitivity

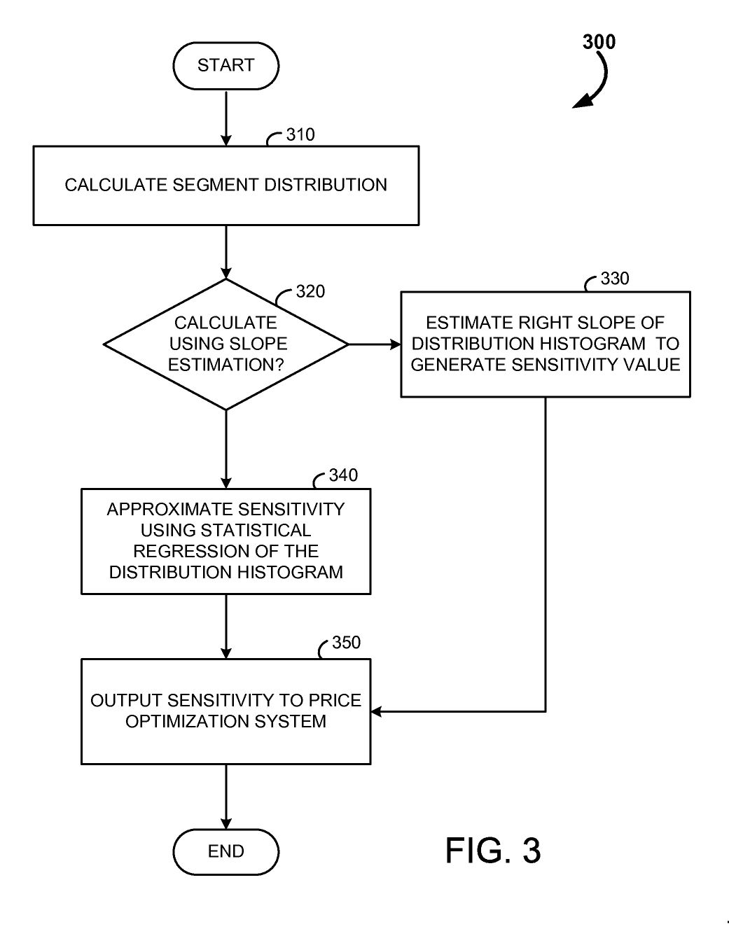

As noted previously, the segment analyzer 130 may be able to utilize the data located in the data warehouse 132 to generate sensitivity measures. FIG. 3 provides an example flowchart 300 for the process of developing these sensitivity values. This process starts by the calculation of a segments transaction distribution (at 310) by parsing through the segment transaction date and generating a histogram of successful transactions by price of said transactions.

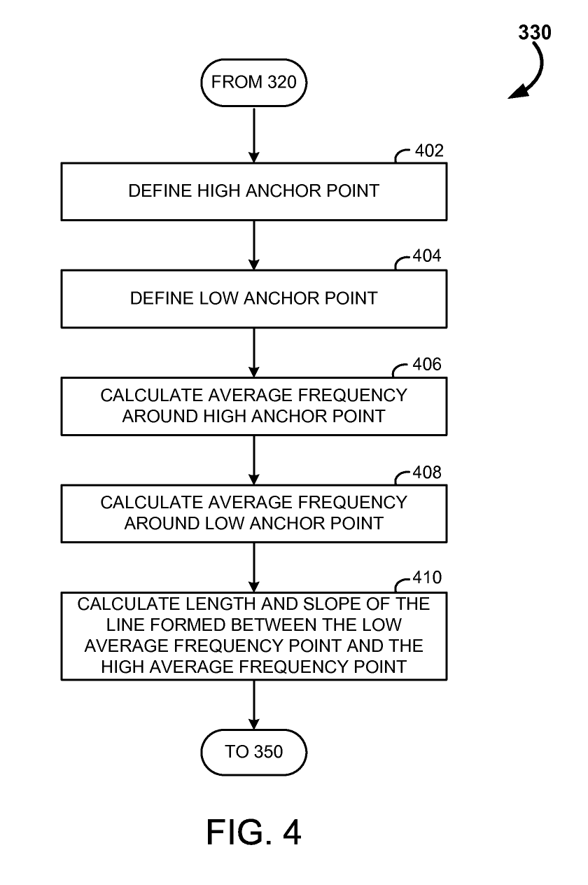

Next the process determines whether to perform a statistical regression (at 340), or a slope estimation (at 330) to approximate the sensitivity of the segment to pricing. Turning briefly to FIG. 4, the process for the estimation of slope is described in greater detail. In this example process, initially a high anchor point is defined (at 402). Likewise a low anchor point is defined (at 404). High and low anchor points may be defined as a percentile of the distribution. In some embodiments, the 55th percentile may be utilized for the high anchor point, and the 90th percentile for the low anchor point, for example.

Once anchor points are defined, the process may derive the average frequencies of transactions for a statistically significant region around the high anchor point (at 406) and the low anchor point (at 408). This averaging process ensures that any noise or other fluctuations in the curve are “smoothed” out, thereby reducing errors. The area averaged over may vary depending upon the data completeness, in some embodiments. For example, where data is very complete, with substantial transactions within the distribution, a smaller average is required in order to get a representative frequency count for the anchor points. In contrast, in data poor distributions, there may be significant variation in frequency numbers, and a larger average may be desirable. In yet other embodiments, a set area is averaged for the sake of simplicity (i.e. 2 percentile to either side of each anchor.

Lastly, the process calculates the slope of the line connecting the average frequency measures at the anchor points (at 410). Likewise the line segment length may be calculated. This provides an estimation of the segment sensitivity to price.

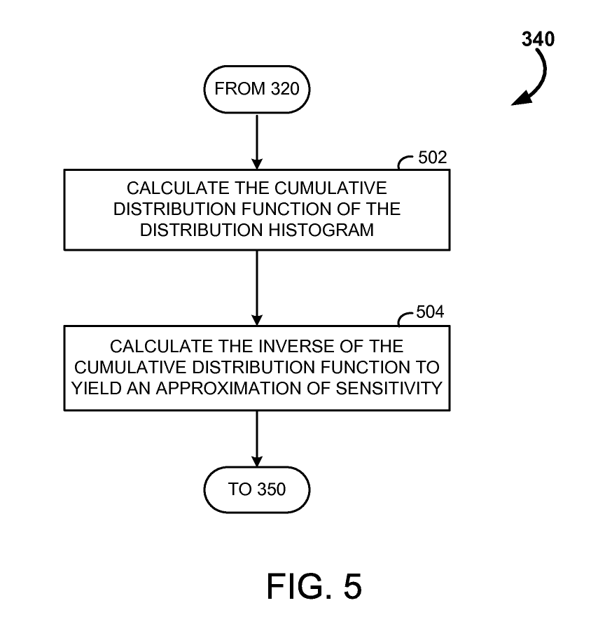

If statistical regression is used instead of slope estimation, then the process resembles that as seen in FIG. 5. In this example flowchart, the Cumulative Distribution Function (CMF) of the distribution histogram is calculated (at 502). Next the inverse of the CMF is calculated to yield a slightly different, yet still representative approximation of price sensitivity (at 504).

Returning to FIG. 3, after the sensitivity has been calculated, the sensitivity measure may be output (at 350) to a price optimization system, or other downstream analytical system. The next subsection shall illustrate how the inverse CMF, and the slope estimation described herein, approximate price sensitivity, and the value that this provides the price optimization system and/or other analytic tools.

### IV. Distribution Examples

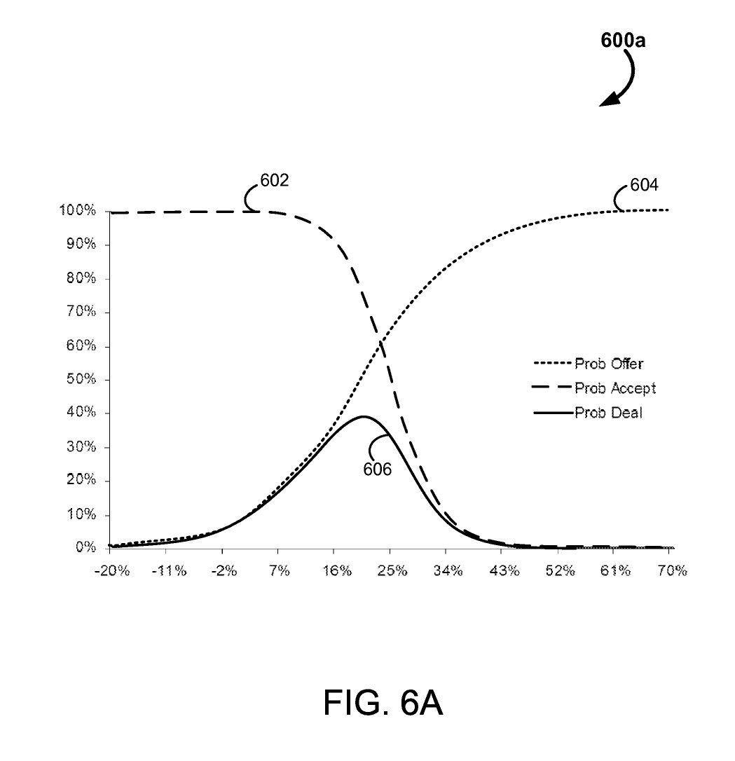

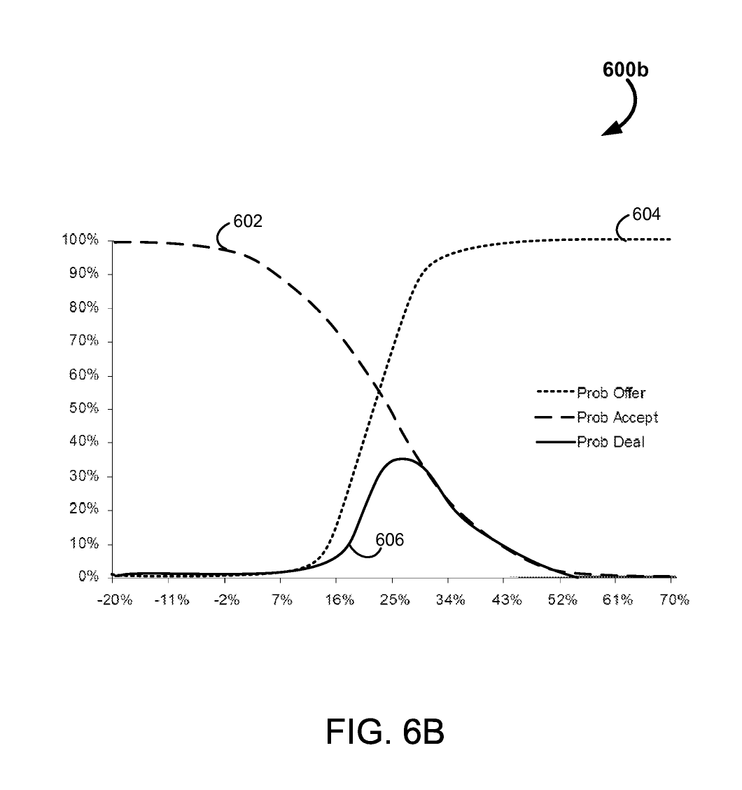

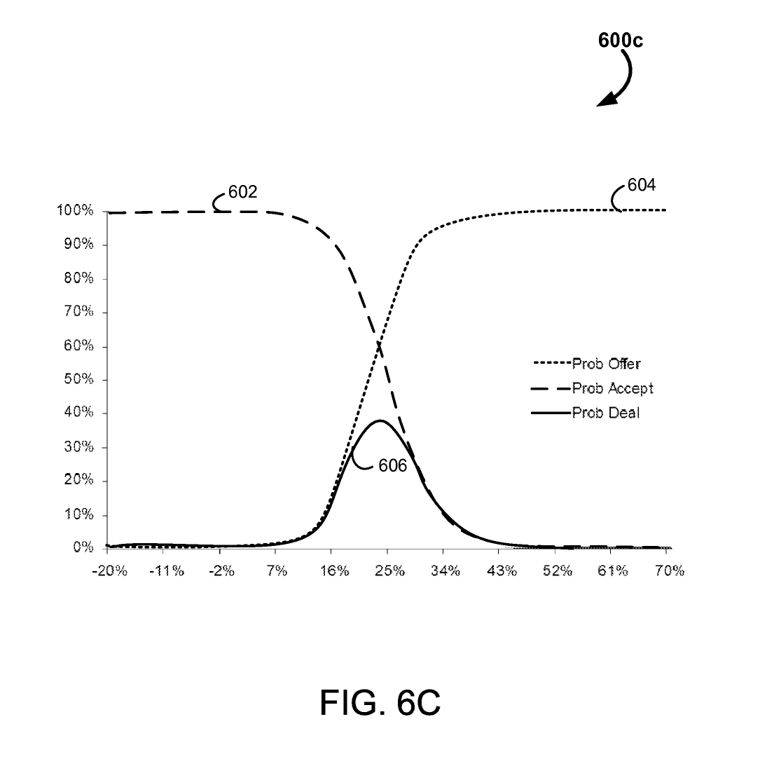

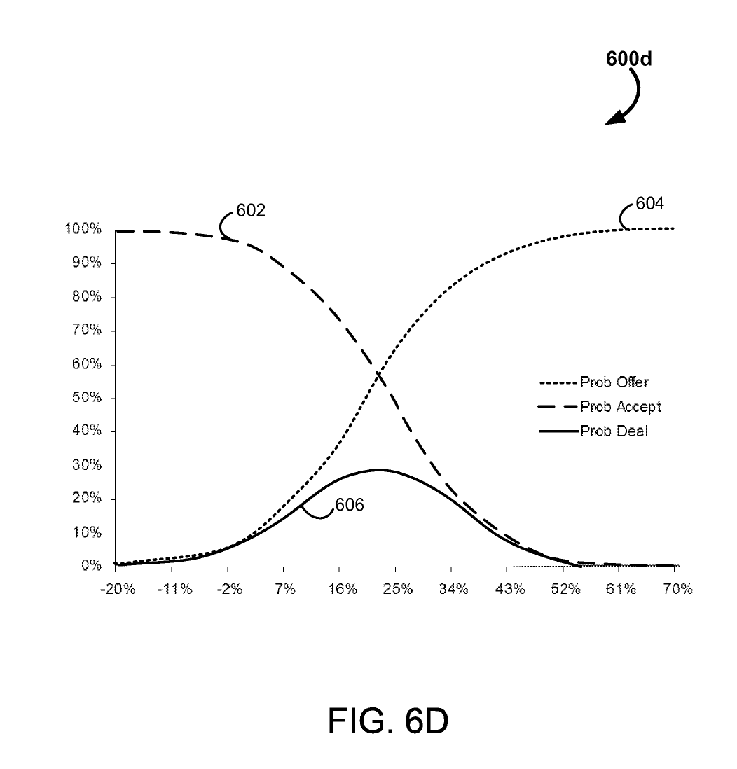

FIGS. 6A, 6B, 6C and 6D are example diagrams illustrating deal completion probabilities by differing acceptance and offer probability curves, in accordance with some embodiments. As can be expected, the probability of a buyer accepting an offer increases significantly as prices decrease. However, as prices drop, sellers are less likely to want to extend the offer due to loss of profitability. Total margins, costs, competitive landscapes and other market factors dictate the exact probability curves for offer extension by the seller, and the probability of acceptance by the buyer.

The buyer's offer acceptance curve, indicates the sensitivity the seller has to price fluctuations. As such, this probability curve is of extreme interest for price optimizations and other analytics. Unfortunately, this probability curve is not readily evident from transactional data, and must be approximated by the systems and methods described herein.

What is measurable from the transactional data is the probability of a deal being completed. Transactional logs include pricing of successful deals. By forming a histogram of the transaction frequencies, as a function of transaction price, this deal probability can be modeled.

Turning to FIG. 6A, an example probability graph 600a is provided. Here, the offer acceptance curve 602 is near 100% at the lower prices, but decreases rapidly as prices increase. In contrast, the probability curve 604 of the seller providing the offer gradually increases as the price increases. These two probability curves generally form boundaries of the probability curve 606 for deal acceptance. This probability curve is generally a normal bell curve, skewed to comport to the offer and acceptance probability curves.

FIG. 6B provides a second probability graph 600b for a segment that has a much lower sensitivity for price changes. This is reflected in an offer acceptance probability curve 602 which is far more gradual, and extends over a much larger price range. Offer probability 604 is still relatively sharp, indicating that there is little flexibility in pricing by sellers. This causes the deal probability curve 606 to skew significantly to the right.

In contrast, FIG. 6C provides a probability graph 600c where the price sensitivity is much higher, which is indicated by a much steeper probability in acceptance curve 602. Offer probability 604 is still relatively sharp, indicating that there is little flexibility in pricing by sellers. This causes the deal probability curve 606 to be more narrow and sharp.

In FIG. 6D, the probability graph 600d is for a segment that is has a much lower price sensitivity, indicated by a much more gradual acceptance probability curve 602. Likewise, due to larger margin, higher competition, etc. there is likewise more flexibility in pricing for the offer to be proposed by the seller, indicated by the probability of offer curve 604. Ultimately, these conditions result in a deal probability curve 606 which is a very low and broad normal bell curve.

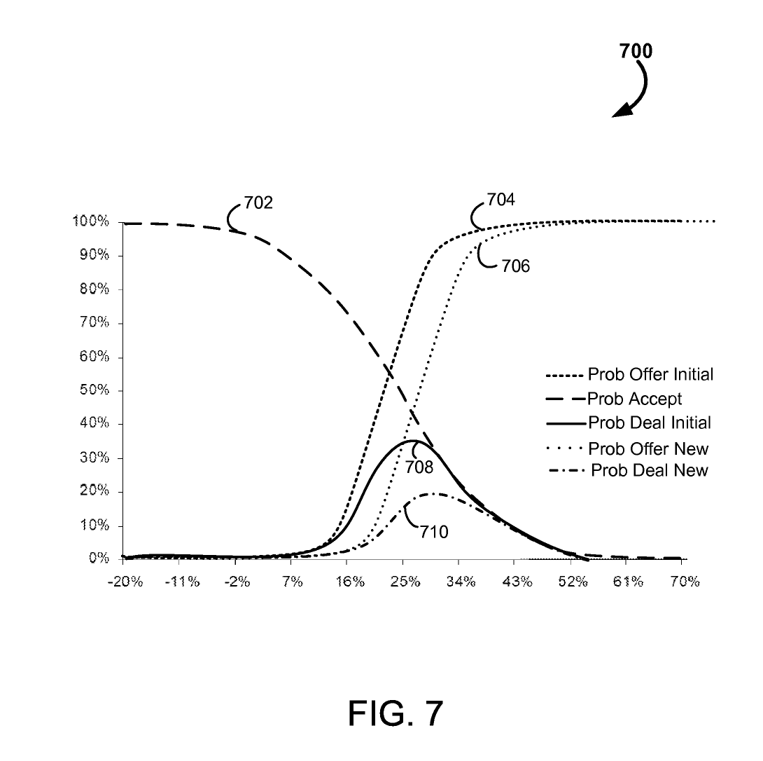

As seen in these examples, the shape and amplitude of the deal probability curves are highly correlated and dependent upon the offer and acceptance probabilities. Thus, these curves can be used to model impacts upon price change policies. For example, turning to FIG. 7, a set of probability curves are provided. The probability of accepting an offer is a static curve 702. This curve indicates a segment which is relatively not sensitive to price changes. The probability of providing the offer is indicated in two curves, an initial probability at 704, and a secondary probability 706 where a pricing policy is implemented to increase the selling price by a set percentage.

These two selling positions thus result in different deal probability curves, one for the initial condition 708, and a second for the higher priced policy 710. The amplitude of the probability curves decreases as the higher pricing policy is implemented, as is to be expected. This suggests that overall deal volume will also decrease. However, the higher pricing policy also skews the curve to higher deal prices. This impact upon average deal price, by predicted volume effect can be utilized to determine the overall profitability of a new pricing policy.

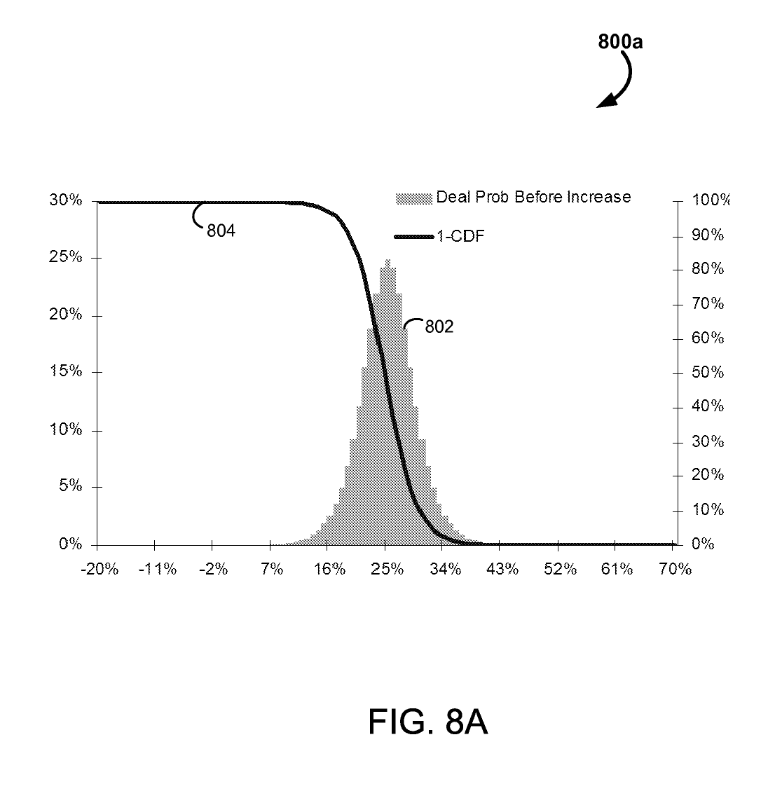

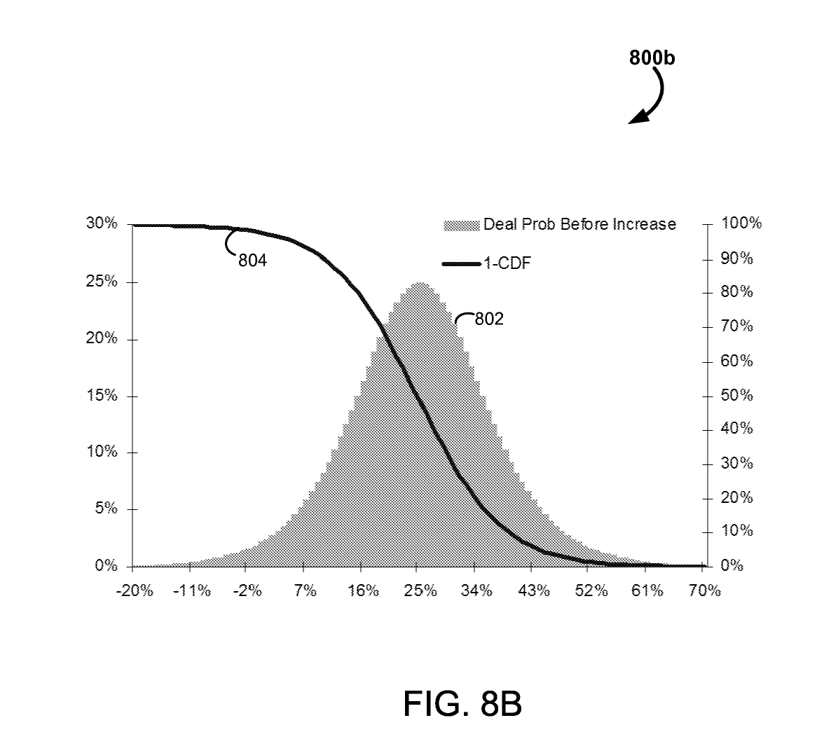

Now that the probability curves, and their meanings, have been explained for transactions within a B2B environment, specific examples of quantifying segment price sensitivity shall now be provided. First, turning to FIG. 8A, a graph 800a illustrating a histogram 802 of pricing versus frequency of deal success is provided. This histogram 802 may be readily derived from past transaction data. Here the graph shape is seen to be a relatively narrow normal curve, which suggests a relatively high sensitivity to price increases, and little pricing flexibility (similar to the example of FIG. 6C). In this example, the inverse CDF 804 is calculated for this distribution. As can be seen, the inverse CDF is relatively steep. This curve slope indicated the sensitivity to price for this segment.

In contrast, in relation to the graph 800b of FIG. 8B, a far broader histogram 802 distribution is provided. This indicates more flexibility in pricing by the sellers, and less pricing sensitivity by the buyers (similar to the example of FIG. 6D). In this example, the inverse CDF 804 is calculated for this distribution. As can be seen, the inverse CDF is relatively gentle of a curve, which indicates a lower sensitivity to price changes.

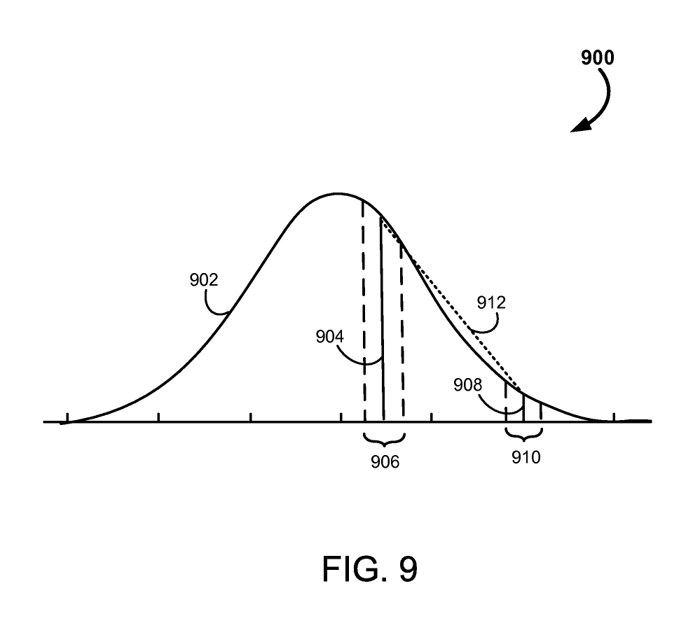

As previously discussed, rather than relying upon the inverse CDF of the deal probability histogram for determining sensitivity, an approximation of the distribution slope can alternatively be utilized. FIG. 9 provides a graphical 900 explanation of how such an approximation may be completed. In this example, the probability curve 902 is seen as a normal bell curve. The right side slope of the curve is approximated in order to generate a sensitivity value.

As previously indicates, a high point anchor 904 is designated, as well as a low point anchor 908. These anchors may be assigned as a percentage of the pricing curve (55% and 95%, for example). Next, the frequency of deals is then averaged for an area around the high and low anchors, indicated at 906 and 910, respectively. This averaging step ensures that any localized frequency perturbations do not artificially skew the results. Lastly a line 912 is generated between the high and low averages. The slope of this line 912 indicates segment price sensitivity.

### V. Pricing System

### A. System Overview

Now that the generation of price sensitivities has been explained in significant detail, attention shall be directed to the usage of this sensitivity for the generation of pricing guidance. As previously noted, price sensitivity is a very important indicator of pricing “power” of the seller. Pricing power and pricing risk may be employed to assist in the generation of pricing guidance, as will be described in more detail below.

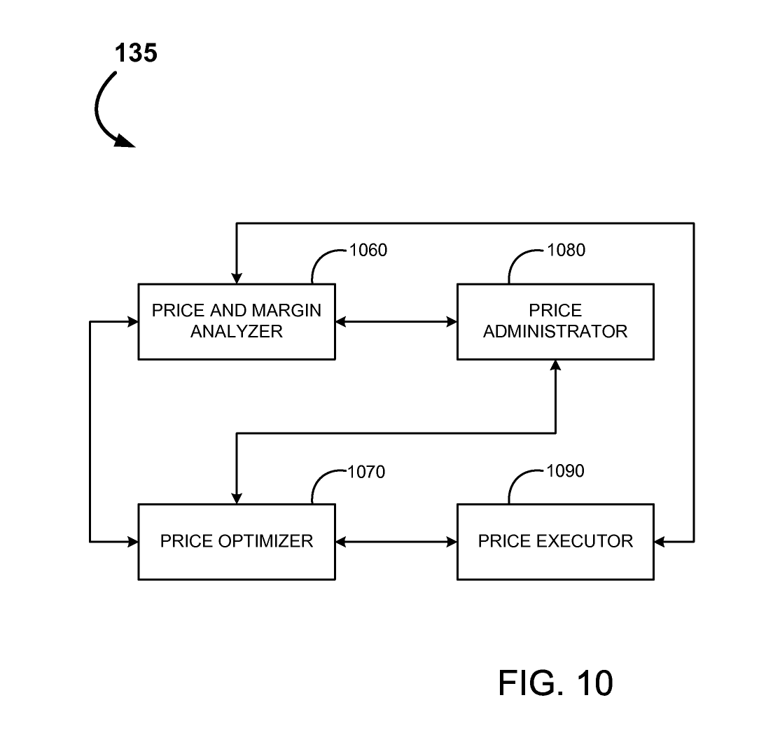

To further facilitate discussion, FIG. 10 is an exemplary Integrated Price Management System 135, as first seen in FIG. 1A, for generating optimized price changes and generating business guidance in accordance with an embodiment of the present invention. The Integrated Price Management System 135 may include a Price and Margin Analyzer 1060, a Price Optimizer 1870, a Price Administrator 1080, and a Price Executor 1090. The Price and Margin Analyzer 1060 may couple to each of the Price Optimizer 1870, the Price Administrator 1080 and Price Executor 1090. Likewise, the Price Optimizer 1870 may couple to each of the Price and Margin Analyzer 1060, Price Administrator 1080 and Price Executor 1090. However, in some embodiments, the Price Administrator 1080 and Price Executor 1090 may couple to the Price and Margin Analyzer 1060 and the Price Optimizer 1870 only.

The Price and Margin Analyzer 1060 may provide detailed understanding of the business context. This understanding may include analyzing pricing results and processes. Segment hypothesizes may likewise be generated by the Price and Margin Analyzer 1060. This segment hypothesis may then be tested and refined.

The Price Optimizer 1870 may utilize segment hypotheses, segment sensitivity, product data and client input in order to generate quotations for deal negotiation. The present embodiment of the Price Optimizer 1870 may utilize Pricing Power for given products or business segments (Power) and Pricing Risk for given products or business segments (Risk) in order to generate pricing guidance. Generated guidance from the Price Optimizer 1870 may be output to the Price Administrator 1080 and the Price Executor 1090.

The Price Administrator 1080 may utilize the generated guidance to generate approvals and facilitate deal evaluations. Pricing management may likewise be performed by the Price Administrator 1080.

The Price Executor 1090 may include the actual implementation of the generated and approved pricing.

### B. Price Optimizer

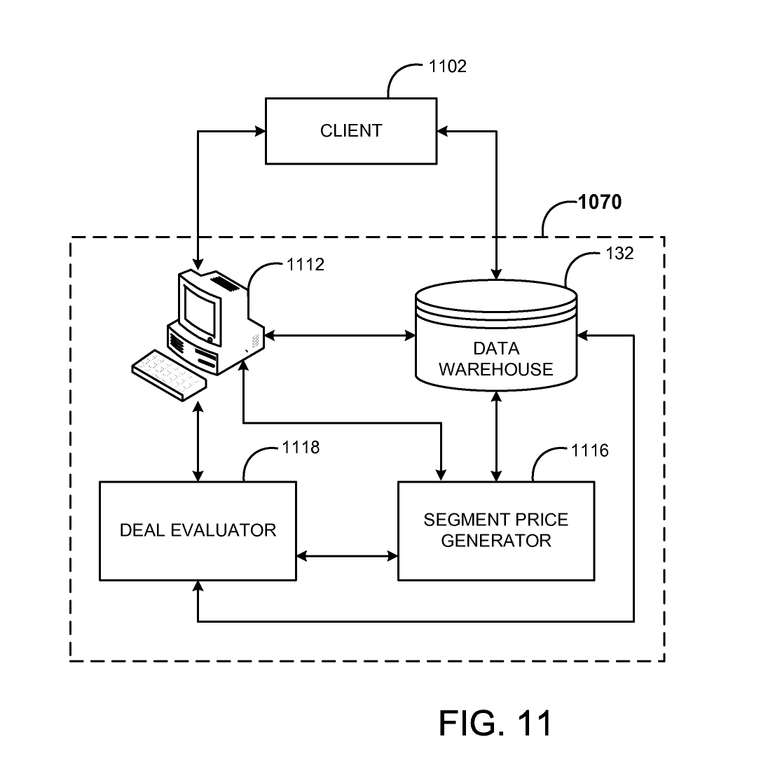

FIG. 11 is an exemplary Price Optimizer 1870 for use with the Integrated Price Management System 135 in accordance with an embodiment of the present invention. As can be seen, the Price Optimizer 1870 may include an Interface 1112, a Deal Evaluator 1118, and a Segment Price Generator 1116. Additionally, the Data Warehouse 132 may be included in the Price Optimizer 1870 in some embodiments. In some alternate embodiments, the Price Optimizer 1870 may access an external Data Warehouse 132.

The Data Warehouse 132 may be populated with data from the Client 1102. This data may include product data, customer data, transaction data, inventory data, cost data, segment data, transaction and deal data, and other data pertinent to pricing. Segment Data may additionally include product types, attributes, channel, transaction and market data.

The Client 1102 may, additionally, be enabled to access the Interface 1112. The Interface 1112 may provide the Client 1102 connectivity to the Deal Evaluator 1118 and the Segment Price Generator 1116. Additionally, generated pricing data and analytics may be provided to the Client 1102 via the Interface 1112. In some embodiments, the Interface 1112 may provide the means for the Client 1102 to add data to the Data Warehouse 132.

The Segment Price Generator 1116 may couple to the Interface 1112 and Data Warehouse 132 and may generate product segments and optimized pricing. The Segment Price Generator 1116 may utilize input from the Client 1102 via the Interface 1112, along with data form the Data Warehouse 132 in the generation of the segment and pricing data. Pricing data may include price approval levels, target prices and price change allocation suggestions. All pricing data may be by line item, or may be by a larger product aggregate, such as by segment, brand, or other grouping.

The Segment Price Generator 1116 may output the segment and pricing data to the Deal Evaluator 1118 for evaluation of received deal proposals. Likewise, these segments are utilized by the sensitivity analyzer for generation of segment price sensitivity. These deal evaluations may be of use in facilitating profitable deals, and may be used to guide business decisions by the Client 1102. Analysis from the evaluations may be provided to the Client 1102 via the Interface 1112. Evaluation data may be used by the Price Administrator 280 and Price Executor 290 for downstream applications.

Note that, in some embodiments, the Segment Price Generator 1116 may be a stand alone system capable of generating pricing data and segment data independently from the Integrated Price Management System 135 or the Price Optimizer 1870 as a whole. Is such embodiments, the output from the Segment Price Generator 1116 may then be utilized by managers directly, or may be input into another price managing system. It is thus intended that each component of the Integrated Price Management System 135 be relatively autonomous and capable of substitution, deletion, or modification as to generate a desired performance of the Integrated Price Management System 135.

### C. Product Segment Price Generator

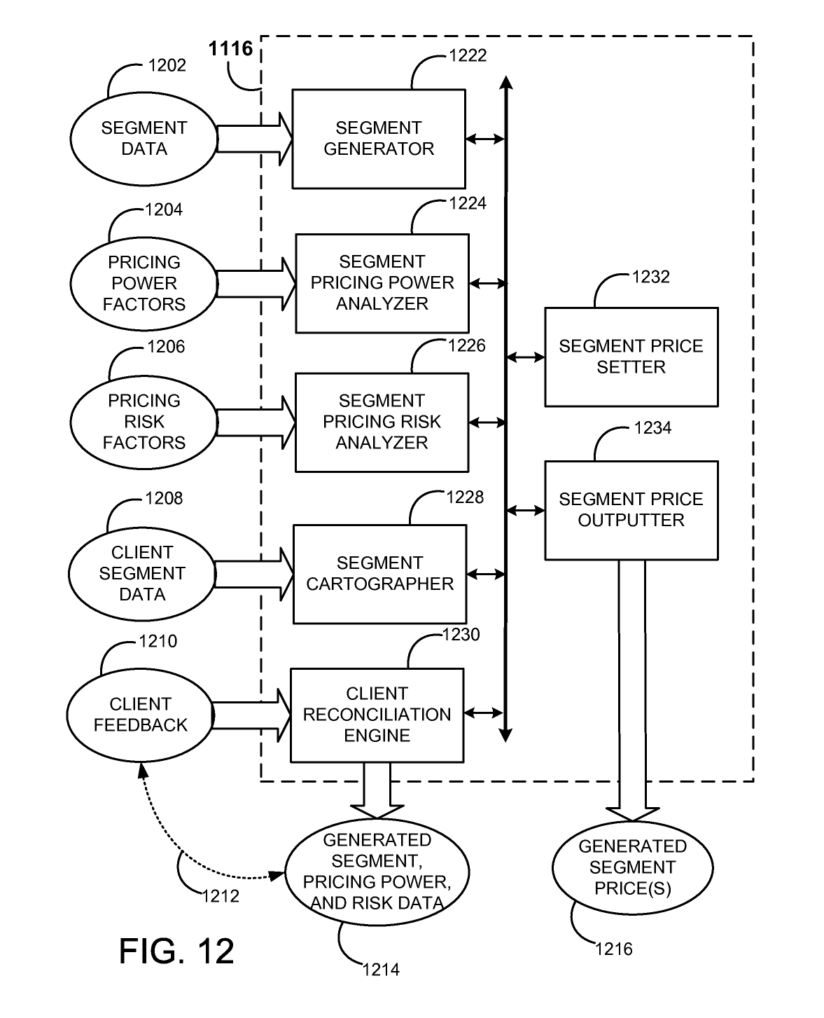

FIG. 12 is an exemplary illustration of the Segment Price Generator 1116 for use with the Price Optimizer 1870 of the Integrated Price Management System 135. The Segment Price Generator 1116 may include any of the following components: a Segment Generator 1222, a Segment Power Analyzer 1224, a Segment Pricing Risk Analyzer 1226, a Segment Cartographer 1228, a Client Reconciliation Engine 1230, a Segment Price Setter 2032 and a Segment Price Outputter 1234. Each component of the Segment Price Generator 1116 may be coupled to one another by use of a bus. Likewise, a network or computer architecture may provide the coupling of each component of the Segment Price Generator 1116. Of course additional, or fewer components may be included within the Segment Price Generator 1116 as is desired for operation capability or efficiency.

The Segment Generator 1222 may receive Segment Data 1202 from the Client 1102 or from data stored in the Data Warehouse 132. The Segment Generator 1222 may generate one or more segments from the segment data. As previously mentioned, segment data may include product ID, product attributes, sales channel data, customer data, transaction data and market data. In some embodiments, additional customer and channel data may be provided to the Segment Generator 1222 as is needed (not illustrated).

The Segment Generator 1222 may use the inputted data to generate segments. Segments may also be referred to as business segments. Typically segments may be generated at the transaction level by considering different attributes, such as product similarities, sales channel similarities, customer similarities, transaction similarities and market similarities. In some embodiments, segmentation may rely upon presets, and products and sales channels may be fit to a segment preset. Additionally, attributes of the product may be used to switch products to different segments. Client override of segments is also considered.

In some embodiments, attributes for segmentation can be static (non-changing) or dynamic (changing over time). Examples of static business segments include: Product segments: Product Family, Product Group, Product Type (e.g., Commodity, Specialty, Competitive), Product Use (e.g., Core Products, Add-on Products, Maintenance Products); Customer segments: Customer Geography, Customer Region, Customer Industry, Customer Size, Customer Relationship (e.g., Primary provider, Spot Purchase, Competitive).

Examples of dynamic business segments include: Product segments: Product Lifecycle (New, Growing, Mature, End-of-life), Product Yearly Revenue Contribution (A=Top 30% of total revenue, B=Next 30%, C=Bottom 40%), Product Yearly Profit Contribution, Customer segments: Customer Yearly Revenue Contribution, Customer Yearly Profit Contribution, Customer Product Purchase Compliance (customers who order less than certain percent of quoted products), Order Compliance (customers who order less than committed volumes from quote or contract), Payment Compliance (customers who pay their invoices outside of pre-agreed payment terms defined in quote or contract).

Generally, the purpose of segmentation is to group transactions in a way where all transactions in the segment react to changes in pricing and events (such as promotions and demand shifts) in a similar fashion. Regardless of method of segment selection, this purpose, that all transactions in the segment react in a similar manner, is maintained.

The Segment Power Analyzer 1224 receives the segment data from the Segment Generator 1222 and, with additional Power Factors 1204 (including sensitivity) that are gathered from the Client 1102 or the Interface 1112, may generate an initial quantitative pricing power score for each segment. Pricing power factors may also include presets stored within the Segment Power Analyzer 1224. Examples of pricing power factors include, but are not limited to, price sensitivity, price variance, approval escalations, win ratios, and elasticity. Pricing power, also known as the segment's power value, or simply ‘power’, is an indicator of the ability for the Client 1102 to realize a price increase. Thus, segments with a large pricing power score will typically be able to have their price increased without shifting business away from the segment.

The Segment Power Analyzer 1224 may generate the quantitative pricing power scores for each segment by assigning values to each pricing power factor, weighting the factors and taking a weighted average of the factors. It should be noted that the pricing power factor arrived at using such a method is considered ‘quantitative’, since this is a mathematically derived scientific value. In contrast, a ‘qualitative’ pricing power score may be defined by a knowledgeable individual within the Client 1102. Qualitative pricing power scores include the manager's (or other knowledgeable individual) “gut feel” and business expertise to determine a relative pricing power scoring from segment to segment. Typically, the qualitative pricing power score may be given for client defined segments which are often larger and more coarsely segmented than the generated segments. Later it will be seen that the quantitative pricing power score and qualitative pricing power score may be reconciled to generate a calibrated pricing power score for each segment.

In a similar manner, the Segment Pricing Risk Analyzer 1226 receives the segment data from the Segment Generator 1222 and, with additional Pricing Risk Factors 1206 that are gathered from the Client 1102 or the Interface 1112, may generate an initial quantitative pricing risk scores for each segment. Pricing Risk factors may also include presets stored within the Segment Pricing Risk Analyzer 1226. Examples of pricing risk factors include, but are not limited to, total sales, sales trends, margin, and percent of total spend. Pricing risk, also known as the segment's risk value, is an indicator of what is at stake for the Client 1102 if a price increase is not realized (loss of some or all segment business). Thus, segments with a large pricing risk score may often be key sales (either by volume, profit, or by customer) to the Client 1102.

The Segment Pricing Risk Analyzer 1226 may generate the quantitative pricing risk scores for each segment by assigning values to each pricing risk factor, weighting the factors and taking a weighted average of the factors. Again, the pricing risk factor arrived at using such a method is considered ‘quantitative’, since this is a mathematically derived scientific value. In contrast, a ‘qualitative’ pricing risk score may be defined by a knowledgeable individual within the Client 1102. Qualitative pricing risk scores, as with pricing power scores, include the manager's (or other knowledgeable individual) “gut feel” and business expertise to determine a relative pricing risk scoring from segment to segment. Typically, the qualitative pricing risk score may be given for the same client defined segments as used for qualitative pricing power score. These client segments are often larger and more coarsely segmented than the generated segments. As with pricing power, it will be seen that the quantitative pricing risk score and qualitative pricing risk score may be reconciled to generate a calibrated pricing risk score for each segment.

A Segment Elasticity Determiner (not illustrated) may, in some embodiments, be an optional component. The Segment Elasticity Determiner may rely upon transaction data for the generation of elasticity variables. In some embodiments, the Segment Elasticity Determiner may be enabled to only generate elasticity variables for segments where there is sufficiently rich transaction history to generate optimized pricing through traditional means. This may be beneficial since, given a rich transaction history, traditional demand modeling may be performed in a very accurate manner. Thus, where the history supports it, demand models and optimized prices may be generated. These prices may then be implemented directly, or may be included into the set pricing utilizing price power and risk scores. Of course, in some alternate embodiments, the Segment Elasticity Determiner may be omitted due to the relative scarcity of transaction data. In some embodiments, the sensitivity analyzer 130 may be included as a component as opposed to as a separate system.

The Segment Cartographer 1228 may receive Client Segment Data 1208 and segment data generated by the Segment Generator 1222. The Segment Cartographer 1228 may compare the Client Segment Data 1208 and generated segment data to produce a segment map. The segment map may indicate which of the generated segments, when aggregated, are comparable to the client segments.

The Client Reconciliation Engine 1230 may receive the quantitative pricing power score for each segment from the Segment Pricing Power Analyzer 1224 and the quantitative pricing risk score for each segment from the Segment Pricing Risk Analyzer 1226. Generated Segment, Pricing Power and Pricing Risk Data 1214 may be output to the client. This data may be output as a plot, known as a ‘pricing power and risk plot’, for ease of user consumption.

The Client Reconciliation Engine 1230 may also receive qualitative pricing power and risk scores for client defined segments as part of Client Feedback 1210. The Client 1102 may review the outputted Data 1214 at 1212 when determining the Client Feedback 1210. Differences between the received qualitative pricing power and risk scores and the generated quantitative pricing power and risk scores may then be reconciled. Reconciliation may include determining errors in the qualitative score, identification of unknown factors, modifying segment groupings and applying a calibration to the quantitative pricing power and risk scores such that they adhere to the qualitative pricing power and risk scores. Much of the application will be discussing the particulars of this reconciliation below.

In addition to qualitative pricing power and risk scores, the Client Feedback 1210 may also include client segment data, criticisms of pricing power and risk factor values and/or weights, unknown factors, and additional information.

The Segment Price Setter 2032 may receive the calibrated pricing power and risk scores from the Client Reconciliation Engine 1230 and use them, in conjunction with various business goals, to generate prices for each segment. This may often be performed by receiving the pricing power and risk scores and plotting them. Tradeoff price change contours or a price change grid (matrix) may be applied to the plot to achieve an overall business goal. For example, the goal may be to raise prices a total of 5% while minimizing pricing risk. By applying the pricing risk and pricing power plot to this goal, a price change value may be generated for each segment where segments with high pricing risk receive little, or even a negative price change. Low pricing risk segments, on the other hand, will have a larger price increase in this example. An example of a tradeoff contour includes isometric curves. Particularly, in some embodiments, hyperbolic curve functions are considered.

The Segment Price Outputter 1234 may receive the prices and business guidance generated by the Segment Price Setter 2032 and may output this information as Generated Segment Price(s) 1216. The Generated Segment Price(s) 1216 may be utilized directly by the management and sales teams of the Client 1102, or may be used for further downstream operations. For example, the Generated Segment Price(s) 1216 may, in some embodiments, be provided to the Deal Evaluator 1118 for evaluation of deal terms, or to the Price Executor 1090 for execution.

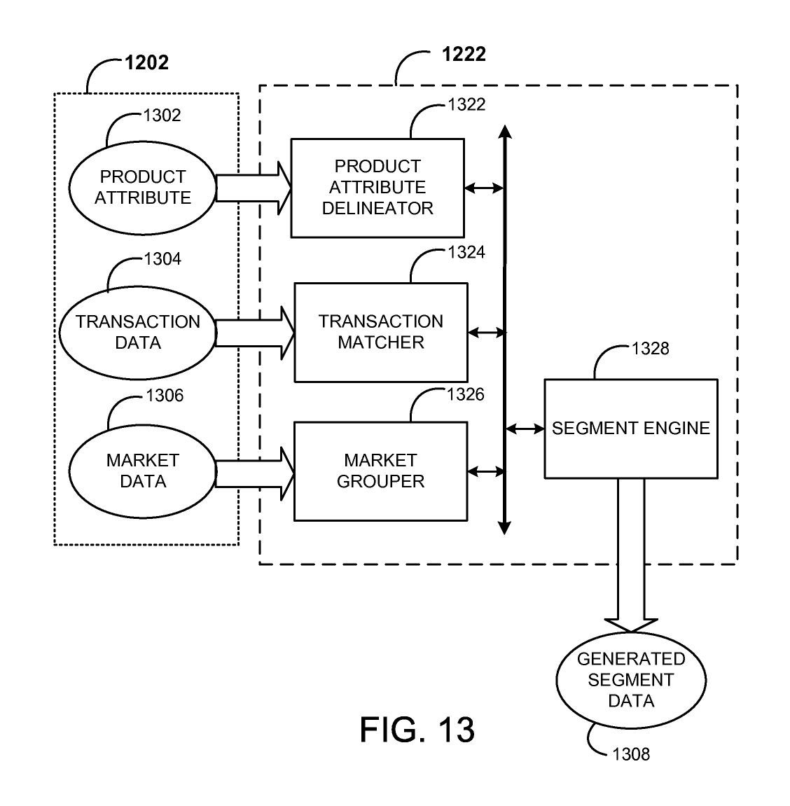

FIG. 13 is an exemplary illustration of the Segment Generator 1222 for use with the Segment Price Generator 1116 of the Price Optimizer 1870 in the Integrated Price Management System 135. Here the Segment Generator 1222 may be seen as including a Product Attribute Delineator 1322, a Transaction Matcher 1324, a Market Grouper 1326 and a Segment Engine 1328. A central bus may couple each component to one another. Additionally, any network system, or computer hardware or software architecture may be used to couple the components of the Segment Generator 1222 to one another.

Also visible is the Segment Data 1202, which is shown to include Product Attributes 1302 data, Transaction Data 1304, and Market Data 1306. Although not illustrated, the Segment Data 1202 may also include client data such as channels, region, customer demographic, etc. Segment analysis of products, transactions and customers may be performed at a ‘transaction level’. That is, a single transaction's details may be analyzed to find similarities across product, customer and transaction attributes. The intent is to create a common base of comparison across seemingly unrelated records and extract insights on what is really driving better price and margin realization.

The Product Attributes 1302 data may be received by the Product Attribute Delineator 1222. The Product Attribute Delineator 1222 may then aggregate products into segments by similarities in product attributes. Such similarities may include functional similarities, such as hardware components, by brand, by price, by quality, or by any other relevant product attribute.

The Transaction Data 1304 may be received by the Transaction Matcher 1224 which may then fit the products of the client according to similarities in the Transaction Data 1304.

The Market Data 1306 data may be received by the Market Grouper 1426. The Market Grouper 1426 may the define segments according to market similarities.

Products that do not fit within any particular product category may be assigned an arbitrary segment, or may be defined as their own segment. Alternatively, product attributes may be used to determine segments for these products. Of course, additional segmentation methods may be applied, such as segments by common consumer demographic, segments by price ranges, segments by sales channels, segments by related use, season, or quality, and segment by client feedback, just to name a few.

Each of the operations performed by the Product Attribute Delineator 1222, Transaction Matcher 1224 and the Market Grouper 1226 may be performed in series or in parallel. In some embodiments, only some of the methods for segmentation may be utilized, and disagreements between segments may be resolved in any of a myriad of ways by the Segment Engine 1228 which creates the Generated Segment Data 1308. For example, in some embodiments, the client's Transaction Data 1304 may form the basis of the segments in the Transaction Matcher 1224. Segments may be generated comprised of most of the client's products, but some products were unable to be fit into any of the Transaction Data 1304. These products may then undergo product attribute analysis by the Product Attribute Delineator 1222. The analysis may determine which segment these unusual products fit within, and the segments may be updated to reflect the additional products. Then the Market Grouper 1226 may perform a segment check to determine that the segments adhere to particular market delineations. Client feedback may also be considered, such as having a single segment for all highly acidic chemicals. If such an incompatibility is identified then, in the present example, the segments may again be modified to adhere to the client requirements. Of course other segment inconsistencies and generation techniques are contemplated by the present invention. The above example is intended to clarify one possible method for segment generation as is not intended to limit the segment generation for the present invention.

Generation of segments may include a subjective hypothesis generation and testing or may involve the use of a computerized segment optimization routine.

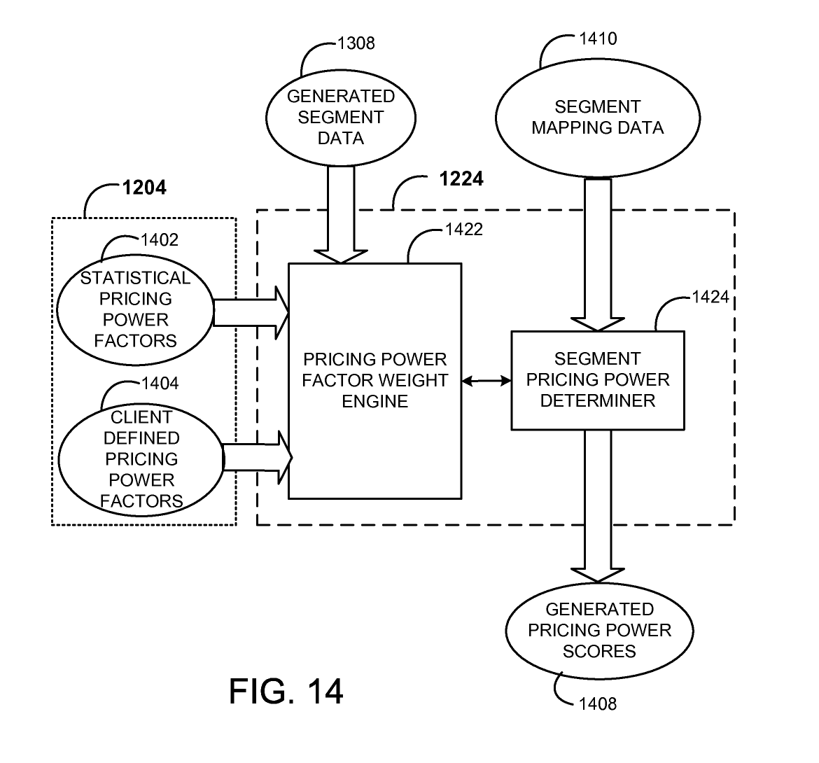

FIG. 14 is an exemplary illustration of the Segment Pricing Power Analyzer 1224 for use with the Segment Price Generator 1116 of the Price Optimizer 1870 in the Integrated Price Management System 135. The Segment Pricing Power Analyzer 1224 may include a Pricing Power Factor Weight Engine 1422 coupled to a Segment Pricing Power Determiner 1424. The Segment Pricing Power Determiner 1424 receives Segment Mapping Data 1410 from the Segment Cartographer 1228. This segment data may be also provided to the Pricing Power Factor Weight Engine 1422 so that pricing power factors are generated for the proper segments. Likewise, this segment data may be also provided to the sensitivity analyzer 130 for sensitivity value generation.

The Pricing Power Factor Weight Engine 1422 may receive the Generated Segment Data 1308 and the Pricing Power Factors 1204. The Pricing Power Factors 1204 may include Statistical Pricing Power Factors 602 and Client Defined Pricing Power Factors 1404. All of these factors are input into the Pricing Power Factor Weight Engine 1422 where values for the factors are assigned. Factor value assignment may utilize user intervention, or may rely upon measurable matrices. For example, win ratios from previous deals found in Deal History Database 114 may be a measured pricing power factor.

Weights are then applied to the pricing power factors. In some embodiments, the weights may initially be set to an equal value, thus counting each power factor equally in the determination of the pricing power score. Alternatively, some default weighing preset may be applied. The default may be industry specific. Also, in some embodiments, the client may provide input for guidance of the weighing factors.

The weighted factors are then averaged within the Segment Pricing Power Determiner 1424 to generate a weighted average pricing power score for each of the generated segments. The Generated Pricing Power Scores 1408 may then be output for raw consumption or for client reconciliation.

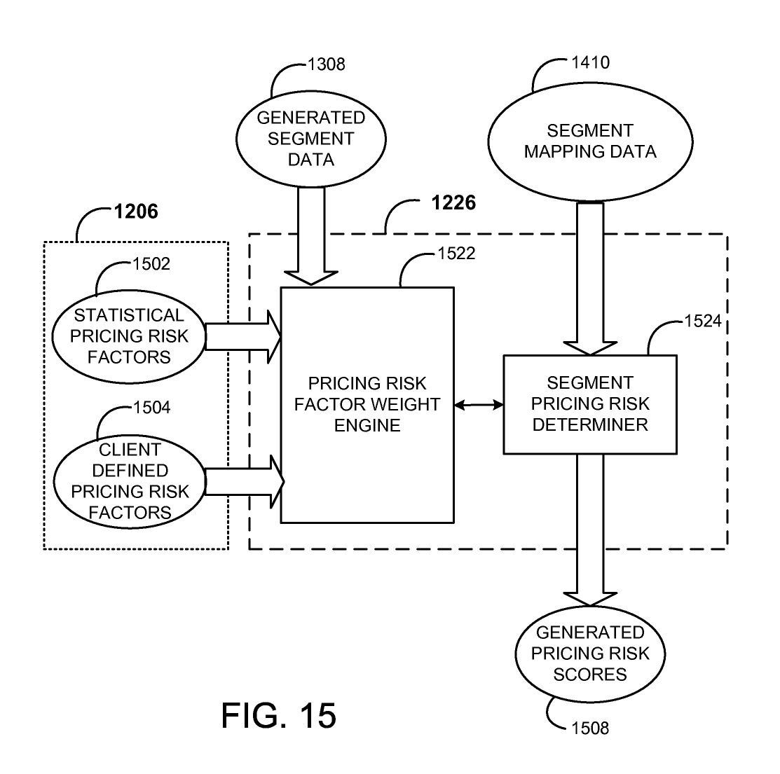

FIG. 15 is an exemplary illustration of the Segment Pricing Risk Analyzer 1226 for use with the Segment Price Generator 1116 of the Price Optimizer 1870 in the Integrated Price Management System 135. Structurally, the Segment Pricing Risk Analyzer 1226 is very similar to the Segment Pricing Power Analyzer 1224 discussed above. The Segment Pricing Risk Analyzer 1226 may include a Pricing Risk Factor Weight Engine 1522 coupled to a Segment Pricing Risk Determiner 1524. The Segment Pricing Risk Determiner 1524 receives Segment Mapping Data 1410 from the Segment Cartographer 1228. This segment data may be also provided to the Pricing Risk Factor Weight Engine 1522 so that pricing risk factors are generated for the proper segments.

The Pricing Risk Factor Weight Engine 1522 may receive the Generated Segment Data 1308 and the Pricing Risk Factors 1206. The Pricing Risk Factors 1206 may include Statistical Pricing Risk Factors 1502 and Client Defined Pricing Risk Factors 1504. All of these factors are input into the Pricing Risk Factor Weight Engine 1522 where values for the factors are assigned. Factor value assignment may utilize user intervention, or may rely upon measurable matrices.

Weights are then applied to the pricing risk factors. In some embodiments, the weights may initially be set to an equal value, thus counting each risk factor equally in the determination of the pricing risk score. Alternatively, some default weighing preset may be applied. The default may be industry specific. Also, in some embodiments, the client may provide input for guidance of the weighing factors.

The weighted factors are then averaged within the Segment Pricing Risk Determiner 1524 to generate a weighted average pricing risk score for each of the generated segments. The Generated Pricing Risk Score 1508 may then be output for raw consumption or for client reconciliation.

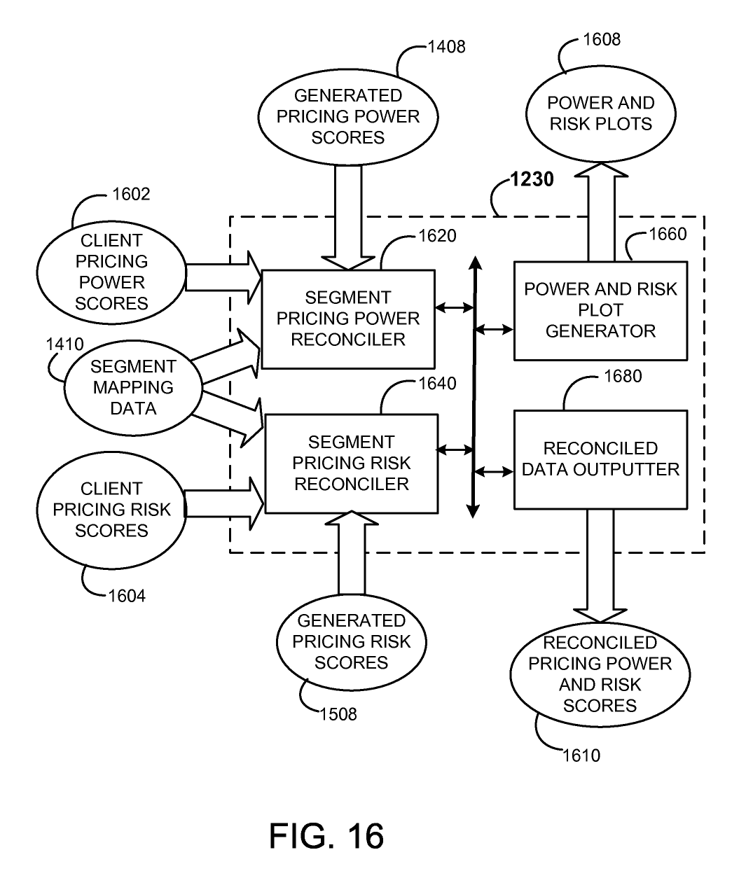

FIG. 16 is an exemplary illustration of the Client Reconciliation Engine 1230 for use with the Segment Price Generator 1116 of the Price Optimizer 1870 in the Integrated Price Management System 135. The Client Reconciliation Engine 1230 may include a Segment Pricing Power Reconciler 1620, a Segment Pricing Risk Reconciler 1640 and a Reconciled Data Outputter 1680. Each component of the Client Reconciliation Engine 1230 may be coupled to one another by use of a bus. Likewise, a network or computer architecture may provide the coupling of each component of the Client Reconciliation Engine 1230.

The Segment Pricing Power Reconciler 1620 may receive Client Pricing Power Scores 1602 from the Client 1102. As previously noted, client segment information tends to be more granular than generated segments. This is due, in part, to the fact that the Integrated Price Management System 135 may generate a large number of segments in order to ensure purchasing behavior is properly modeled. Since a manager at the Client 1102 may not be able to determine pricing power and risk scores for so many segments, they may generate their own segments for which to define qualitative pricing power and risk scores for. In addition, by having fewer segments, the time and effort requirements placed upon the Client 1102 are greatly reduced. Lastly, since managers at the Client 1102 decide client segments, they are typically able to generate more accurate qualitative pricing power and risk scores for these segments (as opposed to determining pricing power and risk for segments generated elsewhere). It should be noted that the term ‘manager’ is intended to include any executive, contractor or employee of the Client 1102 who is authorized to manage price setting. Thus, in some embodiments, a manager may include a senior sales member, who is not necessarily part of the management team.

Additionally, the Generated Pricing Power Scores 1408 and the Segment Mapping Data 1410 may be provided to the Segment Pricing Power Reconciler 1620. The Segment Pricing Power Reconciler 1620 may aggregate the Generated Pricing Power Scores 1408 according to the Segment Mapping Data 1410 to generate comparable aggregate power scores which are compared to the Client Pricing Power Scores 1602.

For this comparison, the segments are then ranked by the size of the gap between the quantitative and the qualitative scores. Segments with small gaps may be accepted, while large gaps may be “drilled into” to determine if there is a segment inconsistency, unknown factor or other reason for the large gap. If such a reason explains the gap, the particular score, be it quantitative or qualitative, may be modified to include the new information. This results in the gap being narrowed and, ideally, making the quantitative score acceptable.

For those segments with large gaps between qualitative and quantitative scores which are not readily attributed to a reason through the drill down, there may be a calibration performed on the quantitative pricing power score to match the qualitative pricing power score. In the calibration, all qualitative scores may be averaged. Likewise, all quantitative scores may be averaged. Average quantitative scores may be compared to the average qualitative scores, and calibration factors may be generated. Again, each quantitative pricing power for each generated segment may then be calibrated using the calibration factor. This calibration may be a linear or nonlinear calibration.

After quantitative scores have been accepted or calibrated the resulting pricing power scores may be known as reconciled pricing power scores. These Reconciled pricing power scores may be provided to the Reconciled Data Outputter 1680 for outputting as part of the Reconciled Pricing Power and Risk Data 1610. Pricing Power and Risk reconciliation will be described in more detail later in the specification.

Likewise, the Segment Pricing Risk Reconciler 1640 may receive Client Pricing Risk Scores 1604 from the Client 1102. Additionally, the Generated Pricing Risk Scores 1508 and the Segment Mapping Data 1410 may be provided to the Segment Pricing Risk Reconciler 1640. The Segment Pricing Risk Reconciler 1640 may aggregate the Generated Pricing Risk Scores 1508 according to the Segment Mapping Data 1410 to generate comparable aggregate risk scores which are compared to the Client Pricing Risk Scores 1604. This comparison may be performed in a manner similar as that described above in relation to power scores.

The reconciled pricing power and risk scores may be compiled by the Reconciled Data Outputter 1680. These Reconciled Pricing Power and Risk Scores 1610 may then be output for deal guidance and pricing purposes. Likewise, the Power and Risk Plot Generator 860 may generate and output Pricing Power and Risk Plots 1608 for user consumption and downstream analysis.

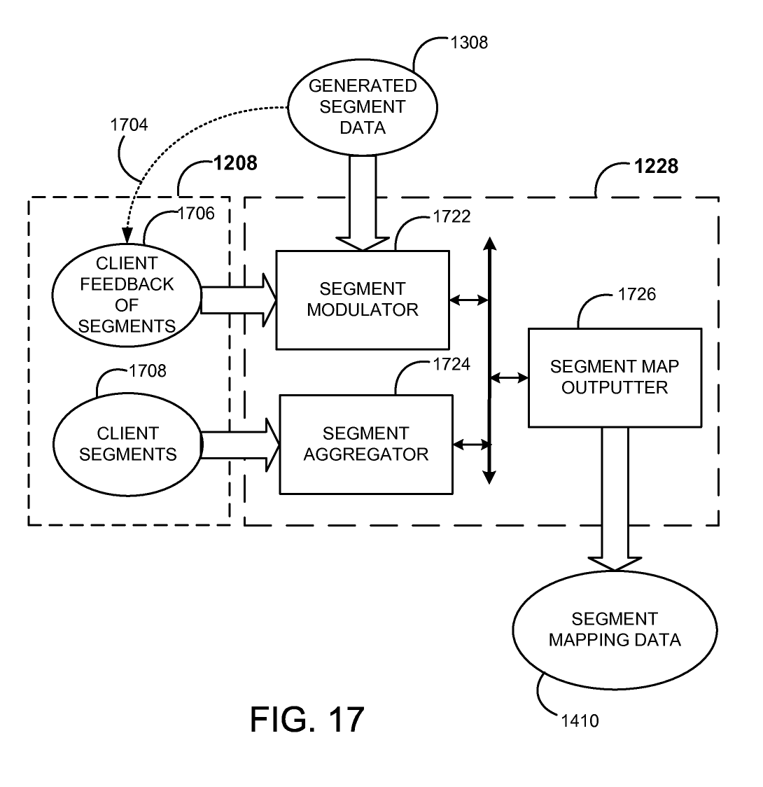

FIG. 17 is an exemplary illustration of the Segment Cartographer 1228 of the Segment Price Generator 1116 of the Price Optimizer 1870 in the Integrated Price Management System 135. The Segment Cartographer 1228 may receive Client Segment Data 1208 and Generated Segment Data 1308. The Segment Cartographer 1228 may compare the Client Segment Data 1208 and Generated Segment Data 1308 to produce a segment map. The segment map may be output as Segment Mapping Data 1410.

The Segment Cartographer 1228 may include, in some embodiments, a Segment Modulator 1722, a Segment Aggregator 1724, and a Segment Map Outputter 1726. Each component of the Segment Cartographer 1228 may be coupled by a bus, network or through computer hardware or software architecture.

Again, Client Segment Data 1208 may be seen being input into the Segment Cartographer 1228. Here, however, the Client Segment Data 1208 may be seen as including Client Feedback of Segments 1706 and Client Segments 1708. The Client 1102 may review the Generated Segment Data 1308, shown by the arrow labeled 1704, in order to generate Client Feedback of Segments 1706. The Segment Modulator 1722 may receive the Generated Segment Data 1308 and Client Feedback of Segments 1706. The Segment Modulator 1722 may alter the Generated Segment Data 1308 in order to comply with the Client Feedback of Segments 1706.

In some embodiments, the level of certainty of a segment makeup may be used to provide the user with suggestions as to if a particular segment is “strong” (believed to have a high degree of similar reaction to price changes) or “weak” (less strong similarity, or less certain of the degree of similarity). In this manner the client may be dissuaded from altering well defined, strong segments, and may be more willing to apply business knowledge and expertise to weaker segments.

The Segment Aggregator 1724 may receive the Generated Segments 1308 from the Segment Modulator 1722 along with the Client Segments 1708 from the Client 1102. The Generated Segments 1308 may be compared to the Client Segments 1708. Groupings of the generated segments may be determined which are similar to the Client Segments 1708. These groupings of segments may be referred to as aggregate segments. The segment grouping data (which segments may be combined to form the aggregate segments) may be used to generate a segment map, which is output by the Segment Map Outputter 1726 as Segment Mapping Data 1410.

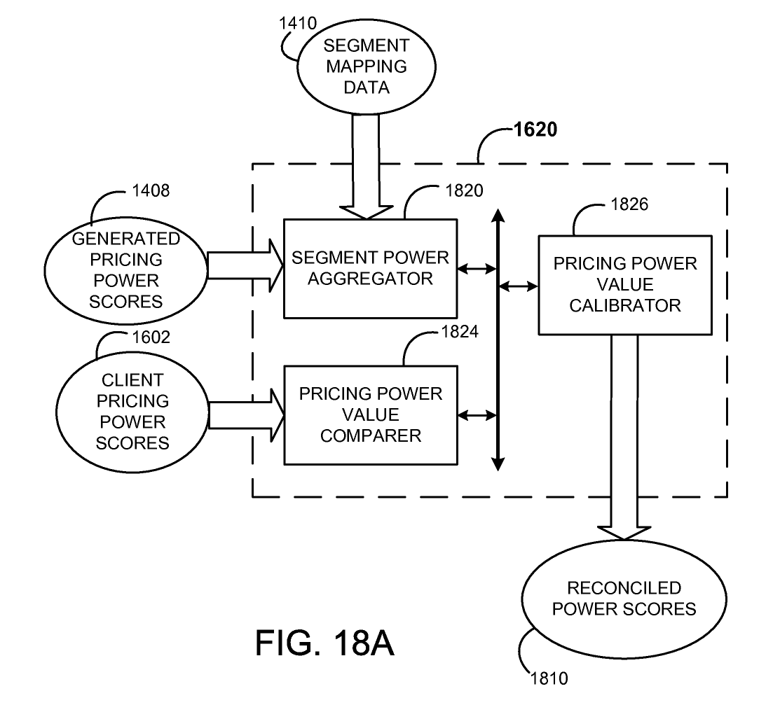

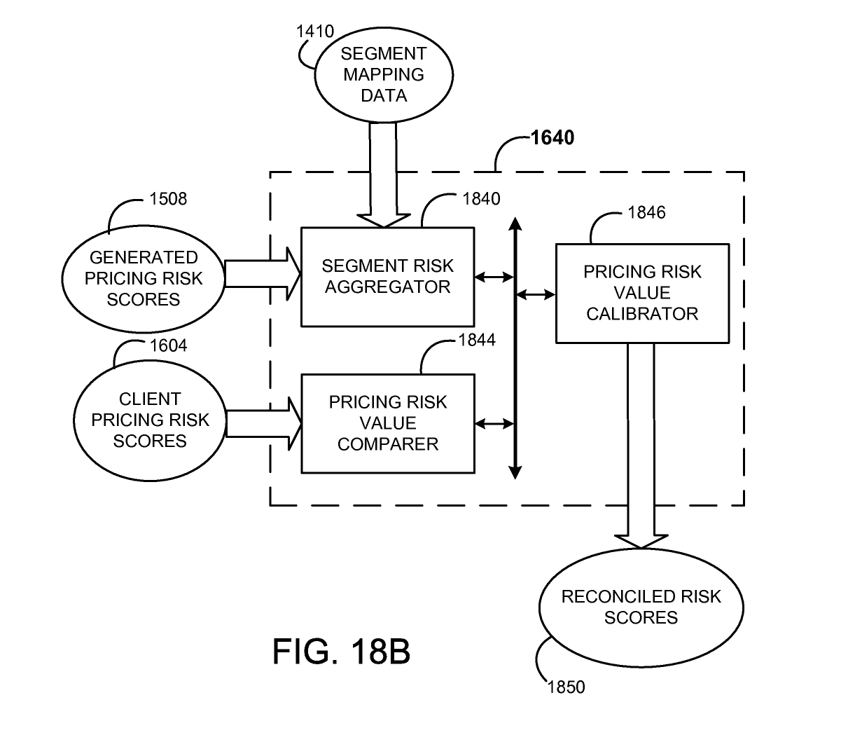

FIG. 18A is an exemplary illustration of the Segment Pricing Power Reconciler 1620 for use with the Client Reconciliation Engine 1230 of the Segment Price Generator 1116 of the Price Optimizer 1870 in the Integrated Price Management System 135. Here the Segment Pricing Power Reconciler 1620 may be seen as including a Segment Pricing Power Aggregator 1820, a Pricing Power Value Comparer 1824, and a Pricing Power Value Calibrator 1826. Each component of the Segment Pricing Power Reconciler 1620 may be coupled to one another by a central bus, network, or computer architecture. The Generated Pricing Power Scores 1408, Client Pricing Power Scores 1602 and Segment Mapping Data 1410 are inputs to the Segment Pricing Power Reconciler 1620.

The Generated Pricing Power Data 1408 includes the quantitative pricing power scores for each of the generated segments. The Segment Pricing Power Aggregator 1820 may then produce aggregate quantitative pricing power scores for the aggregate segments (those segments comparable to client segments) using the Segment Mapping Data 1410.

The aggregate quantitative pricing power scores may then be provided to the Pricing Power Value Comparer 1824. Likewise the Client Pricing Power Scores 1602 for each client segment may be provided from the Client 1102 to the Pricing Power Value Comparer 1824. The Pricing Power Value Comparer 1824 may compare the qualitative pricing power scores with the aggregate quantitative pricing power scores. Scores may then be ranked according to the size of the gap between the qualitative and quantitative scores. In some embodiments, scores that are within some threshold of one another may be deemed as similar. In these embodiments, the similar quantitative scores may be accepted as accurate scores. In some alternate embodiments, the quantitative scores are still subjected to calibration as is discussed below.

Scores with large gaps between the quantitative and qualitative score may be tagged for reconciliation. These scores may be provided to the Client 1102 for additional input, known as a “drill down”. Additionally, the qualitative power scores and quantitative power scores may be reconciled by the Pricing Power Value Calibrator 1826.

The calibrated scores and, where applicable, the accepted quantitative scores may then be output as Reconciled Pricing Power Scores 1810. This reconciled data may be consumed directly by the Client 1102 for business decision guidance, or may be utilized in a downstream application, such as for price allocation.

FIG. 18B is an exemplary illustration of the Segment Pricing Risk Reconciler 1640 for use with the Client Reconciliation Engine 1230 of the Segment Price Generator 1116 of the Price Optimizer 1870 in the Integrated Price Management System 135. Here the Segment Pricing Risk Reconciler 1640 may be seen as including a Segment Pricing Risk Aggregator 1840, a Pricing Risk Value Comparer 1844, and a Pricing Risk Value Calibrator 1846. Each component of the Segment Pricing Risk Reconciler 1640 may be coupled to one another by a central bus, network, or computer architecture. The Generated Pricing Risk Scores 1508, Client Pricing Risk Scores 1604 and Segment Mapping Data 1410 are inputs to the Segment Pricing Risk Reconciler 1640.

The Generated Pricing Risk Scores 1508 includes the quantitative pricing risk scores for each of the generated segments. The Segment Pricing Risk Aggregator 1840 may then produce aggregate quantitative pricing risk scores for the aggregate segments (those segments comparable to client segments) using the Segment Mapping Data 1410.

The aggregate quantitative pricing risk scores may then be provided to the Pricing Risk Value Comparer 1844. Likewise the Client Pricing Risk Scores 1604 for each client segment may be provided from the Client 1102 to the Pricing Risk Value Comparer 1844. The Pricing Risk Value Comparer 1844 may compare the qualitative pricing risk scores with the aggregate quantitative pricing risk scores. Scores may then be ranked according to the size of the gap between the qualitative and quantitative scores. In some embodiments, scores that are within some threshold of one another may be deemed as similar. In these embodiments, the similar quantitative scores may be accepted as accurate scores. In some alternate embodiments, the quantitative scores are still subjected to calibration as is discussed below.

Scores with large gaps between the quantitative and qualitative score may be tagged for reconciliation. These scores may be provided to the Client 1102 for additional input, known as a “drill down”. Additionally, the qualitative risk scores and quantitative risk scores may be reconciled by the Pricing Risk Value Calibrator 1846.

The calibrated scores and, where applicable, the accepted quantitative scores may then be output as Reconciled Pricing Risk Scores 1850. This reconciled data may be consumed directly by the Client 1102 for business decision guidance, or may be utilized in a downstream application, such as for price allocation.

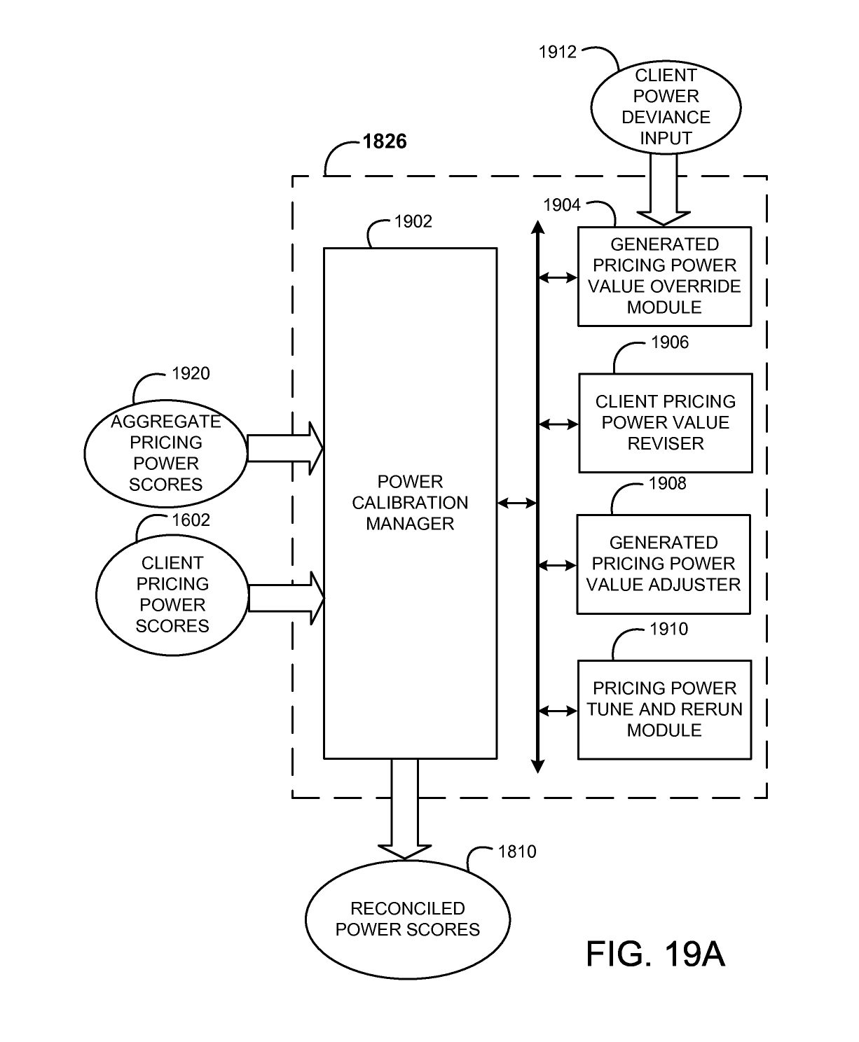

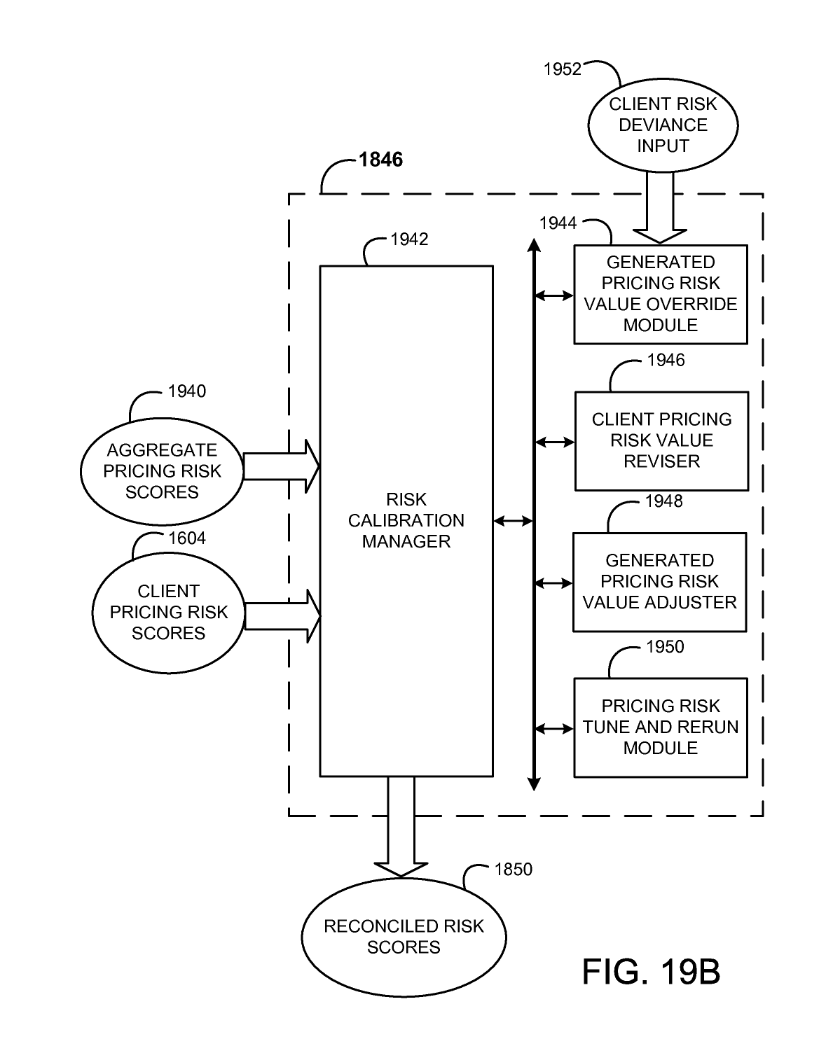

FIG. 19A is an exemplary illustration of the Pricing Power Value Calibrator 1826 of the Segment Pricing Power Reconciler 1620. The Pricing Power Value Calibrator 1826 may include a Power Calibration Manager 1902, a Generated Pricing Power Value Override Module 1904, a Client Pricing Power Value Reviser 1906, a Generated Pricing Power Value Adjuster 1908, and a Pricing Power Tune and Rerun Module 1910. The Power Calibration Manager 1902 may receive the Aggregate Pricing Power Scores 1920 and the Client Pricing Power Scores 1602. The Power Calibration Manager 1902 may also compile and output the final Reconciled Pricing Power Scores 1810.

In some cases the Client 1102 may have a reason for the large gap between the quantitative and qualitative scores. Such reasons include, but are not limited to, the qualitative score was based upon a subset of products within the client segment, factors used by the Client 1102 in generation of the qualitative score were not used in generation of the quantitative score and vice versa.

When a drill down reason for the large gap is identified, the client may provide Client Pricing Power Deviance Input 1112 which includes this information to the Generated Pricing Power Value Override Module 1904. The Generated Pricing Power Value Override Module 1904 may then modify the quantitative score to incorporate the reason. This effectively causes the qualitative and quantitative scores to become more similar. This process may also be referred to as “closing the gap” between the qualitative and quantitative scores. If scores become similar enough, in some embodiments, the quantitative score may be deemed accurate and is accepted as a reconciled score.

Additionally, in some cases the client may realize mistakes were made in the generation of the qualitative Client Power Score 1408. In this case the Client Power Scores 1408 may be revised by the Client Pricing Power Value Reviser 1906. Again, this effectively causes the qualitative and quantitative scores to become more similar. If scores become similar enough, in some embodiments, the quantitative score may be deemed accurate and is accepted as a reconciled score.

If none of the above applies, often the quantitative score may be adjusted to better conform to the qualitative score. This adjustment may be performed by the Generated Pricing Power Value Adjuster 1908, and may include comparing the qualitative and quantitative scores to generate calibration factors. The quantitative scores may then be calibrated by the factor in a linear or nonlinear fashion. Also, note that the calibration of the quantitative scores is performed for each quantitative score separately such as to maintain spread of pricing power and risk scores across the generated segments. The calibrated quantitative scores are then output as reconciled scores.

Lastly, in some embodiments, the Pricing Power Tune and Rerun Module 1910 may receive changes in factors or client scores. The Pricing Power Tune and Rerun Module 1910 may then regenerate updated power scores, and compare these updated scores to updated client scores. Thus, the process becomes iterative over small alterations of qualitative and quantitative scores until a reconciled score is reached.

FIG. 19B is an exemplary illustration of the Pricing Risk Value Calibrator 1846 of the Segment Pricing Power Reconciler 1640. The Pricing Risk Value Calibrator 1846 may include a Risk Calibration Manager 1942, a Generated Pricing Risk Value Override Module 1944, a Client Pricing Risk Value Reviser 1946, a Generated Pricing Risk Value Adjuster 1948, and a Pricing Risk Tune and Rerun Module 1950. The Risk Calibration Manager 1942 may receive the Aggregate Pricing Risk Scores 1940 and the Client Pricing Risk Scores 1604. The Risk Calibration Manager 1942 may also compile and output the final Reconciled Pricing Risk Scores 1850.

As mentioned above, in some cases the Client 1102 may have a reason for the large gap between the quantitative and qualitative scores. Such reasons include, but are not limited to, the qualitative score was based upon a subset of products within the client segment, factors used by the Client 1102 in generation of the qualitative score were not used in generation of the quantitative score and vice versa.

When a drill down reason for the large gap is identified, the client may provide Client Pricing Risk Deviance Input 1152 which includes this information to the Generated Pricing Risk Value Override Module 1944. The Generated Pricing Risk Value Override Module 1944 may then modify the quantitative score to incorporate the reason. This effectively causes the qualitative and quantitative scores to become more similar. If scores become similar enough, in some embodiments, the quantitative score may be deemed accurate and is accepted as a reconciled score.

Additionally, in some cases the client may realize mistakes were made in the generation of the qualitative Client Risk Score 1508. In this case, the Client Risk Scores 1508 may be revised by the Client Pricing Risk Value Reviser 1946. Again, this effectively causes the qualitative and quantitative scores to become more similar. If scores become similar enough, in some embodiments, the quantitative score may be deemed accurate and is accepted as a reconciled score.

If none of the above applies, often the quantitative score may be adjusted to better conform to the qualitative score. This adjustment may be performed by the Generated Pricing Risk Value Adjuster 1948, and may include comparing the qualitative and quantitative scores to generate calibration factors. The quantitative risk scores may then be calibrated by the factor in a linear or nonlinear fashion. Also, note that the calibration of the quantitative risk scores is performed for each quantitative risk score separately such as to maintain spread of pricing risk scores across the generated segments. The calibrated quantitative risk scores are then output as reconciled risk scores.

Lastly, in some embodiments, the Pricing Risk Tune and Rerun Module 1950 may receive changes in factors or client scores. The Pricing Risk Tune and Rerun Module 1950 may then regenerate updated risk scores, and compare these updated scores to updated client risk scores. Thus, the process becomes iterative over small alterations of qualitative and quantitative scores until a reconciled risk score is reached.

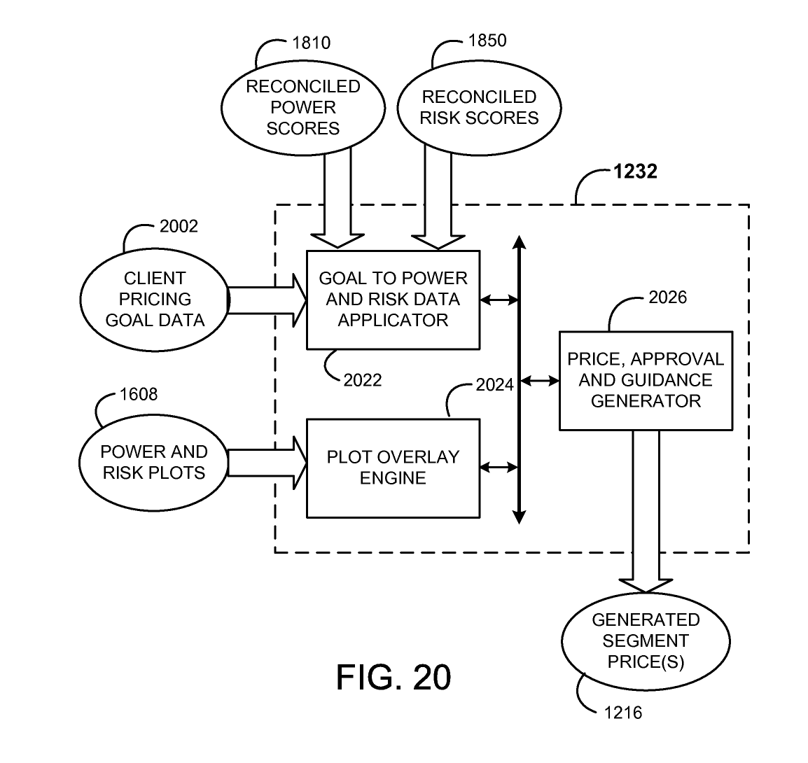

FIG. 20 is an exemplary illustration of the Segment Price Setter 2032 for use with the Segment Price Generator 1116 of the Price Optimizer 1870 in the Integrated Price Management System 135. The Segment Price Setter 2032 may be seen as including a Goal to Pricing Power and Risk Data Applicator 2022, a Plot Overlay Engine 2024 and a Price, Approval and Guidance Generator 2026. Each component of the Segment Price Setter 2032 may be coupled to one another by a bus, a network, or by computer hardware or software architecture.

The Reconciled Pricing Power Scores 1810 and Reconciled Pricing Risk Scores 1850 may be provided to the Goal to Pricing Power and Risk Data Applicator 2022 along with Client Pricing Goal Data 2002 from the Client 1102. The Client Pricing Goal Data 2002 may include information such as price change goals, pricing risk minimization goals, pricing power maximization goals, risk/power combination goals, particular prices, or any other goal which may influence price setting. The Reconciled Pricing Power Scores 1810 and Reconciled Pricing Risk Scores 1850 may then be applied to the Client Pricing Goal Data 2002 to generate suggested price changes by segment.

For example, suppose the Client 1102 were to provide goals including a global 3% price increase, while minimizing pricing risk, and while decreasing the price of certain selected widgets to $5. The Goal to Pricing Power and Risk Data Applicator 2022 may reduce widget price to $5, and apply a varied price increase to all other products in a total amount of 3%. The price increase, however, will not be applied equally to all products. Thus, products in segments with low pricing risk values may experience greater price increases than those of higher pricing risk. Thus ‘doodads’, with a low pricing risk, may receive an 8% price increase, and ‘thingamabobs’, which have a higher pricing risk, may receive a marginal 1% price increase.

The Goal to Pricing Power and Risk Data Applicator 2022 may utilize rule based engines, and multifactor equations in the generation of pricing suggestions. The Plot Overlay Engine 2024, on the other hand, uses the Pricing Power and Risk Plots 1608 to generate pricing suggestions. In some embodiments, the Goal to Pricing Power and Risk Data Applicator 2022 and the Plot Overlay Engine 2024 are the same component, but in this example, for sake of clarity, these components have been illustrated separately.

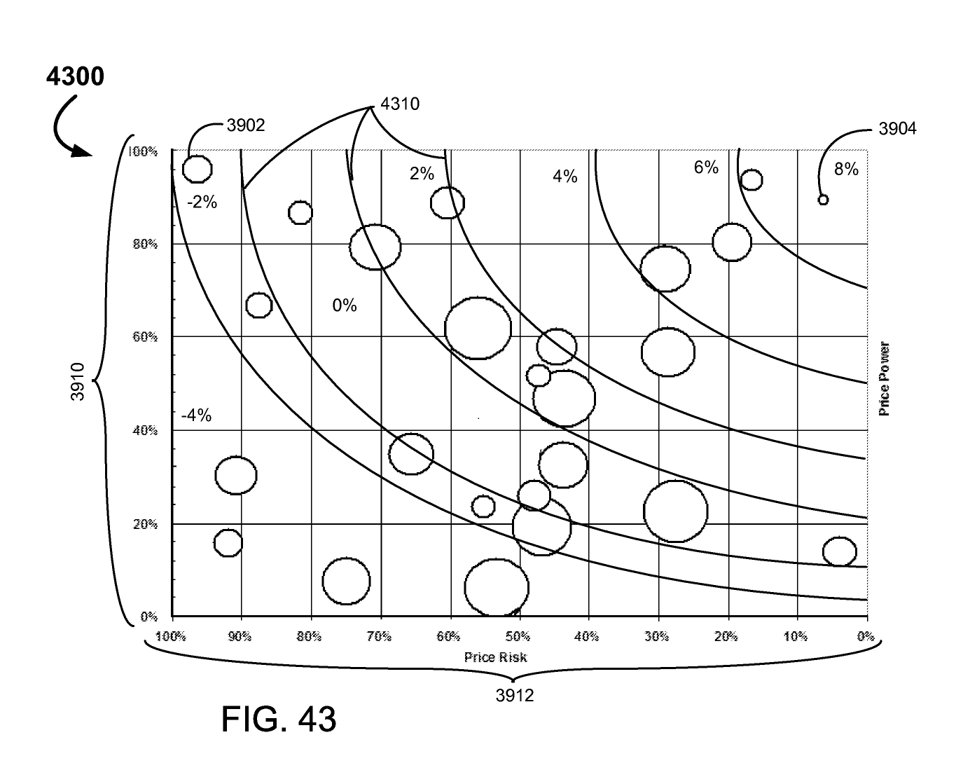

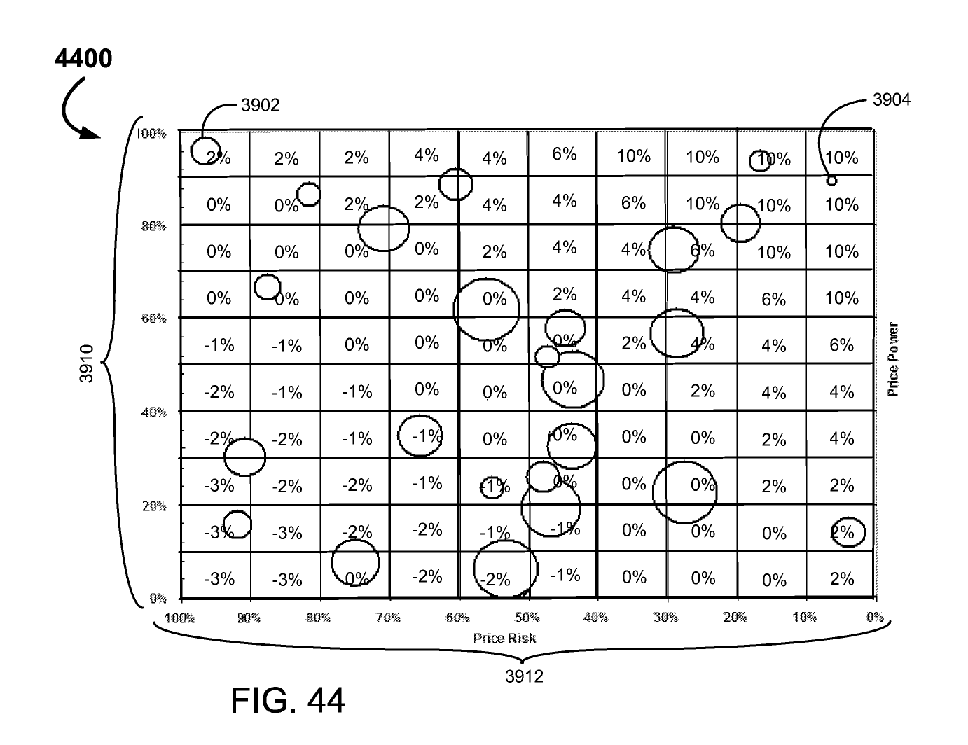

The Plot Overlay Engine 2024 may apply one or more overlays to the Pricing Power and Risk Plots 1608. The overlays may include any of a price change matrix, or tradeoff price change contours. Examples of these are provided below in FIGS. 43 and 44 and accompanying text. The matrix operations or contour location, shape and value may depend upon the goals provided by the Client 1102.

Pricing suggestions created by the Goal to Pricing Power and Risk Data Applicator 2022 and Plot Overlay Engine 2024 may be compiled to generate a set of prices for each product of the segment. This Generated Segment Price(s) 1216 may then be output for direct Client 1102 consumption, or for downstream operations such as deal evaluation.

The Approval and Guidance Generator 2026 may apply reconciled risk and power scores by segment, along with suggested price changes to generate Segment Prices 1216. Segment Prices 1216 is intended to include approval level prices, target prices, floor prices and pricing guidance.

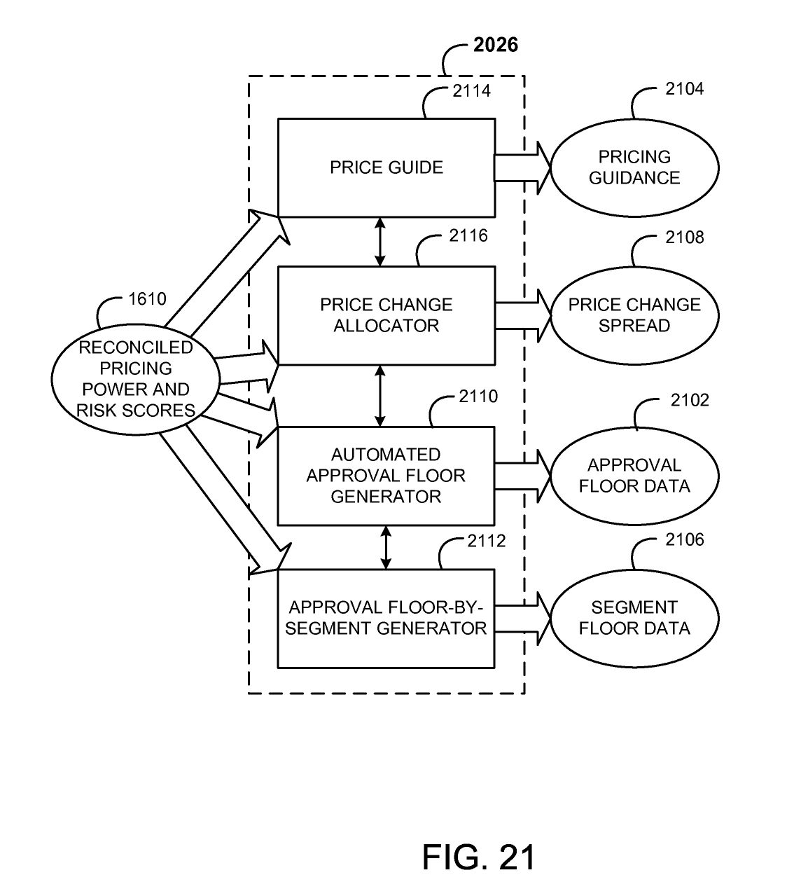

FIG. 21 is an exemplary illustration of the Approval and Guidance Generator 2026. The Approval and Guidance Generator 2026 may include a Price Guide 2114, a Price Change Allocator 2116, an Automated Approval Floor Generator 2110 and an Approval Floor-by-Segment Generator 2112 coupled to one another. Each component of the Approval and Guidance Generator 2026 may receive the Reconciled Pricing Power and Risk Scores 1610.

The Price Guide 2114 may generate general Pricing Guidance 2104 for deal negotiations. This may include raw Pricing Power and Risk indices, up sell suggestions, volume suggestions and behavioral cues for the sales force. Additionally, pricing guidance may include approval levels and target prices.

The Price Change Allocator 2116 may receive input from the Goal to Pricing Power and Risk Data Applicator 2022 and Plot Overlay Engine 2024 in order to generate a Price Change Spread 2108.

The Automated Approval Floor Generator 2110 may set approval floors by any of a myriad of ways, including percentage of cost, percentage of prior transactions, and percentage of competitor pricing. Of course additional known, and future known, methods of generating approval floors are considered within the scope of the invention. Likewise, the Automated Approval Floor Generator 2110 may generate target pricing in similar ways. The Approval Floor Data 2102 may then be output for quote analysis, or sales force guidance.

The Approval Floor-by-Segment Generator 2112 may be, in some embodiments, the same component as the Automated Approval Floor Generator 2110. In the present illustration, however, these components are illustrated separately for clarity. The Approval Floor-by-Segment Generator 2112 may receive Reconciled Pricing Power and Risk Data 1610 in order to generate target and approval values by segment. In addition to the methods described above, the Approval Floor-by-Segment Generator 2112 may include modulation of target and approval levels depending upon pricing power and risk of the given segment a product belongs. For example, high pricing power values for a given segment may cause target and approval levels to increase. High pricing risk, on the other hand, may reduce the approval floor.

The Approval Floor-by-Segment Generator 2112 may generate approval and target data that is impacted by segment. The Segment Floor Data 1306 may then be output for quote analysis, or sales force guidance.

### D. Deal Evaluator

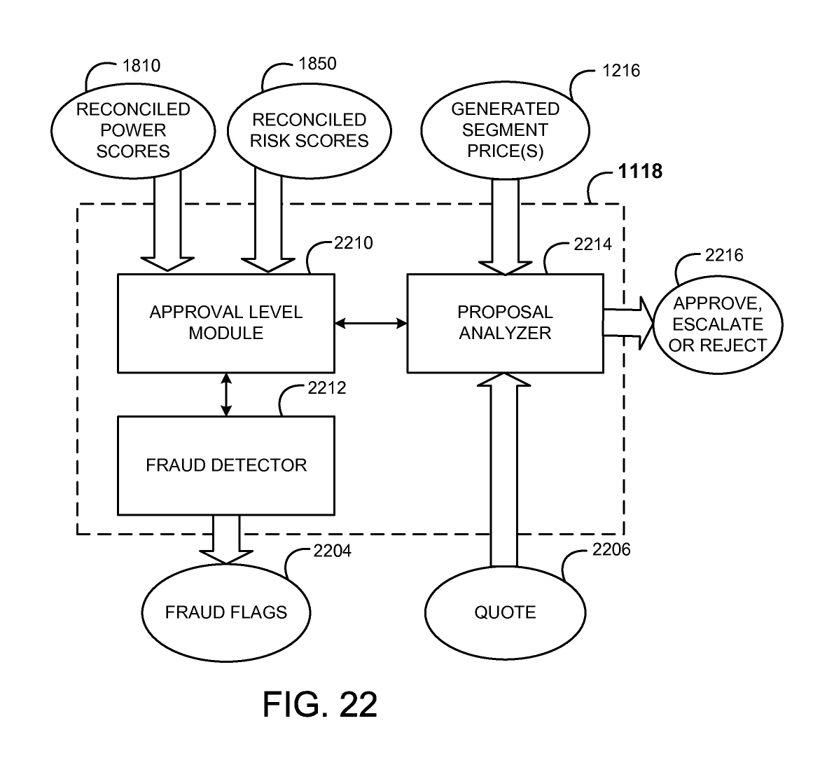

FIG. 22 is an exemplary illustration of the Deal Evaluator 1118 of the Integrated Price Management System 135. The Deal Evaluator 1118 may include an Approval Level Module 2210, a Fraud Detector 2212 and a Proposal Analyzer 2214. The Approval Level Module 2210 may couple to the Fraud Detector 2212 and the Proposal Analyzer 2214. The Approval Level Module 2210 may receive the Reconciled Pricing Power Scores 1810 and Reconciled Pricing Risk Scores 1850. The Approval Level Module 2210 may receive approval levels for each of the segments from the Segment Prices 1216. Approval levels include approval floors, a plurality of approval levels and target pricing. Deals are classified as wins or losses based upon a comparison between deal transactions (quotes and/or contracts) and order transactions. The matching logic compares things like deal effective date (from and to date), specific product or product group, customer account, ship-to or billed-to.

Transaction data, along with the approval level data may be provided to the Fraud Detector 2212 for detection of fraud. Thus, individuals within the Client 1102 who statistically generate deals below the approval floors may receive a Fraud Flag 2204. These individuals, or groups, within the Client 1102 may then be subject to more scrutiny or oversight by the management of the Client 1102.

Approval floors, target pricing and Generated Segment Price(s) 1216 may be provided to the Proposal Analyzer 2214 for analysis of the Quote (or proposal) 1406. The Proposal Analyzer 2214 may then output one of an Approval, Escalation or Rejection 2216 of the deal terms, based upon a comparison of the Quote 1406 and Generated Segment Price(s) 1216.

### VI. Method for Generating Pricing Power and Risk Scores

### A. Integrated Pricing Management

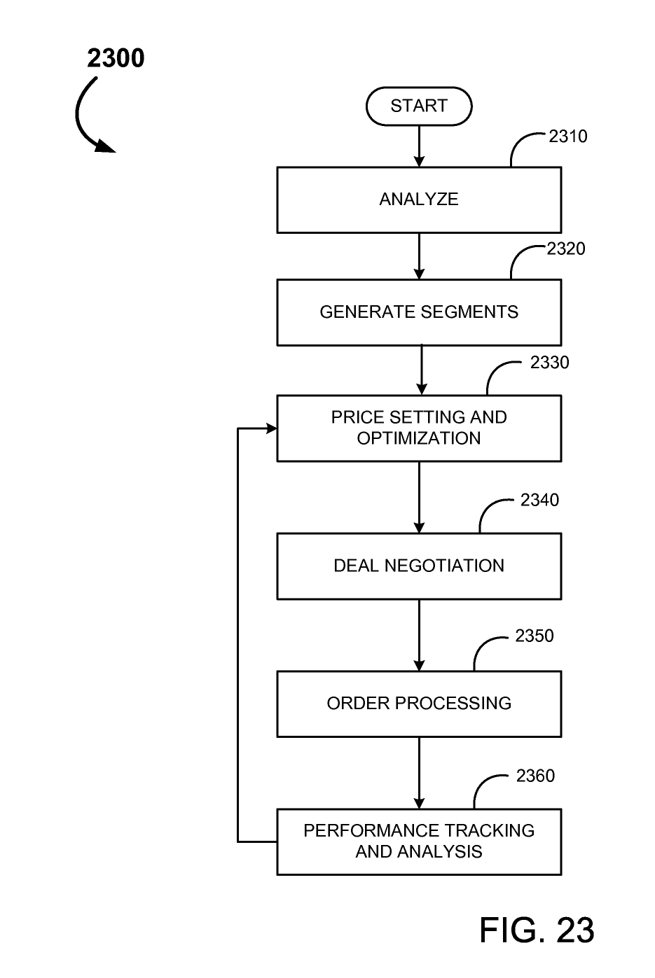

FIG. 23 is a flow chart illustrating an exemplary method for providing price and deal guidance for a business to business client in accordance with an embodiment of the present invention, shown generally at 2300. The process begins and then progresses to step 2310 where the client is analyzed. This analysis includes understanding business context, analyzing prior pricing results and developing segment hypotheses. From these hypotheses, rich data sets may be generated in order to test and refine the hypotheses.

Analysis, or assessment, may be performed by the Price and Margin Analyzer 1060. Particularly, clients may self report and perform much of the analysis in-house. In some embodiments, data crawlers may mine corporate and transaction databases to facilitate analysis. Lastly, external consultants may undergo investigation into the client to perform analysis.

The process then progresses to step 2320 where segmentation occurs. Segmentation has already been discussed in some detail above. The effectiveness of both the demand modeling and price optimization for the selected segment is dependent upon proper segmentation. Segmentation is defined so as to identify clusters of transactions which have similar characteristics and should produce similar outcomes during the negotiation process by analyzing products, customers and transaction attributes. Segmentation may be performed at the transaction level using quantitative analysis. Segment robustness may also be continually monitored and validated.

The process then progresses to step 2330 where prices are set and optimized. Any price setting and optimization is considered; however, the present invention centers on the usage of pricing power and risk values to generate pricing and business guidance.

The process then progresses to step 2340 where deal negotiation is performed. Deal negotiation may be performed by a sales force or, in some embodiments, be an automated process. As has been previously discussed, deal negotiation is more common in the business to business environment, where slim margins account for the bulk of sales. The prices set at step 2330, as well as optimizations, guidance and quotes may be utilized at the deal negotiation step to improve the profits of any particular deal.

At step 2350 orders are processed in response to the negotiated deals. Order processing enables the finalized deals to be examined for changes in profit, margin and volume. These shifts in customer behavior may be referenced to the provided pricing and guidance. Then, at step 2360, this performance tracking may be analyzed for successful activities. Demand models (where utilized) may be updated. Likewise, segments may be updated as to fit the available data. Pricing power and risk values for each segment may be modified by changing the pricing power and pricing risk factors, as well as factor weight. Of course, additional performance analysis and updates may be performed at step 2360.

These updates may then be applied to the next iteration of price setting and optimizations at step 2330. The process may be concluded at any point when desired. Typically conclusion will occur when deals with a particular customer concludes.

### B. Price Setting

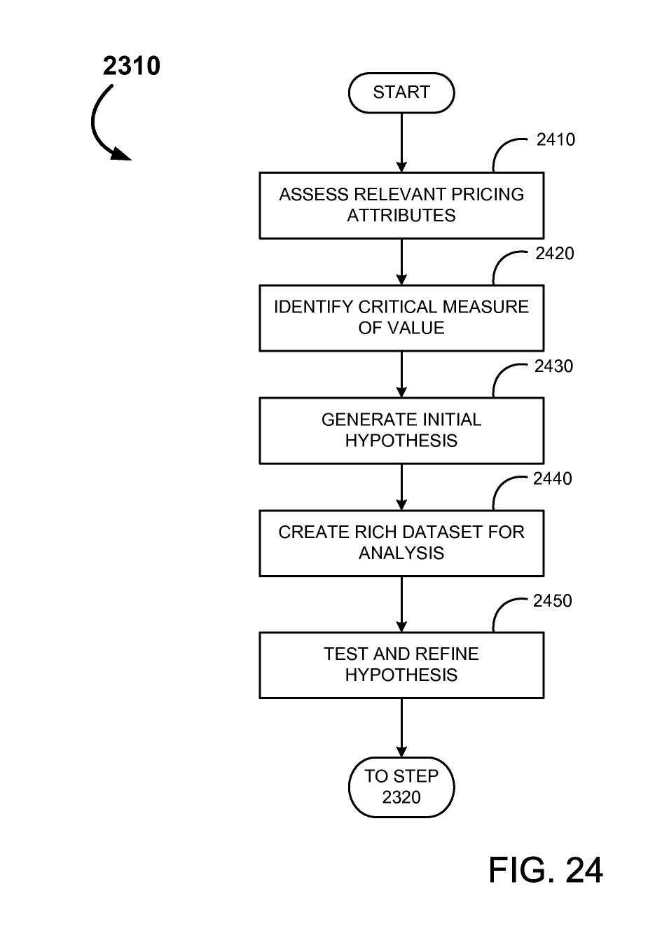

FIG. 24 is a flow chart illustrating an exemplary method for analyzing a business to business client of FIG. 23, shown generally at 2310. The process begins and progresses to step 2410 where relevant pricing attributes are assessed. Assessment of pricing attributes includes the identification of these attributes and developing an understanding of the degree of impact that they may have upon the client business.

The process then progresses to step 2420 where critical measures of value are identified. One or more metrics (ex. margin %, invoice price yield, etc.) can be used to perform the statistical analysis of the business transactions and to identify the critical drivers of value for the client business.

Then, at step 2430, an initial set of hypotheses for segmentation is generated. A rich dataset may then be constructed for the purpose of testing the initial hypotheses, at step 2440.

The process then progresses to step 2450 where the segment hypotheses are tested and refined. In some embodiments, these refined hypotheses may be utilized to create the initial segmentation for the given client. In some alternate embodiments, these hypotheses merely influence segmentation. The process then concludes by progressing to step 2320 of FIG. 23.

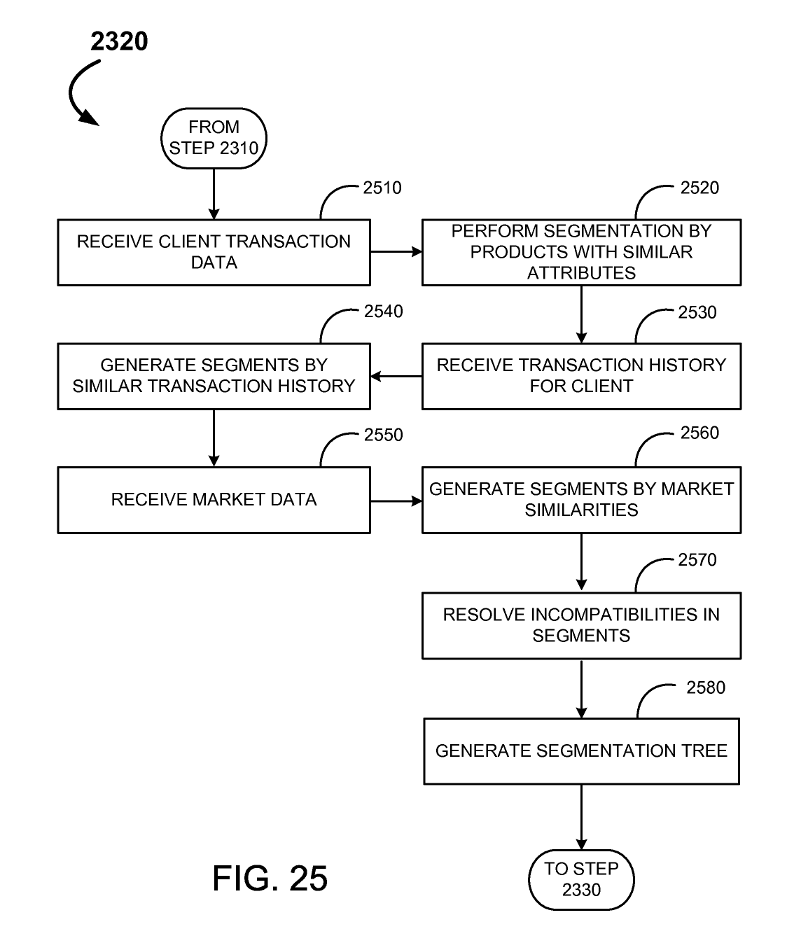

FIG. 25 is a flow chart illustrating an exemplary method for segmenting products, shown generally at 2320. Note that this method of segment generation is intended to be exemplary in nature, as there are other segmentation processes which may be utilized to enable the present invention.

The process begins from step 2310 of FIG. 23. The process then progresses to step 2510 where transaction data is received. Transaction data may be received from the Data Warehouse 132. Transaction data, as used in this specification, includes information regarding customers, sales channels, product attributes and other relevant segmentation data. As previously discussed, segmentation analysis is performed at the ‘transaction level’, where a single transaction's details are analyzed to find similarities across product, customer and transaction attributes. The intent is to create a common base of comparison across seemingly unrelated records and extract insights on what is really driving better price and margin realization.

The process then progresses to step 2520 where similarities in the product dimensions are analyzed. Then, transaction history from the client may be received at step 2530. The transaction history may be utilized, in some embodiments, to identify attributes relevant to the segmentation, at step 2540.

Market data may likewise be received at step 2550. Similarities in a client's markets attributes may also be used to determine relevant segment dimensions, at step 2560.

Each of these exemplary segmentation techniques may be performed alone or in any combination. In addition, while the segmentation has been illustrated as a serial process, any of these segmentation techniques may be performed in any order or even in parallel.

In some cases, there may be inconsistencies between segments generated by one or more of these methods. Such incompatibilities may be resolved at step 2570. Segment incompatibility resolution may involve the degree of similarity within the given segments, segmentation rules, user feedback or other method.

Although not shown, in some embodiments, the client's segment requirements may be received. These requirements may include initial directives. An example of client segment requirements is that all MP3 accessories be grouped together as a single segment.

The client segment requirements may be applied to the segments. Typically client segment demands take priority over generated segments. Yet, in some embodiments, client requirements could be ignored.

After the segments are generated, they may be provided to the client for feedback (not shown). Typically client feedback of segmentation is followed, however, in some embodiments, the strength of any given segment may be provided to the client prior to client segment feedback, thus dissuading clients from adjusting segments that have been validated as accurate.

While several segmentation techniques and algorithms can be used to perform a quantitative segmentation on the client dataset (ex. cluster analysis, CART tree, multivariate regression, latent class analysis, etc.), the end result is typically a portfolio of segments that can be used for downstream use. An example of a possible output at step 2580 is a segment tree (not illustrated). The process then concludes by progressing to step 2330 of FIG. 23.

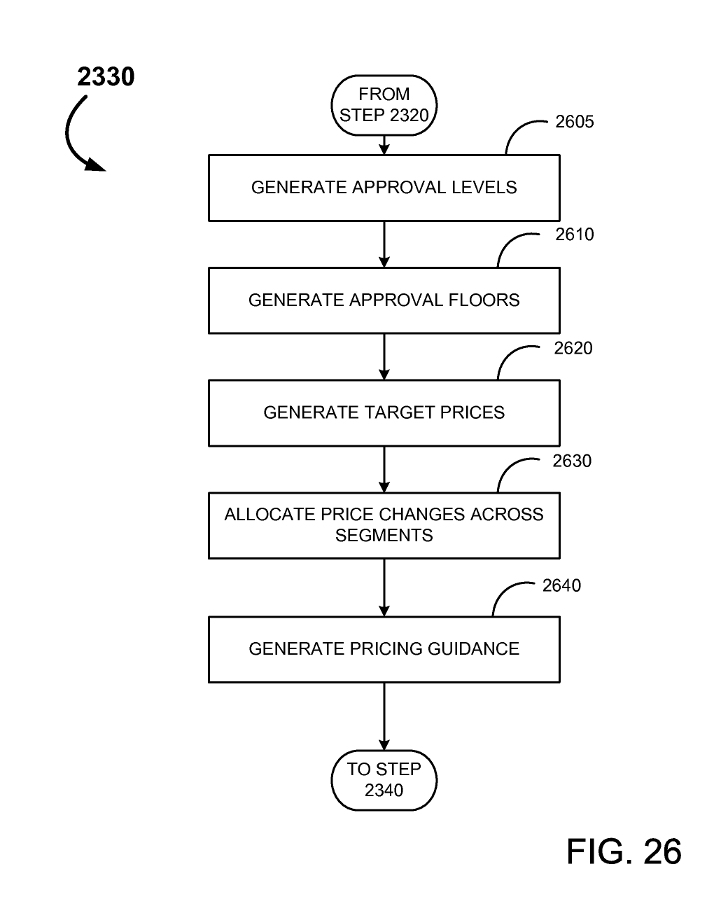

FIG. 26 is a flow chart illustrating an exemplary method for optimizing prices, shown generally at 2330. The process begins from step 2320 of FIG. 23. The process then progresses to step 1805 where approval levels are generated for given segments. Then the process progresses to step 2610 where approval floors are generated for the given segments. Approval levels and floors may additionally be assigned to each product, channel and customer specifically. The approval levels and floors are determined by considering the specific Pricing Power and Risk of the segment/deal/line item considered for the optimization. Sometime approval levels incorporate specific client requests and constraints (ex. all the deals submitted for the top 3 customers have to be reviewed by the SVP of Sales). The degree of approval floor and level granularity may, in some embodiments, be configured to achieve the needs of the particular client.

The process then progresses to step 2620 where target prices may be generated. Setting target prices includes setting and communicating specific goals to the sales team. Target prices may include a sales team incentive structure. The goal of target pricing is to drive an overall increase in price realization. Target prices may or may not have a trial period. In situations where a trial period is implemented, target prices are adjusted according to the effect target prices have on overall profits.

Next, at step 2630, price change goals may be allocated across segment in an intelligent manner to drive increased profit realization. Also, at step 2640 pricing guidance for the sales team may be generated. The process then concludes by progressing to step 2340 of FIG. 23.

In each of steps 2605, 2610, 2620, 2630 and 2640 segmentation, pricing power and risk concepts may be utilized to enhance the process. Particularly, price change allocation may rely heavily upon segment Pricing Power and Risk analysis, as will be seen below.

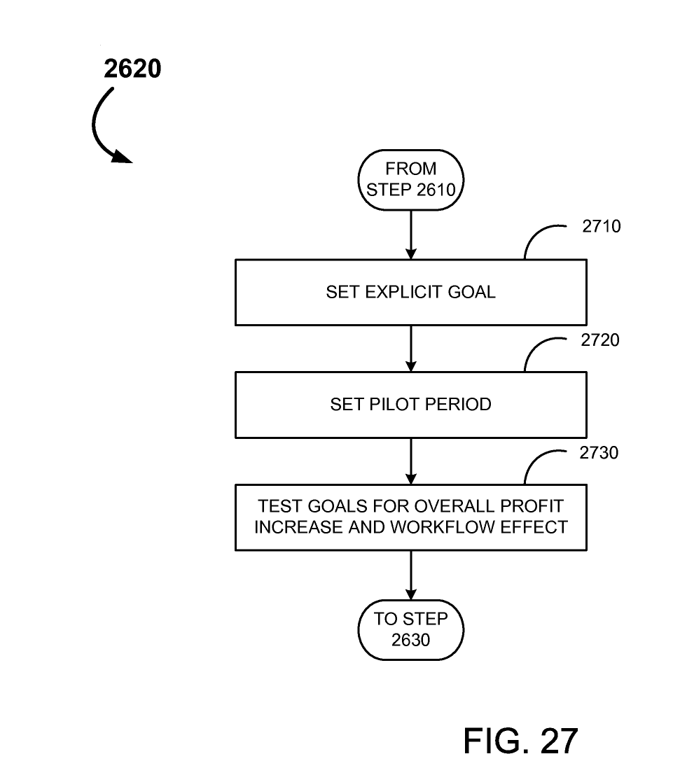

FIG. 27 is a flow chart illustrating an exemplary method for generating target prices, shown generally at 2620. Note that this exemplary embodiment of target price setting does not utilize pricing power and risk scores. Other methods for setting target prices may incorporate pricing power and risk factors in their determination.

The process begins from step 2610 of FIG. 26. The process then progresses to step 2710 where explicit target goals are set. These goals may sometimes be communicated to the sales force. These goals may be generated by managers, or sales executive, or may be generated by the price change allocation. Also, traditional price optimization techniques may be used in some situations to generate target goals.

At step 2720 a trial period may be set for the implementation of the prior mentioned goals. Typically, the time period set may be long enough as to generate meaningful data as to the effectiveness of the target prices, but in the event of harmful target prices, not long enough to damage profit level in a significant manner.

The process then progresses to step 2730 where the goals are tested using the collected transaction and deal data for profit changes. The results may then be used to revise the targets until an optimal target price is achieved. The process then concludes by progressing to step 2630 of FIG. 26.

### C. Price Setting and Guidance Optimization Using Pricing Power and Risk

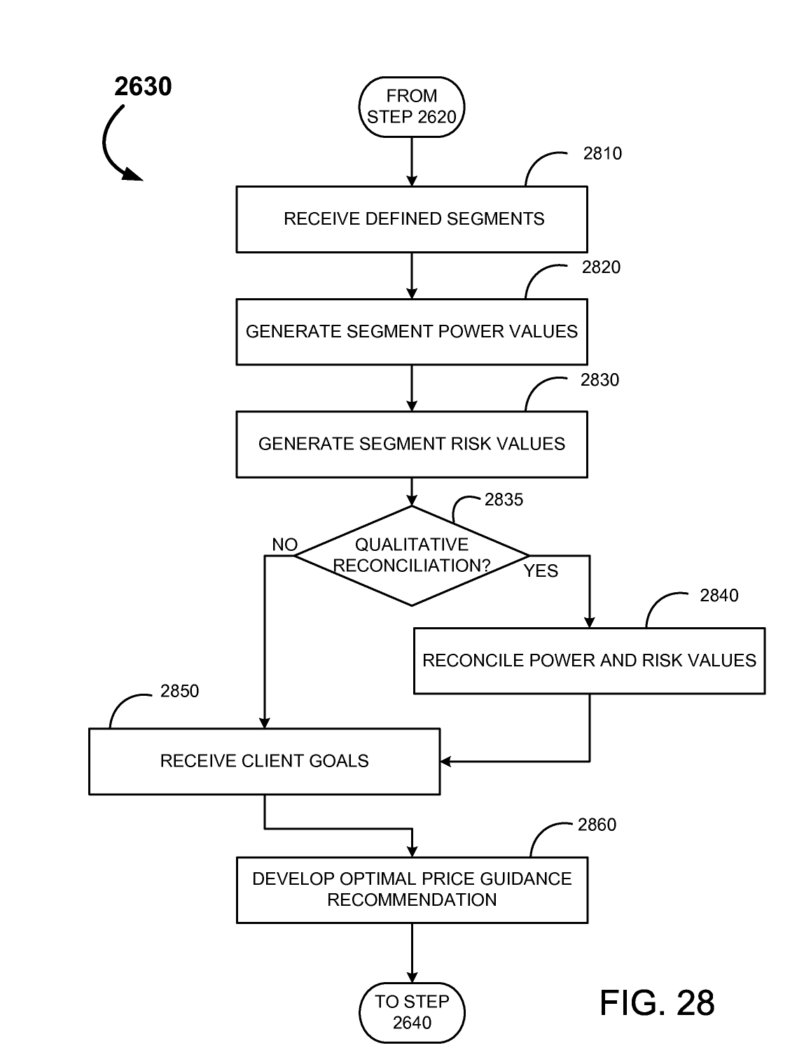

FIG. 28 is a flow chart illustrating an exemplary method for allocating price changes across the segments, shown generally at 2630. The process begins from step 2620 of FIG. 26. The process then progresses to step 2810 where the defined segments are received. As previously mentioned, segments were defined at step 2570 of FIG. 25.

Then, at step 2820 initial quantitative pricing power values are generated for each of the given segments. Likewise, at step 2830 initial quantitative pricing risk values are generated for each of the given segments.

The process then progresses to step 2835 where an inquiry is made whether to perform a qualitative reconciliation on the initial quantitative pricing power and pricing risk values. If reconciliation is desired at step 2835, the process then progresses to step 2840 where qualitative and quantitative pricing power and risk scores are reconciled. This may also be referred to as calibration of the quantitative scores. Reconciliation of pricing power and risk scores will be discussed in more detail below.

After reconciliation of qualitative and quantitative scores, the process then progresses to step 2850 where client goals are received.

Else, if at step 2835 a qualitative score reconciliation is not desired, the process also progresses to step 2850 where the client goals, strategies and policies are received. As previously discussed, client goals, strategies and policies may include specific prices, price changes for one or more product or category, segment wide goals, pricing risk minimization, pricing power maximization, pricing power and pricing risk combination goals, global price changes, margin goals and volume goals.

After client goals are received, the process then progresses to step 2860 where the pricing power and risk values are compared to the goals in order to develop optimal price guidance recommendations. This comparison may include pricing power and risk plot manipulation, mathematical manipulation of prices using pricing power and risk variables, or other desired technique. The process then concludes by progressing to step 2640 of FIG. 26.

FIG. 21 is a flow chart illustrating an exemplary method for generating segment pricing power values, shown generally at 2820. The process begins from step 2810 of FIG. 28. The process then progresses to step 2910 where pricing power factors are identified. Pricing power factors may include any number of factors, including, but not limited to, price sensitivity, price variances, approval escalations, win ratios, and elasticity to name a few. Pricing power factors may be identified by statistical means or may be generated by individuals with extensive business knowledge.

Initial values may then be assigned to each of the pricing power factors at step 2920. Some initial values may be readily quantified, such as win ratios. Other pricing power factor values may not be readily determined, and a generic value may be utilized instead. Alternatively, a value may be generated from related factors or by an experienced individual with extensive business knowledge.

The process then progresses to step 2930 where weights are generated for each pricing power factor. In some embodiments, the weightings are assigned according to a default configuration or industry experience. Other times, initial weights may be equal for all factors.

The weight for the pricing power factors may be used to take a weighted average of the pricing power factors for each segment at step 2940, thereby generating power scores for each segment. This weighted average of pricing power factors for the segment is the initial quantitative pricing power value for that segment. The process then concludes by progressing to step 2830 of FIG. 28.

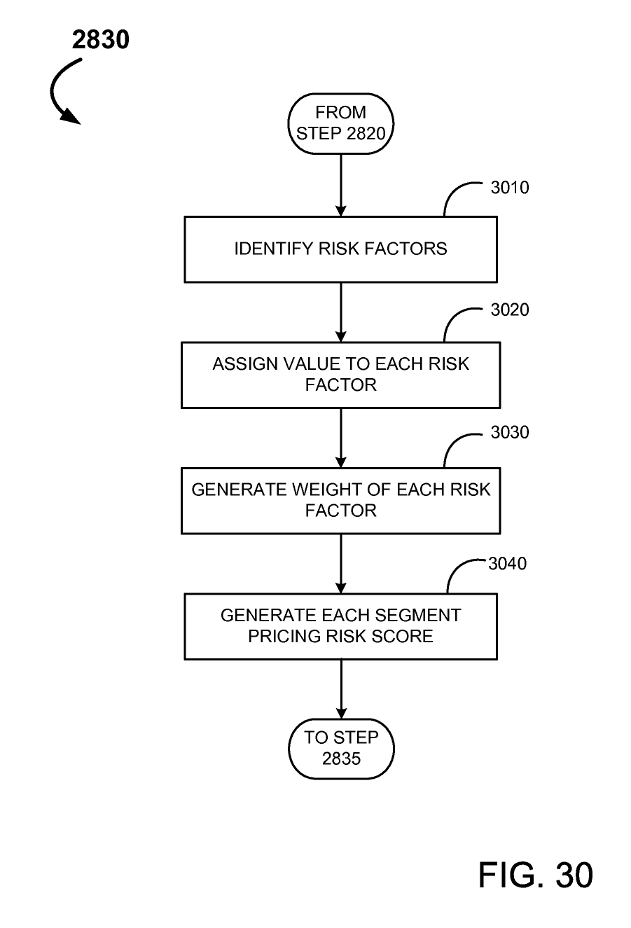

FIG. 30 is a flow chart illustrating an exemplary method for generating segment pricing risk values, shown generally at 2830. Pricing Risk value generation is, in many ways, very similar to the generation of a pricing power value. The primary difference between generation of the pricing power and risk score is the factors considered.

The process begins from step 2820 of FIG. 28. The process then progresses to step 3010 where pricing risk factors are identified. Pricing Risk factors may include any number of factors, including, but not limited to, total sales, sales trends, margin and percent of total spend, to name a few. Pricing Risk factors may be identified by statistical means or may be generated by individuals with extensive business knowledge.

Initial values may then be assigned to each of the pricing risk factors at step 3020. Some initial values may be readily quantified, such as total sales. Other pricing risk factor values may not be readily determined, and a generic value may be utilized instead. Alternatively, a value may be generated from related factors or by an experienced individual with extensive business knowledge.

The process then progresses to step 3030 where weights are generated for each pricing risk factor. In some embodiments, the weightings are assigned according to a default configuration or business experience. Other times, initial weights may be equal for all factors.

The weight for the pricing risk factors may be used to take a weighted average of the pricing risk factors for each segment at step 3040, thereby generating risk scores for each segment. This weighted average of pricing risk factors for the segment is the initial quantitative pricing risk value for that segment. The process then concludes by progressing to step 2835 of FIG. 28.

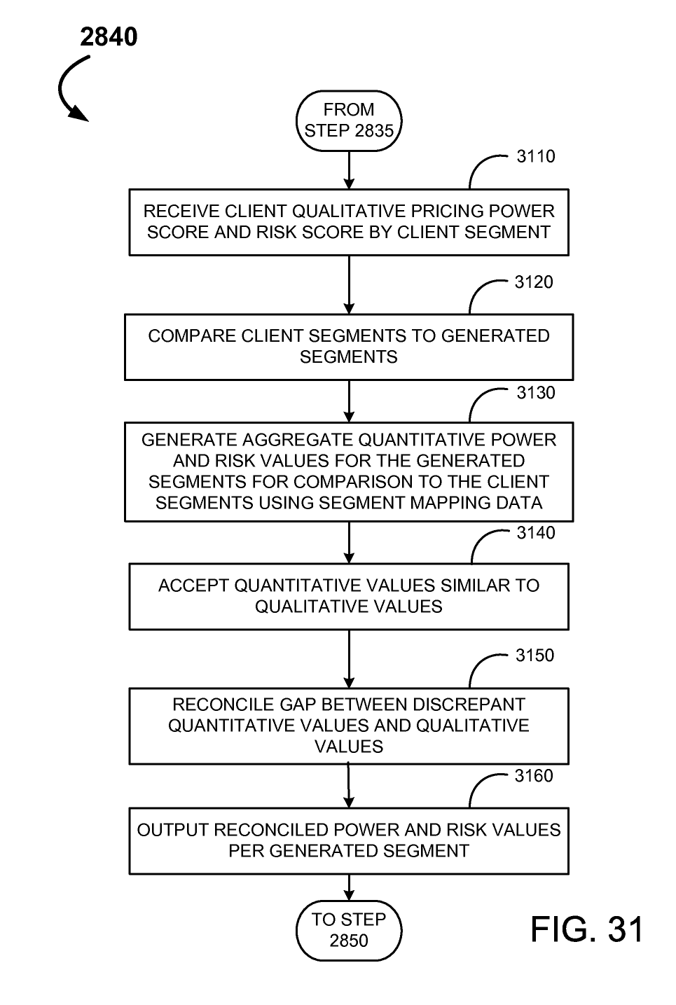

FIG. 31 is a flow chart illustrating an exemplary method for reconciling pricing power and risk values, shown generally at 2840. The process begins from step 2835 of FIG. 28. The process then progresses to step 3110 where client qualitative pricing power and risk scores by client segment are received.

As previously mentioned, the clients typically have fewer “segments” in mind when viewing the business. This is due to the fact that humans are less capable for generating the fine level of segment granularity that the present invention is adept at performing. Moreover, for humans, larger, more distinct and identifiable segments are more easily analyzed. Thus, while the present invention may generate many hundreds, if not thousands, of segments, a human may divide the business up into a mere handful of segments. In order to keep these segments separate, the fewer human derived segments will be referred to as ‘client segments’, whereas the segments created by the present invention may be referred to as ‘generated segments’.

Thus, the clients may provide pricing power and risk scores for each client segment. These client segment pricing power and risk scores may be referred to as qualitative scores. The qualitative pricing power and risk scores may be generated from the extensive business knowledge of the client.

The process then progresses to step 3120 where the generated segments are compared to the client segments. As there are many fewer client segments than generated segments, it may be found that many generated segments must be combined in order to include the same dimensions as a client segment. The grouping required to generate these ‘aggregate segments’ may be stored for the aggregation of quantitative pricing power and risk scores as detailed below.

At step 3130, the aggregate quantitative pricing power and risk scores are generated which correspond to the aggregate segments. The purpose of generating the aggregate quantitative scores is to have a comparable for the qualitative scores.

The aggregate quantitative pricing power score for each aggregate segment is generated by taking weighted averages of all the quantitative pricing power scores for each generated segment composing the aggregate segment. Likewise, the aggregate quantitative pricing risk score for each aggregate segment is generated by taking weighted averages of all the quantitative pricing risk scores for each generated segment composing the aggregate segment. The aggregates may be determined by using the segment mapping data.

The purpose of weighting the scores when performing the averages is that some generated segments tend to be of different sizes than other generated segments. Thus, the weighting may reflect these different sized segments. Weighting may be by segment profit, revenue, volume or other index of segment size.

The process then progresses to step 3140 where the aggregated quantitative scores for the aggregate segment are compared to the qualitative scores for the corresponding client segment. Scores which are similar may be accepted as accurate. Similarity of pricing power scores may be determined by comparing the difference between pricing power scores to a pricing power difference threshold. Likewise, similarity of pricing risk scores may be determined by comparing the difference between pricing risk scores to a pricing risk difference threshold. Scores with large gaps between the qualitative and quantitative scores may undergo further analysis.

At step 3150 the gap between qualitative scores and quantitative score may be reconciled. This reconciliation may involve modifying scores and ultimately calibrating the quantitative scores to the qualitative scores, in some embodiments.

The process then progresses to step 3160 where the reconciled pricing power and risk values for each generated segment are outputted. Reconciled pricing power and risk scores may include accepted quantitative scores, as well as calibrated quantitative scores. The process then concludes by progressing to step 2850 of FIG. 28.

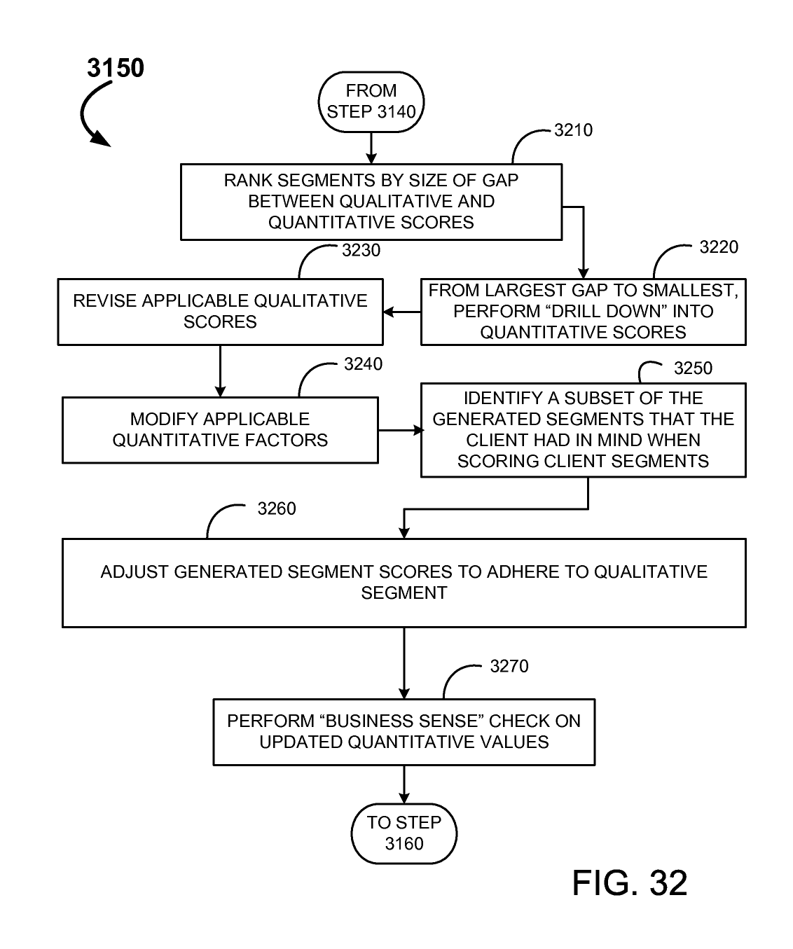

FIG. 32 is a flow chart illustrating an exemplary method for reconciling gap between discrepant quantitative values and qualitative values, shown generally at 3150. The process begins from step 3140 of FIG. 31. The process then progresses to step 3210 where segments are ranked by the size of the gap between the quantitative scores and the qualitative scores.

In some embodiments, a “drill down” may be performed on each segment from the segment with the largest gap to that of the smallest gap, at step 3220. Of course drill down may occur in any order in some other embodiment. Likewise, in some alternate embodiments, drill down may occur for each segment in parallel.

A drill down includes an analysis of the driving factors behind the qualitative score and contrasting them to the factors driving the quantitative score. Often client input is desirous at this step. The purpose is to isolate and identify the cause(s) of the large gap between the qualitative score and the quantitative score. Often a factor was included, or overly relied upon, in the generation of one of the quantitative score or the qualitative score that was not adequately represented in the other score. Also, often the qualitative score was based upon some subset of the client segment, such as items that are most visible or the highest selling items.

A determination is made if a factor mistake was made and the mistake is corrected for. This may include adding or removing factors to one or both of the scores. Thus, applicable qualitative scores may be revised at step 3230, and applicable quantitative scores may be revised at step 3240.

Also, as noted above, segment inclusion may be checked at step 3250. The segment used in generating the qualitative score may be compared with the aggregate segment. A subset of the generated segments which the client had in mind when scoring the qualitative segment may then be identified. Ideally, the subset of generated segments includes all of the segments that were aggregated; however, often, due to human limitations, the qualitative segment may only account for a small portion of the segment, such as large ticket or highly visible items. The quantitative score may thus be adjusted such as to adhere to the qualitative scores at step 3260. This adjustment may be referred to as calibration of the quantitative scores. In some embodiments, the calibration of quantitative scores may be performed by reweighting the individual factors used to generate the quantitative scores. In some alternate embodiments, the calibration may be performed by a simple shift of all scores. Score shifts may include linear shifts, or nonlinear shifting.

At step 3270 a ‘business sense’ check may be performed on the updated quantitative values. Such a business sense check may actually involve an individual with extensive business knowledge reviewing the updates, or may include a check by a computer application which identifies and correct negative weights or similar aberrations. The process then concludes by progressing to step 3160 of FIG. 31.

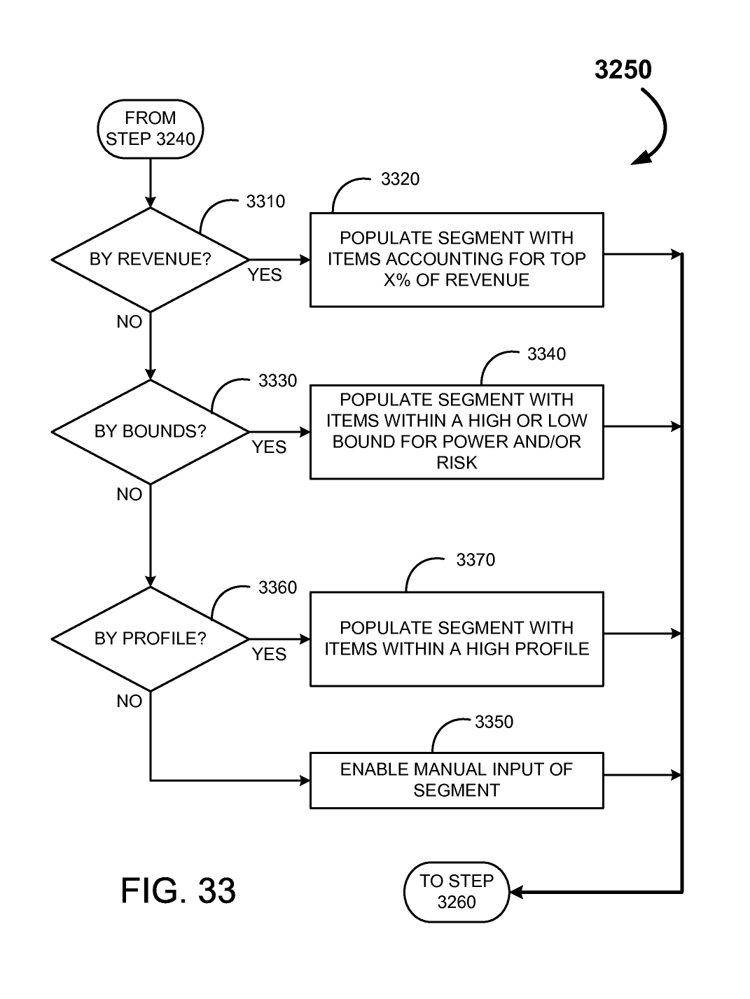

FIG. 33 is a flow chart illustrating an exemplary method for modifying quantitative segments to reflect client segments, shown generally at 3250. Note that this method for modifying segments to match the subset utilized to determine the qualitative segment is exemplary in nature. Additional methods may be utilized as is desirous.

The process begins from step 3240 of FIG. 32. The process then progresses to step 3310 where an inquiry is made whether to select the subset of generated segments to reflect the client segment using products accounting for the top revenue earned. If a revenue segment subset selection is desired, the process then progresses to step 3320 where the segment subset is populated with products which account for the top X % of revenue. The exact percentage cutoff for revenue may be configured to match the client segment subset. After the quantitative segment subset has been thus identified, the quantitative pricing power and risk scores may be calibrated such that the weighted averages of power and risk for the subset adheres to the qualitative scores. The process then concludes by progressing to step 3260 of FIG. 32.

Else, if at step 3310 a revenue modification is not desired, the process then progresses to step 3330 where an inquiry is made whether to populate the subset of the quantitative segment by bounds. If a bound based subset is desired the process then progresses to step 3340 where the segment subset is populated with products within some high or low bound for pricing power and/or pricing risk value. This situation arises when, in generating the qualitative segment, the client particularly relies upon a limited number of products in the segment that are particularly memorable. For example, if one product in the segment is sold to a single customer, generates a large profit margin, and is highly competitive, the client may be particularly worried about the loss of this subset of the segment. As a result, the qualitative pricing risk score may be set much higher due to the concern over this memorable segment subset.

After the quantitative segment subset has been thus identified by bounds, the quantitative pricing power and risk scores may be adjusted such that the weighted averages of power and risk for the subset adheres to the qualitative scores for. The process then concludes by progressing to step 3260 of FIG. 32.

Otherwise, if a bound segment subset selection is not desired at step 3330, the process then progresses to step 3360 where an inquiry is made whether to populate the subset of the quantitative segment by profile. If a profile based subset is desired, the process then progresses to step 3370 where the segment is populated with products within some high profile. This may be new or highly publicized segments, which tend to dominate the mind. This situation arises when, in generating the qualitative segment, the client particularly relies upon a limited number of products in the segment that are particularly memorable due to profile. For example, iPods or other “cool” or “hot” items may qualify as high profile items.

After the quantitative segment has been thus modified by profile, the quantitative pricing power and risk scores may be calibrated such that the weighted averages of power and risk for the subset adheres to the qualitative scores. The process then concludes by progressing to step 3260 of FIG. 32.

Else, if a profile selection of a segment subset is not desired at step 3360, the process then progresses to step 3350 where a manual segment subset selection is enabled. In this way an administrator, client user, or statistical factor identifier may assign the segment subset which reflects what was relied upon by the client in generation of the qualitative scores. After the quantitative segment subset has been thus identified, the quantitative pricing power and risk scores may be adjusted such that the weighted averages of power and risk for the subset adheres to the qualitative scores. The process then concludes by progressing to step 3260 of FIG. 32.

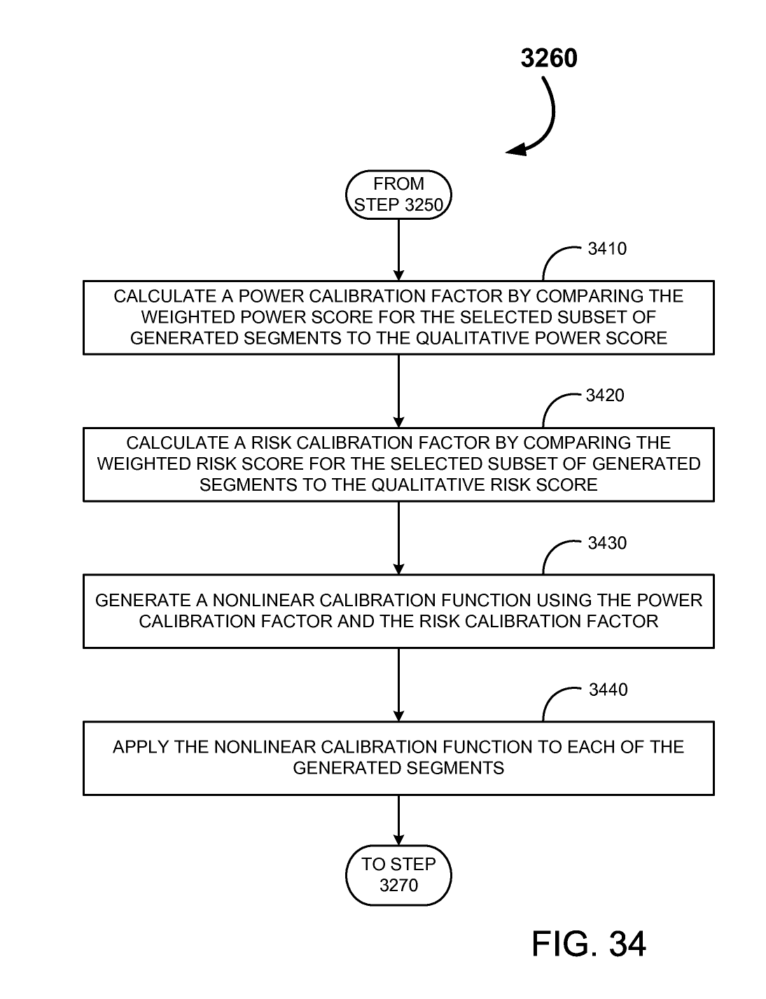

FIG. 34 is a flow chart illustrating an exemplary method for adjusting item level scores such that quantitative scores adhere to qualitative scores, shown generally at 3260. The process begins from step 3250 of FIG. 32. The process then progresses to step 3410 where a power calibration factor is calculated by comparing the weighted power score for the selected subset of generated segments to the qualitative power score. Again, the selected subset of the generated segments is those segments the client had in mind when generating the client pricing power and risk scores (qualitative scores).

Likewise, at step 3420 a risk calibration factor is calculated by comparing the weighted risk score for the selected subset of generated segments to the qualitative risk score. The generated power calibration factor and risk calibration factor may then be used to define a calibration function, at step 3430.

Adjustment by the calibration function may include a linear adjustment, where all pricing power scores are shifted and/or scaled by some value, and each pricing risk score is likewise shifted and/or scaled by some value (ex. new risk score=c1+c2*old risk score). In some alternate embodiments, the adjustment may be nonlinear as to prevent scores from being shifted to out of bounds (i.e. less than 0% or greater than 100%).

The calibration function may then be applied to all of the generated segments (not just the subset) at step 3440. An important result of this calibration technique is that the spread of the pricing power and risk values for each generated segment is maintained after calibration. Thus, while each generated segment's quantitative pricing power and risk scores may be adjusted, these adjustments occur for all generated segments making up the aggregate segment, thereby preserving the relative differences in pricing power and risk scores for each segment.

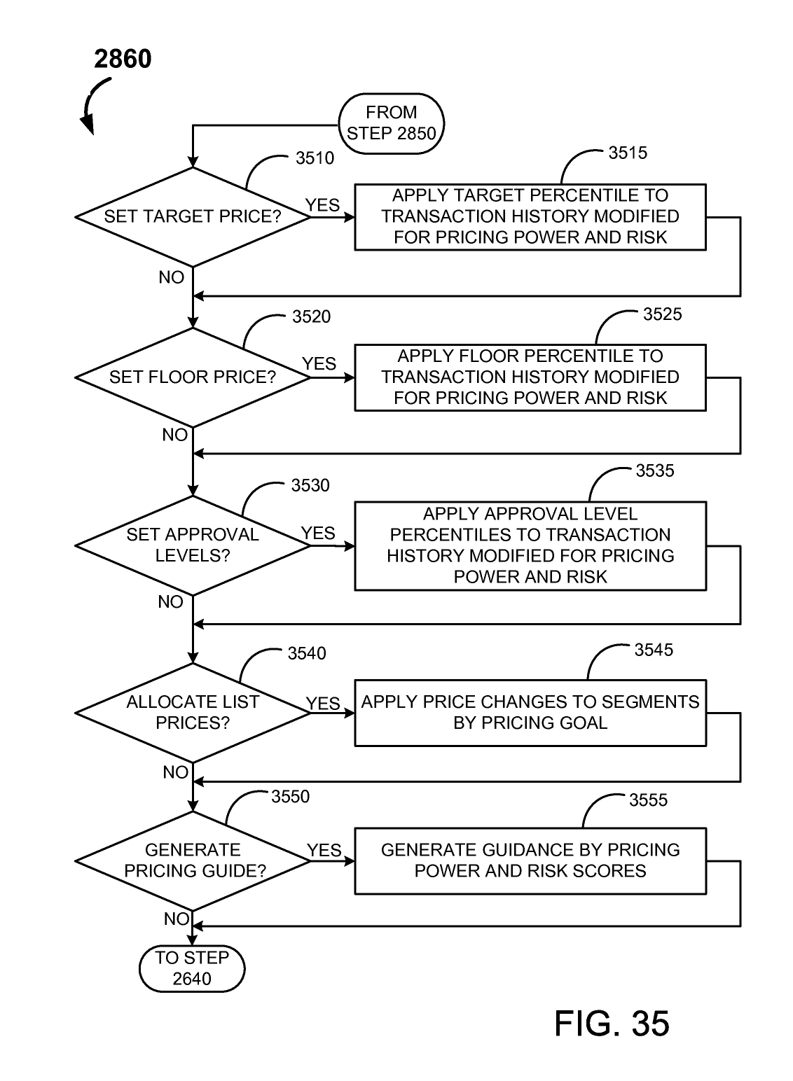

FIG. 35 is a flow chart illustrating an exemplary method for comparing pricing power and risk values to business goals to develop optimal pricing guidance, shown generally at 2860. The process begins from step 2850 of FIG. 28. The process then progresses to step 3510 where an inquiry is made whether to set target prices. If target prices are to be set, then the process progresses to step 3515 where the target prices are determined by looking up transaction history. The transaction history may be plotted as a curve of successful deals frequency by the deal price. A percentile is selected for the target price. Target price percentiles are typically high, such as the 80th percentile. This percentile is applied to the transaction curve and the target price is selected. Thus, continuing the example, the target price is one in which 80% of the prior successful deals have a price below the target price. Selection of the target percentile may, in some embodiments, include analysis of the pricing power and risk of the given segment. Thus, for segments with high pricing risk and low pricing power, the target percentile may be lower, at 70th percentile for example. Likewise, segments with low pricing risk and high power may be set higher, at 90th percentile for example.

After target price is set, or if target price setting is not desired, the process may progress to step 3520 where an inquiry is made whether to set floor prices. If floor prices are to be set, then the process progresses to step 3525 where the floor prices are determined by looking up transaction history. As with target prices, the transaction history may be plotted as a curve of successful deals frequency by the deal price. A percentile is selected for the floor price. Floor prices are the absolute minimum deal price that may be accepted, thus floor price is typically relatively low, such as the 20th percentile. The floor percentile is applied to the transaction curve and the floor price is selected. Selection of the floor percentile may, in some embodiments, include analysis of the pricing power and risk of the given segment.

After floor price is set, or if floor price setting is not desired, the process may progress to step 3530 where an inquiry is made whether to set approval level prices. If approval level prices are to be set, then the process progresses to step 3535 where the approval level prices are determined by looking up transaction history. As with floor and target prices, the transaction history may be plotted as a curve of successful deals frequency by the deal price. One or more percentiles are selected for the approval levels price. Each approval level corresponds to a price where escalation to a higher management level is required. Thus, for example, an approval level of 60th percentile may require an escalation to a manager, while an approval level of 40th percentile may require escalation to a vice president or higher. The approval percentiles are applied to the transaction curve and the approval level prices are selected. Selection of the approval level percentiles may, in some embodiments, include analysis of the pricing power and risk of the given segment.

After approval level prices are set, or if approval level price setting is not desired, the process may progress to step 2740 where an inquiry is made whether to allocate list prices. If list price allocation is desired, then the process progresses to step 3545 where a set price change is applied to segments by a pricing goal. Details of price allocation are discussed below.

After prices are allocated, or if price allocation is not desired, the process may progress to step 3550 where an inquiry is made whether to generate guidance. If guidance generation is desired, then the process progresses to step 3555 where pricing power and risk scores may be utilized to generate guidance for the sales force. This may include presentation of the raw pricing power and/or risk, or may include generating verbal pricing suggestions. For example, high pricing power for a given segment may translate to a phrase ‘be aggressive in the deal negotiation’ which may be presented to the sales force. Likewise, a high risk score may translate to the phrase ‘be willing to make some concessions when asked.’

After guidance is generated, or if price guidance is not desired, the process may end by progressing to step 2640 of FIG. 26.

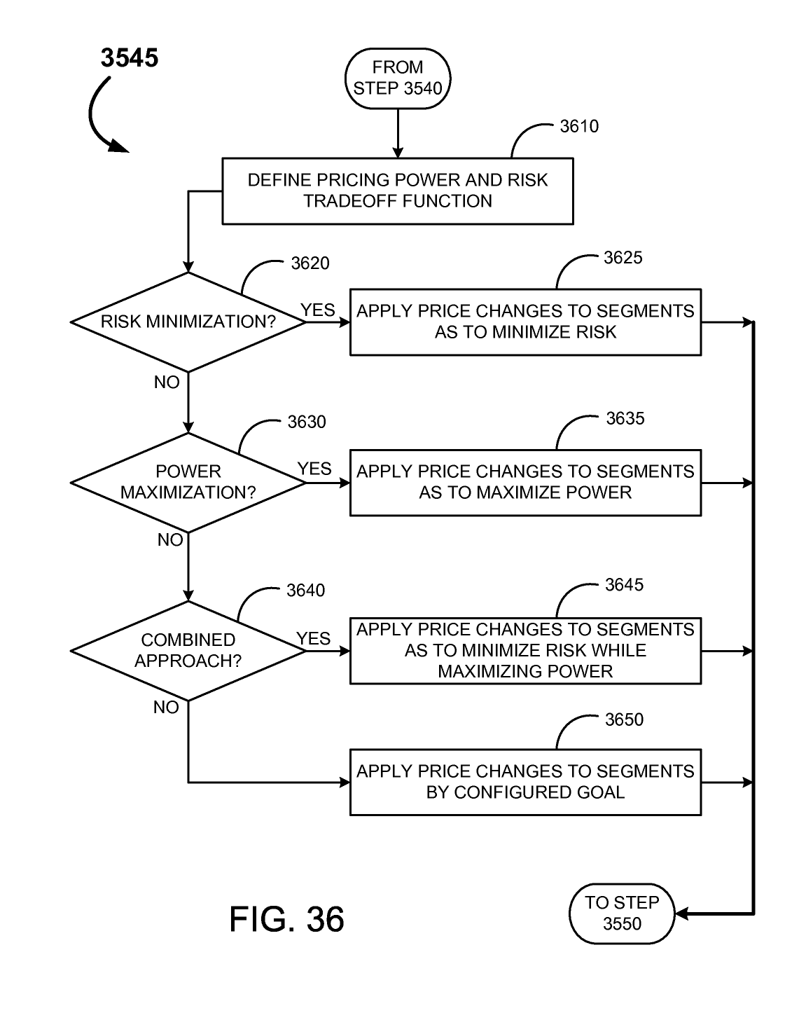

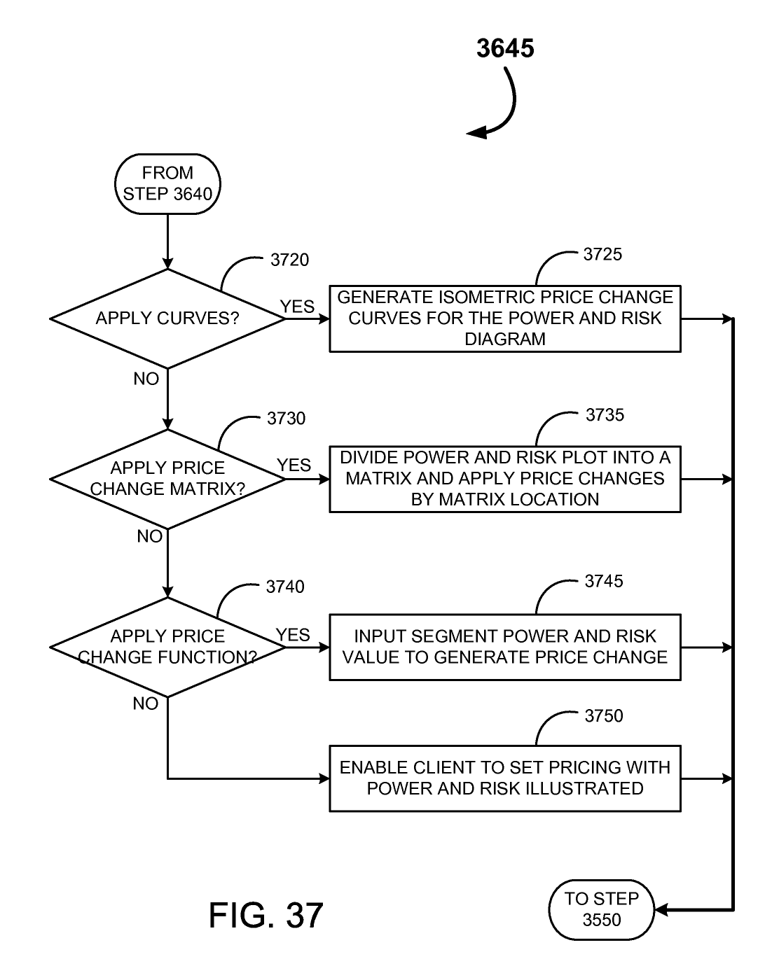

FIG. 36 is a flow chart illustrating an exemplary method for applying price changes across segments, shown generally at 3545. The process begins from step 3540 of FIG. 35. The process then progresses to step 3610 where a pricing power and risk tradeoff function is defined. (ex. hyperbolic function). The pricing power and risk tradeoff function indicates the degree in which either pricing power or pricing risk is considered in the generation of tradeoff curves.

The process then progresses to step 3620 where an inquiry is made whether a pricing risk minimization goal has been provided. If pricing risk minimization is a goal, the process then progresses to step 3625 where price changes are applied across segments, utilizing the calibrated pricing risk scores for each segment, as to minimize the pricing risk of the price changes. Thus, typically, segments of low pricing risk may receive greater price increases, while high pricing risk segments may receive little or no price increase. In some situations, prices may actually be decreased for the segments exhibiting the largest pricing risk. After price changes are applied, the process then concludes by progressing to step 3550 of FIG. 35.

Else, if pricing risk minimization is not a goal at step 3620, the process then progresses to step 3630 where an inquiry is made whether a pricing power maximization goal has been provided. If pricing power maximization is a goal, the process then progresses to step 3635 where price changes are applied across segments, utilizing the calibrated pricing power scores for each segment, as to maximization the pricing power of the price changes. Thus, typically, segments of high pricing power may receive greater price increases, while low pricing power segments may receive little or no price increase. In some situations, prices may actually be decreased for the segments exhibiting the lowest pricing power. After price changes are applied, the process then concludes by progressing to step 3550 of FIG. 35.

Otherwise, if pricing power maximization is not a goal at step 3630, the process then progresses to step 3640 where an inquiry is made whether a combined approach goal has been provided. If using a combined approach is a goal, the process then progresses to step 3645 where price changes are applied across segments, utilizing the calibrated pricing power and pricing risk scores for each segment, as to maximize the pricing power and minimize pricing risks of the price changes. Thus, typically, segments of high pricing power and low pricing risk may receive greater price increases. Segments with low pricing power yet low pricing risk may receive marginal price increases, as will high pricing power and high pricing risk segments. Those segments with low pricing power and high pricing risk may receive little or no price increase. In some situations, prices may actually be decreased for the segments exhibiting the lowest pricing power and the highest pricing risk. The combined approach may utilize mathematical operations, or pricing power and pricing risk plot overlays. After price changes are applied, the process then concludes by progressing to step 3550 of FIG. 35.

Else, if a combined approach is not desired at step 3640, the process then progresses to step 3650 where any additional configured goal may be utilized to apply the price changes. This may include changing prices for segments including only particular products, sold to specific customers, or of a particular size. After price changes are applied, the process then concludes by progressing to step 3550 of FIG. 35.

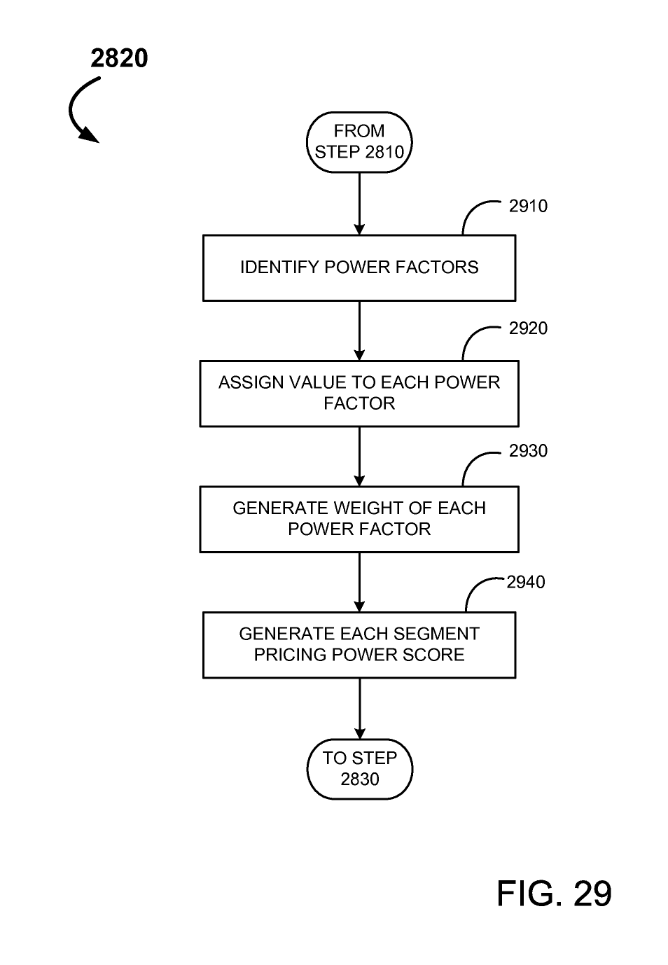

FIG. 29 is a flow chart illustrating an exemplary method for applying price changes to segments as to minimize pricing risk while maximizing pricing power, shown generally at 3645. The process begins from step 3640 of FIG. 36. The process then progresses to step 3720 where an inquiry is made whether to apply tradeoff curves to the pricing power and risk plot. If curve application is desired, the process then progresses to step 2925 where tradeoff curves may be applied to the pricing power and risk plot. For pricing risk minimization, curves are typically vertically oriented lines across the x-axis. For pricing power maximization, curves are typically horizontally oriented lines across the y-axis. For a combined approach, the curves are typically diagonal or radial curves across pricing power and pricing risk dimensions. Price changes may then be generated by referencing the segment location on the pricing power and risk plot in relation to the price change curve. After price setting, the process then concludes by progressing to step 3550 of FIG. 35.

Else, if curve application is not desired at step 3720, the process then progresses to step 3730 where an inquiry is made whether to apply a price change matrix to the pricing power and risk plot. If using a price change matrix is desired, the process then progresses to step 3735 where the pricing power and risk plot may be subdivided into a matrix of a configurable number of boxes. In some embodiments, every 10% of pricing power or risk change may be used to subdivide the pricing power and risk plot, thereby resulting in a 100 point matrix. Of course other numbers of matrix blocks and division are considered within the scope of the invention. Price changes may be assigned to each box of the matrix. Price changes may then be generated by referencing the segment location on the pricing power and risk plot in relation to the price change matrix. After price setting, the process then concludes by progressing to step 3550 of FIG. 35.

The benefit of tradeoff curve and matrix usage for assigning price changes is that a highly intuitive and graphical representation of the price change operation may be provided to the client, as well as to the sales force.

Otherwise, if at step 3730 a price change matrix is not desired, the process then progresses to step 3740 where an inquiry is made whether to apply a function to derive price changes. If a function approach is desired, the process then progresses to step 3745 where segment pricing power and risk scores may be inputted into a function, along with the total price change goals. The function may then provide an output of the applicable price change by segment. After price setting, the process then concludes by progressing to step 3550 of FIG. 35.

Else, if at step 3740 a price change function is not desired, the process then progresses to step 3750 where the client may be provided with the segment pricing power and risk scores. The client may then be enabled to set prices. After price setting the process then concludes by progressing to step 3550 of FIG. 35.

### D. Deal Evaluation

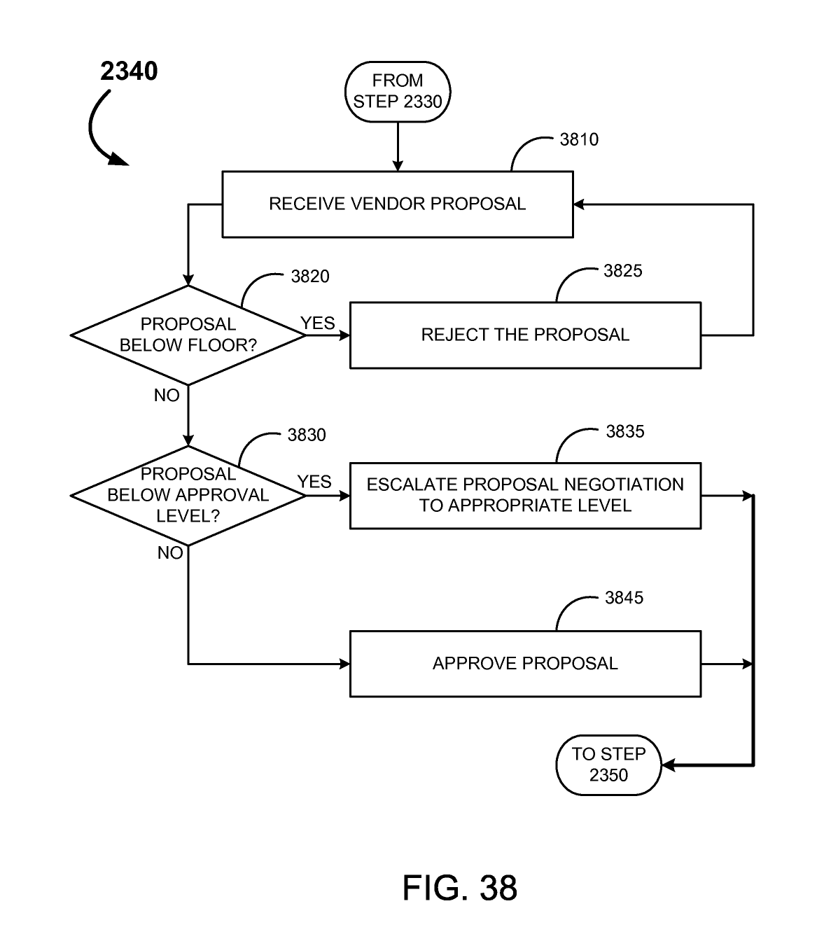

FIG. 38 is a flow chart illustrating an exemplary method for negotiating a deal, shown generally at 2340. The process begins from step 2330 of FIG. 23. The process than progresses to step 3810 where a vendor proposal is received. A vendor proposal represents an initial step in a negotiation process that may encompass many transactions. A vendor proposal generally may contain enough relevant information for the proposal to be properly evaluated. Relevant information may include without limitation, account name, user name, general terms, shipping terms, bid type, bid date, pricing, product descriptions, and other generally known terms well known in the art. Guidance may be presented along with the proposals.

An inquiry is then made if the proposal is below the floor price, at step 3820. If the proposal is below the floor price, the proposal may be rejected at step 3825. If the proposal is rejected, negotiations may terminate. However, if negotiations continue, a new renegotiated proposal may be again received at step 3810.

Else, if the proposal is above the floor price at step 3820, the process continues to step 3830 where an inquiry is made as to whether the proposal is below one or more of the approval level prices. If the proposal is below an approval level, the process progresses to step 3835 where the proposal negotiation is escalated to the appropriate level. Escalation may be to an immediate superior or to a higher level depending upon the proposal price, vendor class, and deal size. Thus, for an important customer, in a large deal, with a low approval level, escalation may even reach CEO or Board levels. The escalation results in the approval or rejection of the proposal. After escalation, the process ends by progressing to step 2350 of FIG. 23.

Otherwise, if the proposal is above the approval levels at step 3830, the process may progress to step 3845 where the proposal is approved. After approval, the process ends by progressing to step 2350 of FIG. 23.

### VII. Power and Risk Examples

### A. Pricing Power and Risk Plots and Manipulations

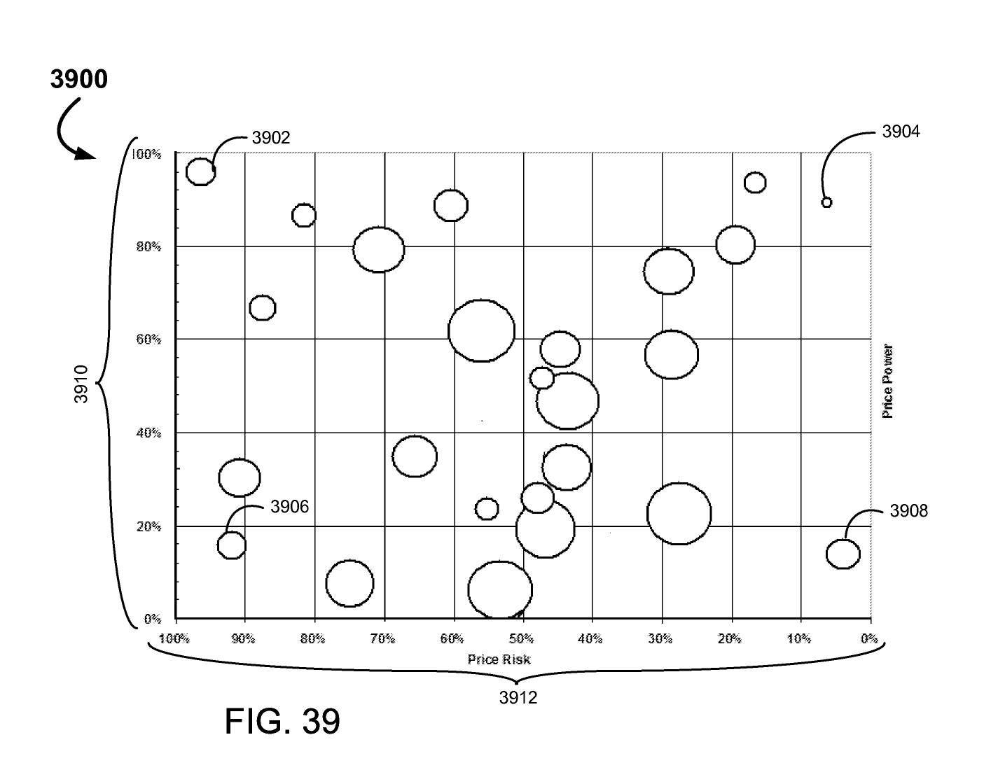

FIG. 39 is an illustrative example of a pricing power and risk segment plot in accordance with an embodiment of the present invention, shown generally at 3900. As may be seen, Price Power 3910 may be a percentage value and is assigned to the vertical axis of the pricing power and risk plot. Likewise, Price Risk 3912 may be in a percentile score and may span the horizontal axis.

Segments may be seen as circles, or ‘bubbles’, on the pricing power and risk plot. Some example segments have been labeled as 3902, 3904, 3906 and 3908, respectively. The location of the segment bubble may indicate the relative pricing power and risk score for the segment. The varying size of the segment bubble may indicate the size of the segment. As previously noted, segment size may be determined by revenue, profit, volume, margin or any other viable indices.

Thus, for example, segment 3904 is a small segment with a relatively low pricing risk and high pricing power score. Price changes will be most successful for segments such as 3904. Segment 3902, a mid-sized segment, also has a high pricing power, but also has a high pricing risk. On the opposite side of the spectrum, segment 3108, a mid-sized segment, has very low pricing power, but also very low pricing risk. Lastly, exemplary segment 3906 has both high pricing risk and low pricing power. Prices for segments like 3906 typically are not increased and may even be decreased in some situations.

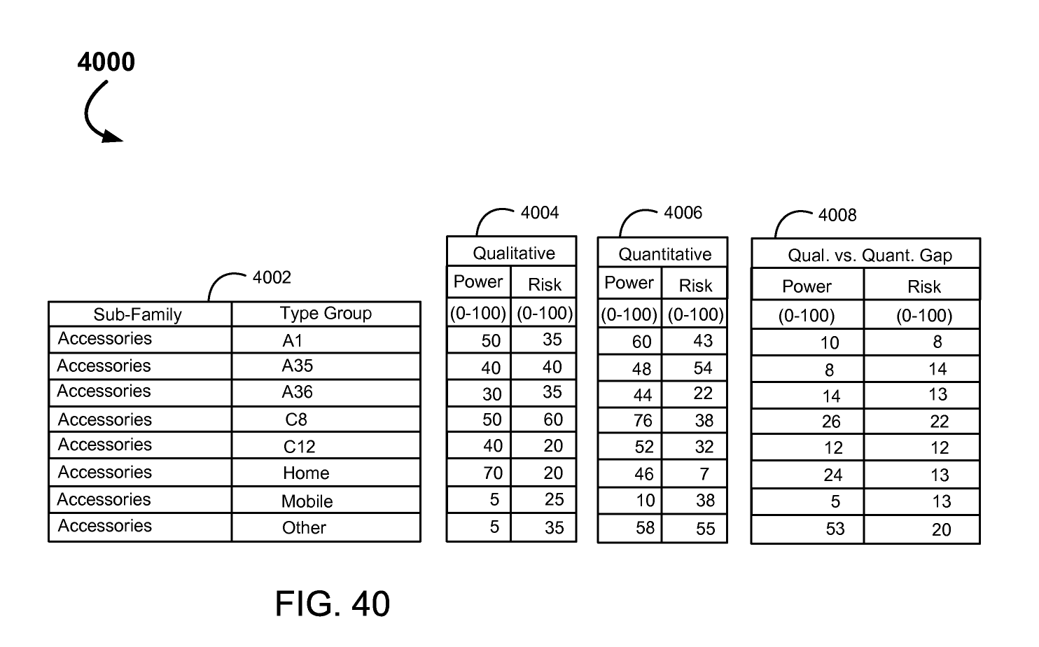

FIG. 40 is an illustrative example of a pricing power and risk table for exemplary segments in accordance with an embodiment of the present invention, shown generally at 4000. This segment table is simplified for the sake of clarity. Identification Columns 4002 may indicate the segment's sub family and segment ID. Provided are examples of segments in an accessory subfamily.

Qualitative scores for pricing power and risk may be received by the client and displayed at Qualitative Columns 4004. Likewise, the aggregate quantitative scores for pricing power and risk generated for the aggregate segments may be provided at the Quantitative Columns 4006.

The gap between the qualitative scores and the quantitative scores may be provided at Gap Columns 4008. Thus, the segment labeled ‘A1’ is seen to have relatively small gaps at 10 for pricing power and 8 for pricing risk. Contrary, segment ‘other’ has relatively large gaps at 53 for pricing power and 20 for pricing risk.

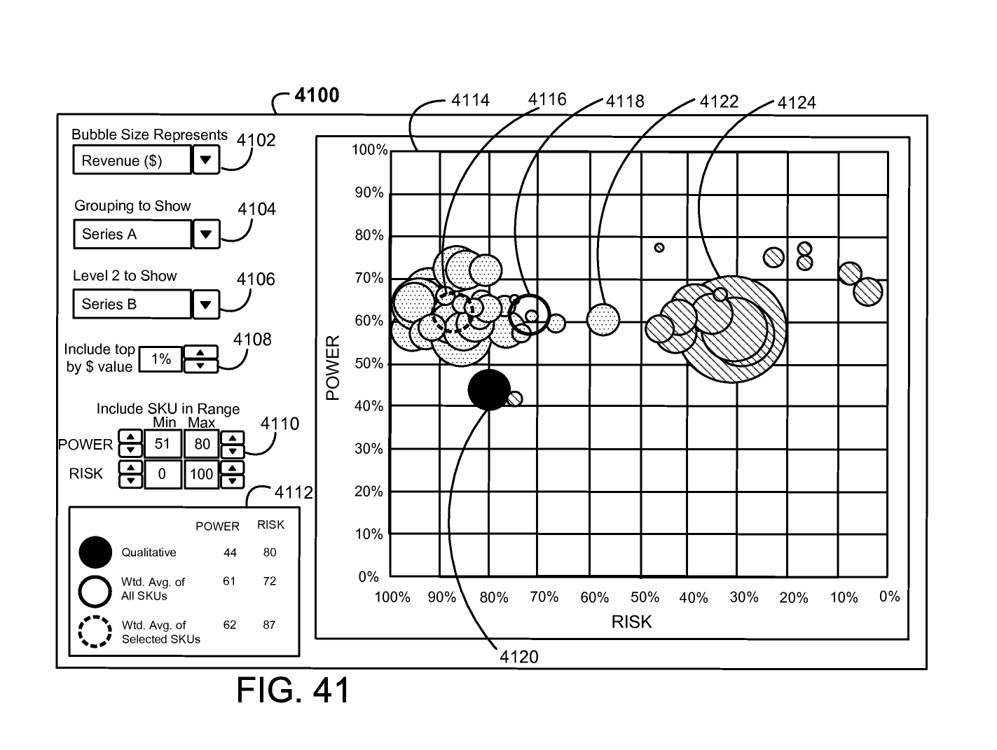

FIG. 41 is an illustrative example of a pricing power and risk segment plot in an Interface Screen 4100 in accordance with an embodiment of the present invention. The Interface Screen 4100 may include a Pricing Power and Risk Plot 4114, a Plot Key 4112 and various controls. The controls may include a Sizing Selector 4102, which determines how the segment sizing is determined. Here the revenue of the segments is used to determine size.

Show Controls 4104 and 4106 provide user control of which segment groupings to display on the Pricing Power and Risk Plot 4114. Here a ‘Series A’ Segment Grouping 4122 is displayed (dot filled segment bubbles) using Show control 4104. Also, a ‘Series B’ Segment Grouping 4124 is displayed (line filled segment bubbles) using Show control 4106.

The displayed segments may be narrowed by those segments representing a certain level of value at the Value selector 4106. The displayed segments may be further narrowed by the Bounds Selector 4110. The Bounds Selector 4110 may indicate cutoffs for pricing power and risk scores for segments that are to be displayed on the Pricing Power and Risk Plot 4114.

As identified in the Plot Key 4112, a Qualitative Score 4120 may be seen on the Pricing Power and Risk Plot 4114. This Qualitative Score 3320 may be for the client segment. All other segments shown on the Pricing Power and Risk Plot 4114, including the ‘Series A’ Segment Grouping 4122 and the ‘Series B’ Segment Grouping 4124, may be generated segments which when combined may equal an aggregate segment that is equal to the client segment. Thus, the Aggregated Quantitative Pricing Power and Risk Scores 4118 for all the illustrated generated segments may be seen. Alternatively, the aggregated quantitative pricing power and risk scores for ‘Series A’ Segment Grouping 4122 may be seen at 4116.

In some situations, the ‘Series A’ Segment Grouping 4122 may be a more visible set of products, and thus the Qualitative Score 4120 may have been generated with this segment grouping, rather than both ‘series A and B’, in mind. This may be of importance when reconciling scores as is illustrated below.

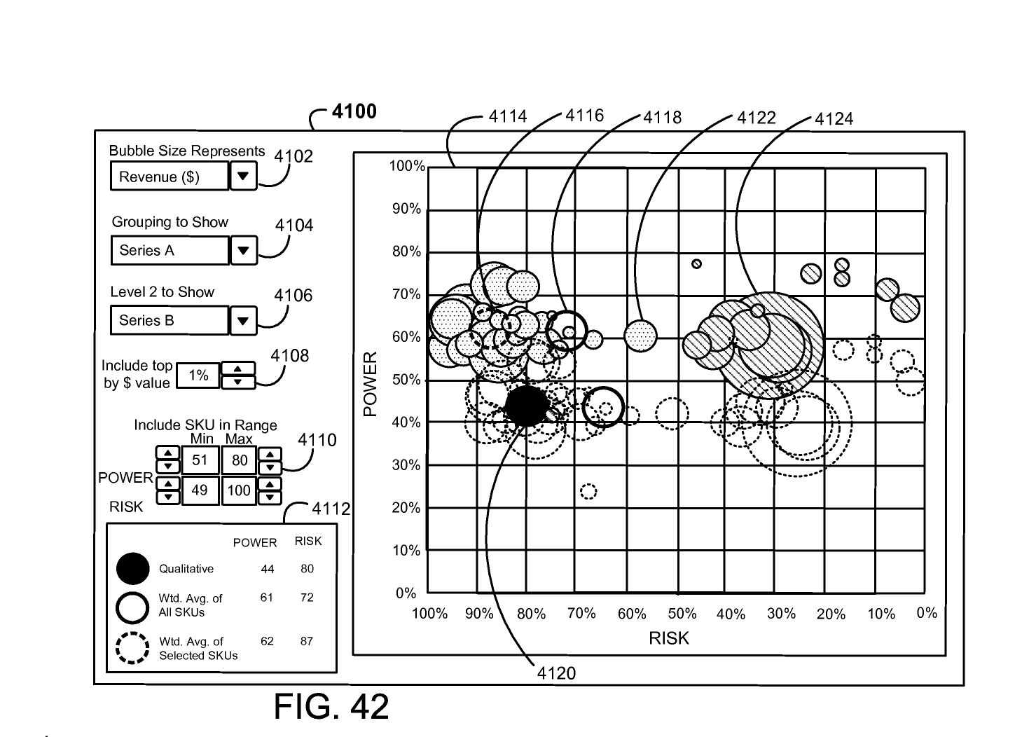

FIG. 42 is an illustrative example of the pricing power and risk segment plot in the Interface Screen 4100 and illustrating a pricing power and risk reconciliation in accordance with an embodiment of the present invention. As noted above, the ‘Series A’ Aggregate Quantitative Score 4116 is the comparable score to the Qualitative Score 4120. Thus, for pricing power and risk score calibration the ‘Series A’ Aggregate Quantitative Score 4116 may be compared to the Qualitative Score 4120 to generate a calibration factor. This calibration factor may then be applied to all generated segments (including both ‘series A’ and ‘series B’). The resulting calibrated quantitative scores may be seen as dotted outlines below and to the right of the original positions. These calibrated quantitative scores may be provided for price allocation and business guidance.

FIG. 43 is an illustrative example of a pricing power and risk segment plot with price change guidance Tradeoff Contours 4310 in accordance with an embodiment of the present invention, shown generally at 4300. Again the Price Power 3910 and Price Risk 3912 may be seen. Between the Contours 4310 is the applied price change. Thus, the exemplary segment 3902 may receive a −2% price change, whereas segment 3904 may be increased by 6%. Such a tradeoff contour layout may reflect a combined approach, thereby taking into account both pricing power and pricing risk in determining price changes. Note that this tradeoff contour map is merely exemplary in nature and not intended to limit the invention in any way.

FIG. 44 is an illustrative example of a pricing power and risk segment plot with an applied price change matrix in accordance with an embodiment of the present invention, shown generally at 4400. Again the Price Power 3910 and Price Risk 3912 may be seen. In this example, the matrix is divided by increments of 10% both in the pricing power and risk dimensions. Of course, additional divisions of the matrix are possible.

Price change values are assigned to each block of the matrix. Thus, depending upon where any given segment falls, the appropriate price change may be applied. In this example, segment 3904 may receive a 10% pricing increase. Note that this exemplary matrix overlay is merely exemplary in nature and not intended to limit the invention in any way.

### B. Vehicle Price Optimization

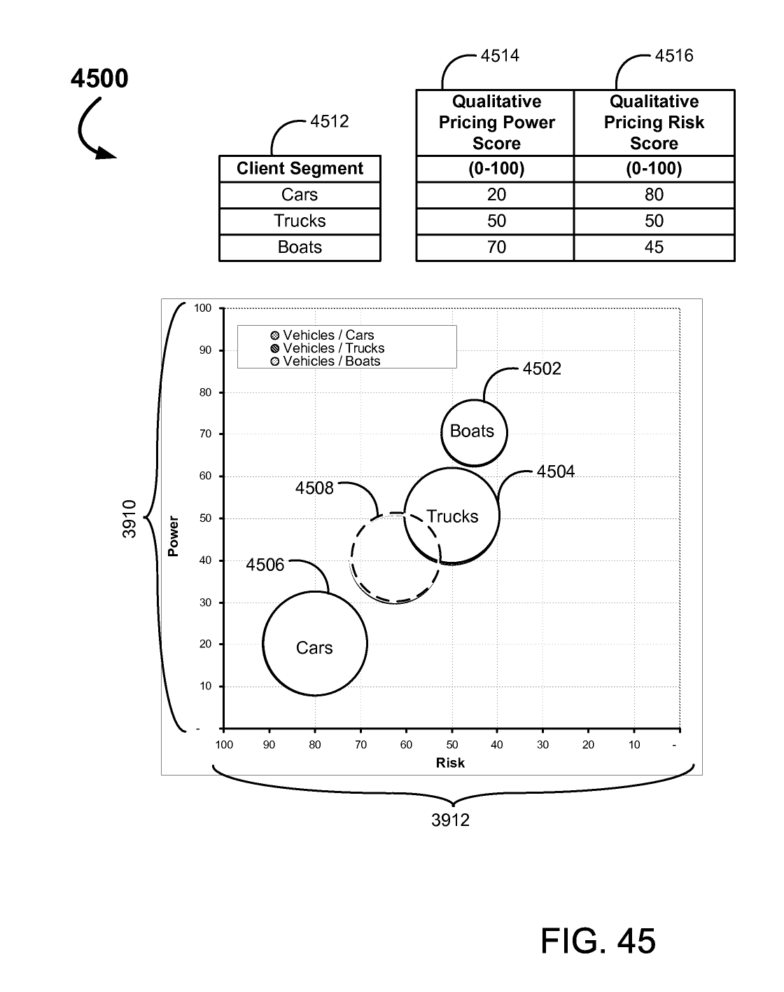

All remaining FIGS. 45 to 54 pertain to a cohesive example of particular generated and client segments for vehicles. Values for pricing risk, power, revenue and factors for these exemplary segments is likewise provided. It is noted that all segment data relating to this example are intended to be illustrative in nature and do not represent limitations of the present invention.

FIG. 45 is an illustrative example of a pricing power and risk segment plot for three exemplary client segments, shown generally at 4500. Here a Table 4512 of the client segments is provided. The client in this particular example may be a distributor of automotive and aquatic vehicles. These Client segments, defined as the segments the client selects as representing her business, include cars, truck and boats.

The client has provided qualitative pricing power scores for the client segments, illustrated at the Qualitative Power Table 4514. Likewise, the client has provided qualitative pricing risk scores for the client segments, illustrated at the Qualitative Risk Table 4516. These qualitative pricing power and risks scores have been plotted on the illustrated power and risk plot.

The power and risk plot may include Risk on the X-axis, illustrated by 3912. Pricing power, on the Y-axis, may be seen illustrated by 3910. A bubble plot may be seen, where the size of the bubble corresponds to the revenue size of the particular client segment. Thus, Cars are plotted at 4506 as having low qualitative risk and power, and the bubble is large since this segment composes a large portion of the client's revenue. Trucks are seen at 4504 and Boats are illustrated at 4502. A weighted average of the qualitative pricing power and risk scores may be seen at 4508.

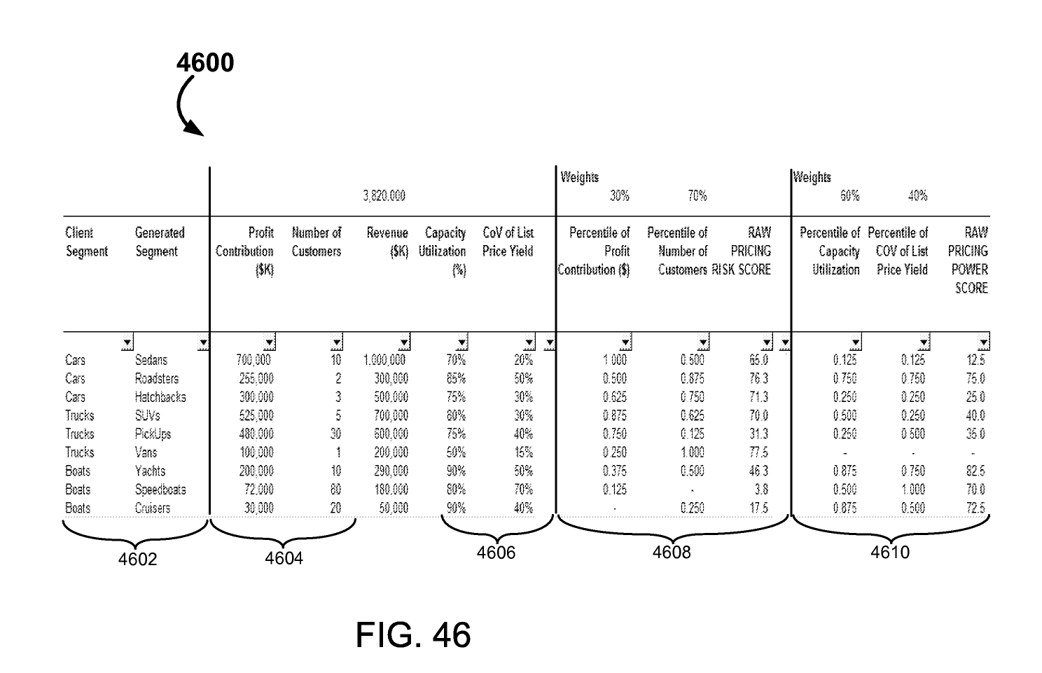

FIG. 46 is an exemplary table of quantitative pricing power and risk factors and scores for exemplary generated segments, shown generally at 4600. The generated segments typically are more finely segmented as compared to client segments. The generated segments, in this example, may include sedans, roadsters, hatchbacks, SUVs, pickup trucks, vans, yachts, speedboats and cruisers. Of these generated segments, they may be aggregated into aggregate segments which correspond to the client segments. Thus, sedans, roadsters and hatchbacks may be aggregated to be the equivalent to the ‘cars’ client segment. SUVs, pickup trucks and vans may be aggregated to be the equivalent to the ‘trucks’ client segment. And lastly, yachts, speedboats and cruisers may be aggregated to be the equivalent to the ‘boats’ client segment. This segment aggregation is illustrated at 4602.

The number of customers purchasing from each generated segment, as well as the profit contribution of each generated segment may be seen at 4604. These, for this example, have been identified as the pricing risk factors. Profit contribution may be automatically calculated from transaction history. The higher profit contribution may be related to a higher pricing risk as loss of the segment may be very damaging to the overall profitability of the client. The number of customers per generated segment may likewise be determined from transaction history. The greater the number of customers, the less risk exposure since loss of one of the customers may not significantly reduce sales within the segment.

Similarly, the capacity utilization and Coefficient of Variation (CoV) of unit price of each generated segment may be seen at 4606. These, for this example, have been identified as the pricing power factors. Higher capacity utilization results in an increase in pricing power. Capacity utilization is typically an entered value of 0-100%. The Coefficient of Variation of the unit price may be calculated from the transaction history. Typically, larger variation in unit price relates to a greater pricing power.

Weights are assigned to the pricing power and risk factors. The risk factors are then normalized, as seen at 4608. Weights are applied to the normalized risk factors and the resulting Raw Quantitative Risk scores are displayed at 4608. Likewise, the power factors are then normalized, as seen at 4610. Weights are applied to the normalized power factors and the resulting Raw Quantitative Power scores are displayed at 4610.

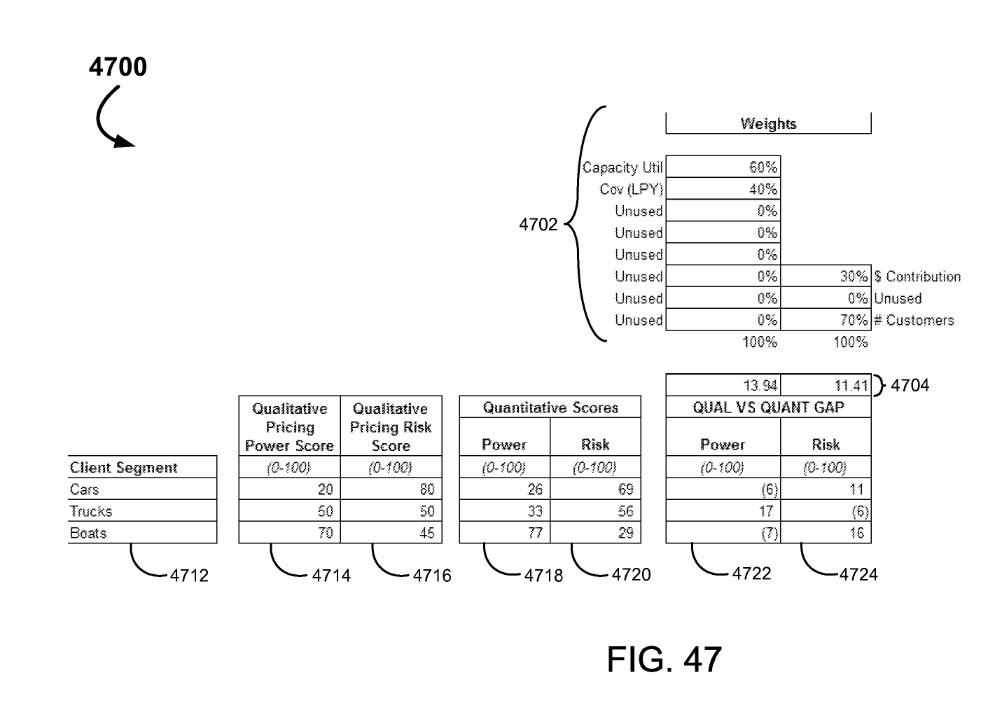

FIG. 47 is an exemplary table of quantitative versus qualitative pricing power and risk scores for the exemplary client segments of FIG. 45, seen generally at 4700. The client segments are listed at 4712. Qualitative pricing power scores for the client segments are shown at 4714. Qualitative pricing risk scores for the client segments are shown at 4716. The raw quantitative power and risk scores may be aggregated for each of the client segments. This aggregation may include a revenue weighted average of the quantitative scores for each generated segment. The aggregated quantitative pricing power scores for the aggregate segments are shown at 4718. The aggregated quantitative pricing risk scores for the aggregate segments are shown at 4720.

Next, the difference between the qualitative and quantitative pricing power and risk scores may be calculated and displayed. Differences in pricing power are illustrated at 4722, and differences in pricing risk are illustrated at 4724. Likewise, standard deviations of the gap between qualitative and quantitative scores may be seen.

The table at 4702 once again shows the breakdown of factor weights in determining quantitative pricing power and risk scores.

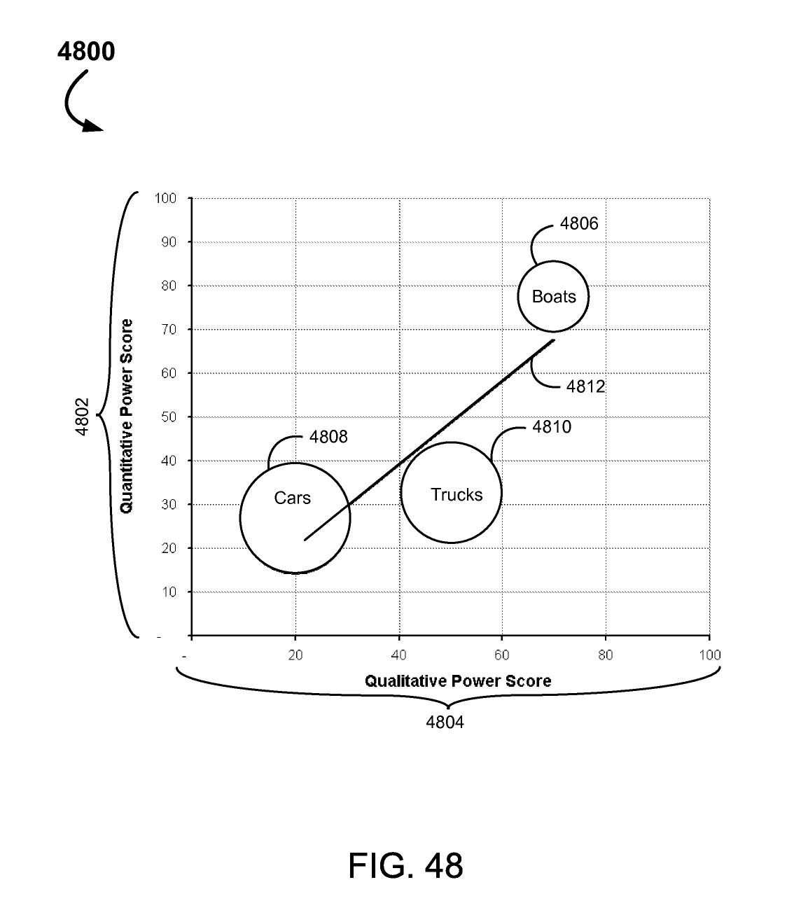

FIG. 48 is an exemplary plot of quantitative versus qualitative pricing power scores for the exemplary client segments of FIG. 45, shown generally at 4800. Qualitative power scores may be seen at 4804, on the X-axis. Quantitative power scores may be seen at 4802, on the Y-axis. The client segments may then be plotted as a bubble plot. Again, size of the bubbles may correspond to revenue.

A linear regression line is plotted at 4812. Ideally, segments would fall on the regression line. Cars segment is plotted at 4808, trucks segment at 4810 and boats segment at 4806. As can be seen, for the trucks segment the quantitative power score is much lower than the qualitative power score.

The low quantitative power score of trucks is due, in this example, to vans having the lowest capacity utilization and coefficient of variation of list price of all segments. Having seen this data, the client, in this hypothetical example, may revise its subjective opinion and reduce the qualitative score from 50 to 35.

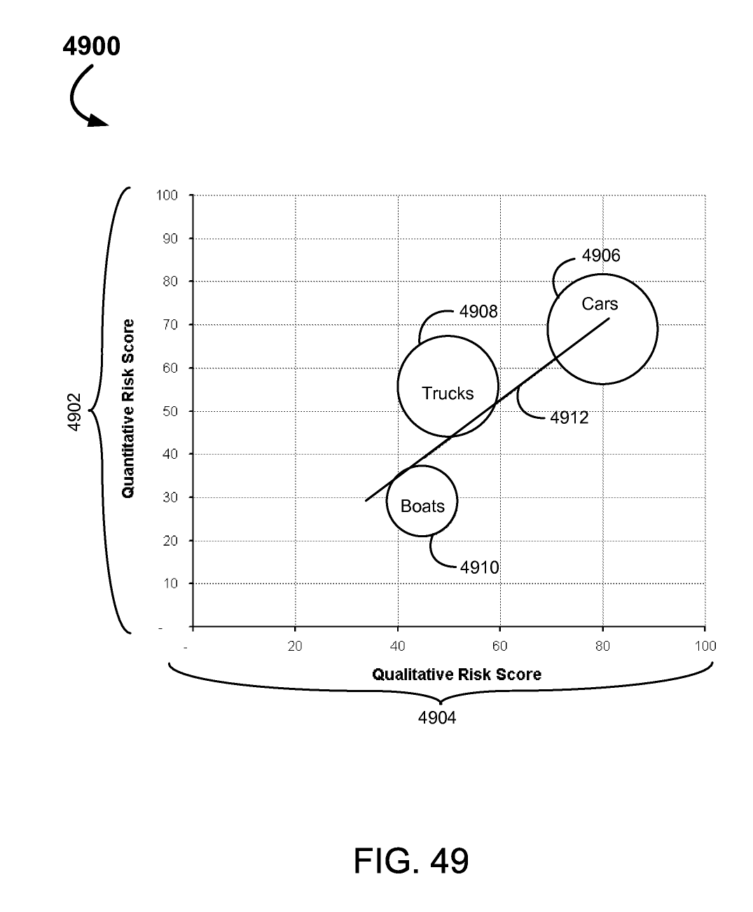

FIG. 49 is an exemplary plot of quantitative versus qualitative pricing risk scores for the exemplary client segments of FIG. 45, shown generally at 4900. Qualitative risk scores may be seen at 4904, on the X-axis. Quantitative risk scores may be seen at 4902, on the Y-axis. The client segments may then be plotted as a bubble plot. Again, size of the bubbles may correspond to revenue.

A linear regression line is plotted at 4912. Ideally, segments would fall on the regression line. Cars segment is plotted at 4906; trucks segment at 4908 and boats segment at 4110. As can be seen, for the boats segment the quantitative risk score is much lower than the qualitative risk score.

The low quantitative risk score for boats, in this example, was due to speedboats and cruisers having small overall profit contributions and many customers. In this example, however, the client may determine that boat sales lend them an “upscale” brand image, therefore making sales of boats more important to the business that profit contributions would indicate. Thus, for this hypothetical example, the client may decide to leave the qualitative risk score at 45.

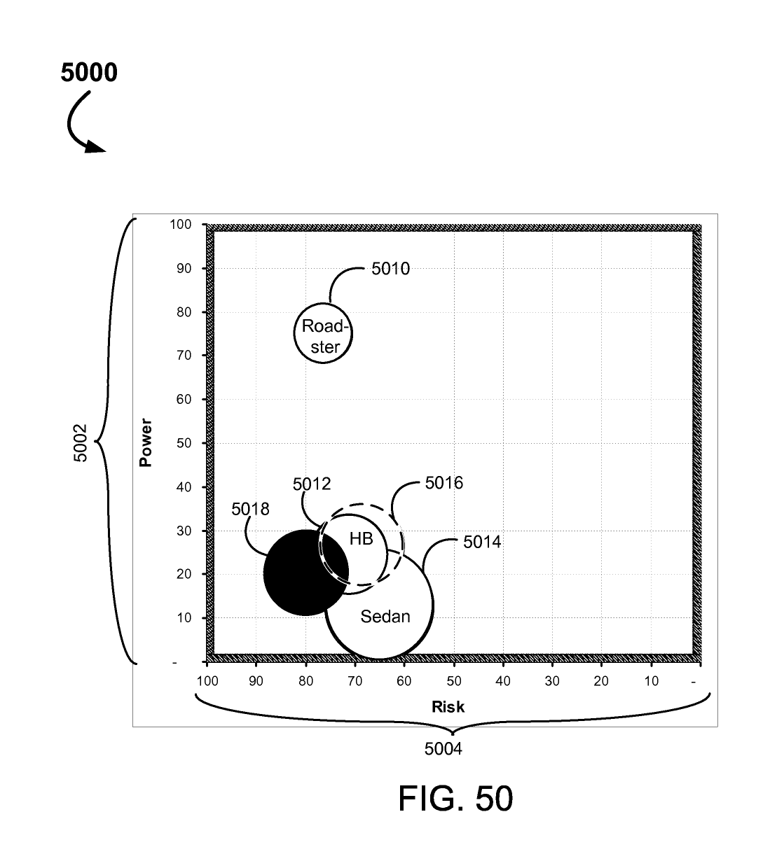

FIG. 50 is an exemplary plot of quantitative pricing power and risk scores for the exemplary generated segments and the qualitative client scores for the exemplary client segment of FIGS. 45 and 46, shown generally at 5000. For this plot, pricing power, at 4202, is on the Y-axis. Pricing risk, at 4204, is on the X-axis.

The qualitative scores for the client segment ‘cars’ is plotted at 5018. The generated segments quantitative scores are likewise plotted. Thus, the quantitative power and risk scores for Roadsters segment may be seen at 5010. The quantitative power and risk scores for Hatchback segment may be seen at 5012. Lastly, the quantitative power and risk scores for the Sedans segment may be seen at 5014.

The aggregate quantitative power and risk scores for the aggregate ‘cars’ segment may also be seen at 5016. This aggregate quantitative power and risk score may then be compared to the qualitative scores for the client segment ‘cars’ that is plotted at 5018.

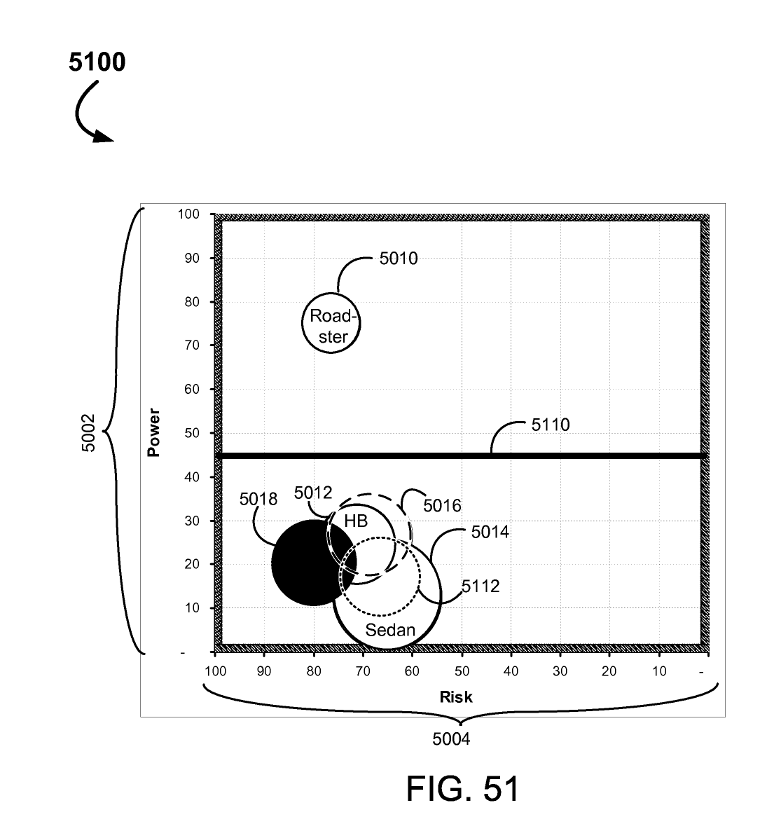

FIG. 51 is the exemplary plot of FIG. 50 wherein a subset of the exemplary generated segments has been selected for the quantitative pricing power and risk scores, shown generally at 5100. In this example, the client realized that it effectively ignored Roadsters when making its qualitative assessment. Thus, Hatchbacks and sedans form the subset of generated segments which are to be aggregated in order to compare to the qualitative scores for the client's car segment.

Thus, a bound is set at a power of 45, above which the segments are not included in the generation of the aggregate segment. This bound is shown at 5110. Thus, a new aggregated quantitative power and risk score may be generated for the subset of generated segments (i.e., hatchbacks and sedans). This updated aggregate quantitative score may be seen at 5112. Since Roadsters were not included in this aggregate, the power scores are lower and risk scores are a little higher as compared to the old aggregate score of 5016.

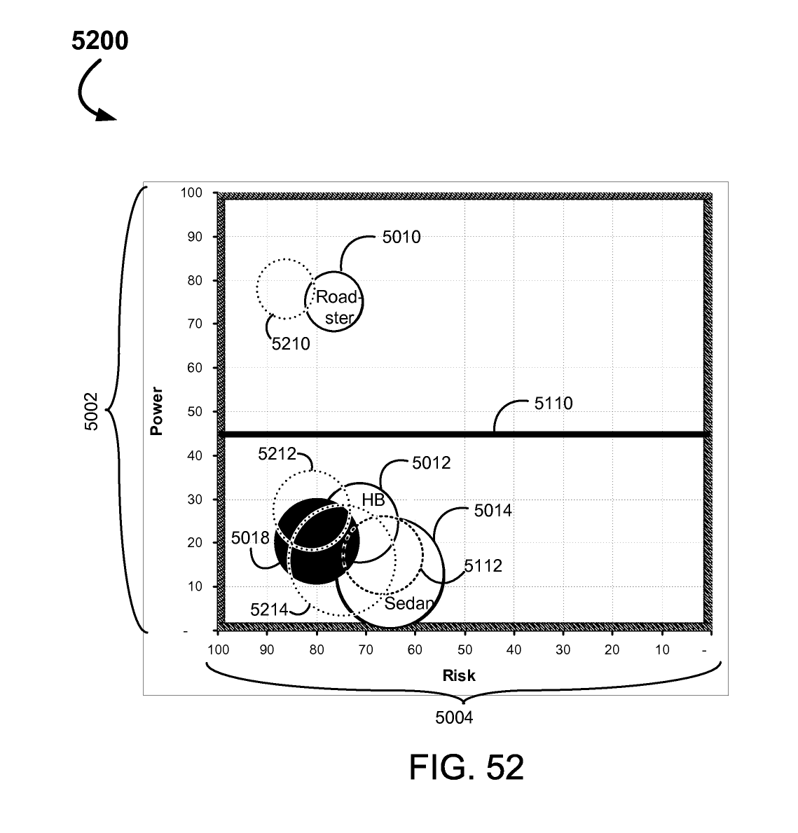

FIG. 52 is the exemplary plot of FIG. 51 wherein the exemplary generated segments' quantitative pricing power and risk scores have been calibrated, shown generally at 5200. Here the subset aggregate quantitative power and risk score, seen at 5112, may be compared to the client qualitative score seen at 5018. Calibration factors may then be determined and applied to all generated segments. Application to all segments includes the Roadster segment, shown at 5010, as to maintain spread.

Thus, the adjusted power and risk scores for Roadsters may be seen at 5210. The adjusted power and risk scores for Hatchbacks may be seen at 5212. Lastly, the adjusted power and risk scores for Sedans may be seen at 5214.

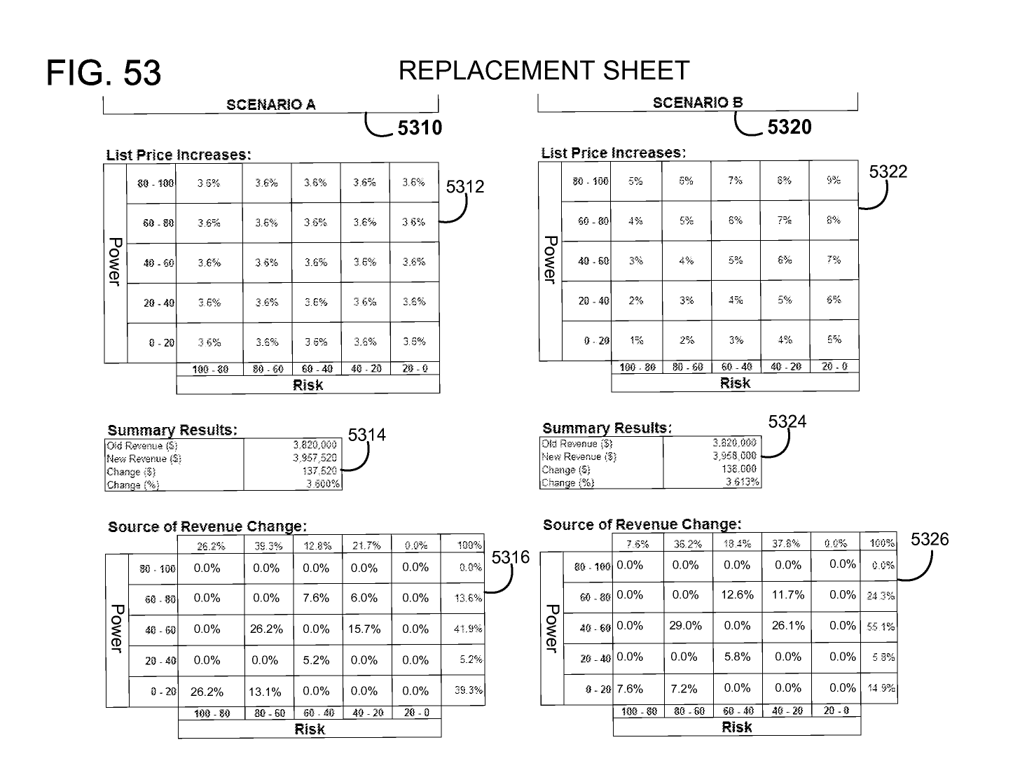

FIG. 53 illustrates a comparison of two exemplary price change scenarios in accordance with an embodiment of the present invention. The first price change scenario (Scenario A 5310) includes the application of a price change evenly across all pricing power and risk values, as may be seen in the pricing power and risk plot with a price change matrix overlay illustrated at 5312. This results in a 3.6% list price increase across all segments. Exemplary results of such a price change are illustrated at table 5314. The source of revenue change for this scenario may then be seen at the plot 5316. As can be seen, the bulk of the revenue increase, in this exemplary scenario, comes from higher risk and lower power segments.

On the other hand, the second price change scenario (Scenario B 5320) includes the application of a price change unevenly across pricing power and risk values, as may be seen in the pricing power and risk plot with a price change matrix overlay illustrated at 5322. This results in a maximum of 9% list price increase for the most-power-least-risk segments, and as low as a 1% increase for the lowest power and highest risk segments. Exemplary results of such a price change are illustrated at table 5324. The source of revenue change for this scenario may then be seen at the plot 5326. As can be seen, the bulk of the revenue increase, in this exemplary scenario, comes from less risk and higher power segments.

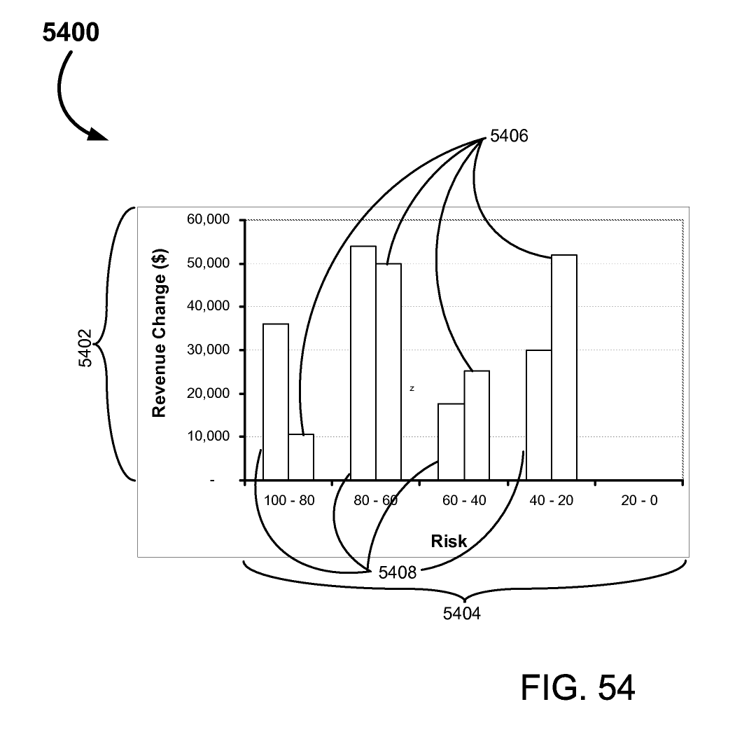

FIG. 54 illustrates an exemplary bar plot of revenue change to risk for the two exemplary price change scenarios of FIG. 53, shown generally at 5400. The Revenue change is plotted along the Y-axis and is shown at 5402. Risk value buckets are plotted along the X-axis and are shown at 5404.

Bars labeled 5406 correspond to the unequal price change distribution from FIG. 53. Contrary, bars labeled 5408 correspond to the equal across all segment price change distribution from FIG. 53. Thus, it may be seen that with unequal pricing distribution, the price change may come from segments with a lower risk than if pricing were applied equally across all segments.

### VIII. System Embodiments

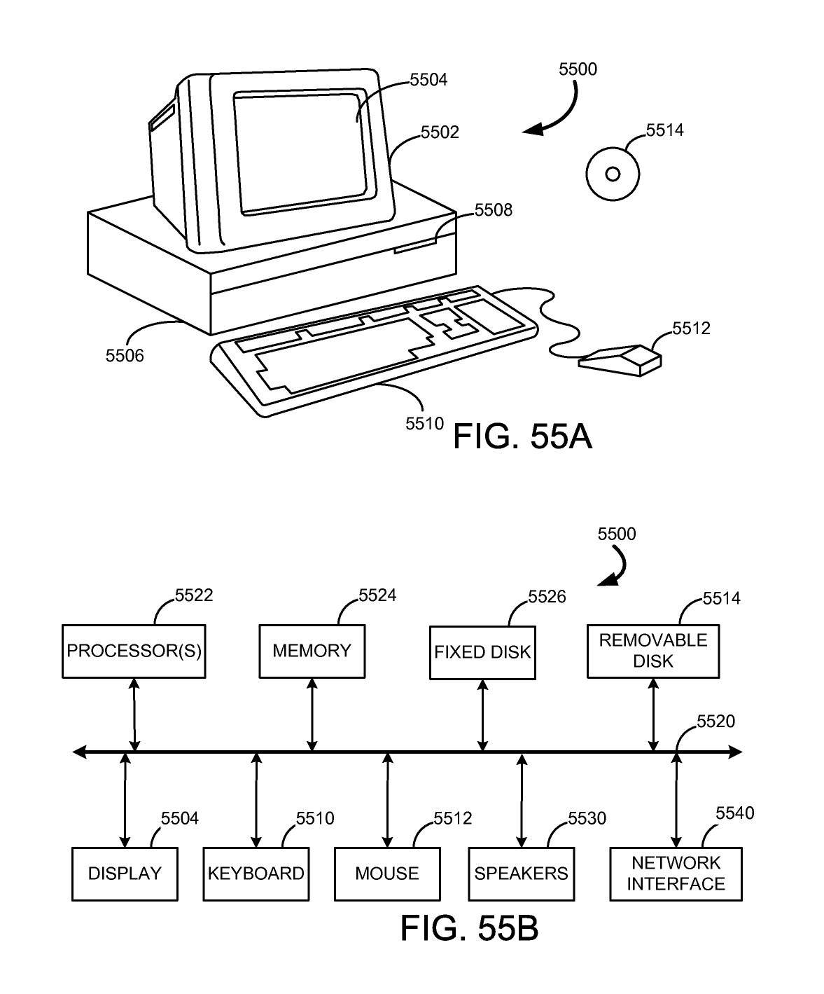

FIGS. 55A and 55B illustrate a Computer System 5500, which is suitable for implementing embodiments of the present invention. FIG. 55A shows one possible physical form of the Computer System 5500. Of course, the Computer System 5500 may have many physical forms ranging from a printed circuit board, an integrated circuit, and a small handheld device up to a huge super computer. Computer system 5500 may include a Monitor 5502, a Display 5504, a Housing 5506, a Disk Drive 5508, a Keyboard 5510, and a Mouse 5512. Disk 5514 is a computer-readable medium used to transfer data to and from Computer System 5500.

FIG. 55B is an example of a block diagram for Computer System 5500. Attached to System Bus 5520 are a wide variety of subsystems. Processor(s) 5522 (also referred to as central processing units, or CPUs) are coupled to storage devices, including Memory 5524. Memory 5524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 5526 may also be coupled bi-directionally to the Processor 5522; it provides additional data storage capacity and may also include any of the computer-readable media described below. Fixed Disk 5526 may be used to store programs, data, and the like and is typically a secondary storage medium (such as a hard disk) that is slower than primary storage. It will be appreciated that the information retained within Fixed Disk 5526 may, in appropriate cases, be incorporated in standard fashion as virtual memory in Memory 5524. Removable Disk 5514 may take the form of any of the computer-readable media described below.

Processor 5522 is also coupled to a variety of input/output devices, such as Display 5504, Keyboard 5510, Mouse 5512 and Speakers 5530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 5522 optionally may be coupled to another computer or telecommunications network using Network Interface 5540. With such a Network Interface 5540, it is contemplated that the Processor 5522 might receive information from the network, or might output information to the network in the course of performing the above-described multi-merchant tokenization. Furthermore, method embodiments of the present invention may execute solely upon Processor 5522 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, systems and methods for generating segment price sensitivities are provided. While a number of specific examples have been provided to aid in the explanation of the present invention, it is intended that the given examples expand, rather than limit the scope of the invention. Although sub-section titles have been provided to aid in the description of the invention, these titles are merely illustrative and are not intended to limit the scope of the present invention.

While the system and methods has been described in functional terms, embodiments of the present invention may include entirely hardware, entirely software or some combination of the two. Additionally, manual performance of any of the methods disclosed is considered as disclosed by the present invention.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A method for generating segment price sensitivity, useful in association with an integrated price management system, the method comprising:
generating a histogram distribution of frequency of deals by deal price for a segment; and
calculating the sensitivity of the segment to price change using the shape of the histogram distribution.

2. The method as recited in claim 1, further comprising generating a segment from transaction logs.

3. The method as recited in claim 2, wherein the segment is generated using product attribute information, market data, and transaction history data.

4. The method as recited in claim 1, further comprising outputting the sensitivity to a pricing system.

5. The method as recited in claim 4, wherein the sensitivity is used by the pricing system as a pricing power factor in a risk/power analysis.

6. The method as recited in claim 1, wherein the sensitivity is calculated by computing an inverse cumulative distribution function of the histogram, and determining the slope of the inverse cumulative distribution function.

7. The method as recited in claim 1, wherein the sensitivity is calculated by computing an approximation of a slope for the right hand curve of the histogram.

8. The method as recited in claim 7, wherein the computing the approximation comprises:
setting a high and a low anchor;
averaging the frequency around the high anchor to yield a high frequency value;
averaging the frequency around the low anchor to yield a low frequency value;
generating a line between the high frequency value and the low frequency value; and
determining the slope of the line.

9. The method as recited in claim 8, wherein the high anchor is between 50 to 65% of the distribution histogram.

10. The method as recited in claim 8, wherein the low anchor is between 80 to 100% of the distribution histogram.

11. A system for generating segment price sensitivity, useful in association with an integrated price management system, the system comprising:
a segment distribution generator configured to generate a histogram distribution of frequency of deals by deal price for a segment; and
a sensitivity approximator, including a processor, configured to calculate the sensitivity of the segment to price change using the shape of the histogram distribution.

12. The system as recited in claim 11, further comprising a segmenter configured to generate a segment from transaction logs.

13. The system as recited in claim 12, wherein the segmenter generates the segment using product attribute information, market data, and transaction history data.

14. The system as recited in claim 11, further comprising an interface configured to output the sensitivity to a pricing system.

15. The system as recited in claim 14, wherein the sensitivity is used by the pricing system as a pricing power factor in a risk/power analysis.

16. The system as recited in claim 11, wherein the sensitivity approximator calculates the sensitivity by computing an inverse cumulative distribution function of the histogram, and determining the slope of the inverse cumulative distribution function.

17. The system as recited in claim 11, wherein the sensitivity approximator calculates the sensitivity by computing an approximation of a slope for the right hand curve of the histogram.

18. The system as recited in claim 17, wherein the sensitivity approximator performs the steps of:
setting a high and a low anchor;
averaging the frequency around the high anchor to yield a high frequency value;
averaging the frequency around the low anchor to yield a low frequency value;
generating a line between the high frequency value and the low frequency value; and
determining the slope of the line.

19. The system as recited in claim 18, wherein the high anchor is between 50 to 65% of the distribution histogram.

20. The system as recited in claim 18, wherein the low anchor is between 80 to 100% of the distribution histogram.
